(19) United States
(12) Patent Application Publication
(10) Pub. No.: US 2010/0208176 A1
(43) Pub. Date: Aug. 19, 2010

(54) Wide Viewing Angle Transflective Liquid Crystal Displays

(75) Inventors: Zhibing Ge, Orlando, FL (US); Shin-Tson Wu, Oviedo, FL (US); Wang-Yang Li, Tainan County (TW); Chung- Kuang Wei, Taipei City (TW)

Correspondence Address: FISH & RICHARDSON PC, P.O. BOX 1022, MINNEAPOLIS, MN, 55440-1022, US

(73) Assignees: Chi Mei Optoelectronics Corporation, Tainan County (TW); University of Central Florida Research Foundation, Inc., Orlando, FL (US)

(21) Appl. No.: 12/372,375

(22) Filed: Feb. 17, 2009

(51) Int. Cl. G02F 1/13363; G02F 1/1335

(52) U.S. Cl. 349/98; 349/114; 349/118

(57) ABSTRACT

A wide viewing angle transflective liquid crystal display includes a retardation film and pixels positioned between first and second substrates, each pixel including a transmissive region and a reflective region. The retardation film has a phase retardation that compensates the phase retardation of a liquid crystal layer in the transmissive region for normal incident light to achieve a dark state when no data voltage is applied to the pixel. The retardation film and a liquid crystal layer in the reflective region has a phase retardation in a range between 0.22λ and 0.28λ with respect to normal incident light to achieve a dark state when no data voltage is applied to the pixel, λ being the wavelength of the incident light.

At least some of the subject matter disclosed in this patent application was developed under a joint research agreement between Chi Mei Optoelectronics Corporation and the University of Central Florida.

### BACKGROUND

The description relates to wide viewing angle transflective liquid crystal displays.

In some examples, a transflective liquid crystal display includes pixels each having a transmissive region that is illuminated by a backlight unit and a reflective region that is illuminated by ambient light. A liquid crystal cell is positioned between a bottom glass substrate and a top glass substrate, which are interposed between a bottom circular polarizer and a top circular polarizer. The bottom circular polarizer can include a first linear polarizer, a first half-wave plate, and a first quarter-wave plate. The top circular polarizer can include a second linear polarizer, a second half-wave plate, and a second quarter-wave plate. The liquid crystal layer is initially homogeneously aligned to the substrates by a bottom alignment layer and a top alignment layer in the inner surfaces of the substrates. A plane-shaped pixel electrode is formed on the bottom substrate in the transmissive region, and a conductive metal reflector connected to the pixel electrode is formed in the reflective region. On the top substrate, a common electrode is formed in both transmissive and reflective regions.

In the examples above, light from a backlight unit passes the LC cell once in the transmissive region, and ambient light incident from the top side passes the LC cell twice in the reflective region. In order to compensate their optical path difference, a dielectric bumper is formed in the reflective region to make the cell gap in the reflective region about half of the cell gap of the transmissive region. When the phase retardation Δn·d_{T} (where Δn=nₑ−nₒ and nₑ, nₒ are the extraordinary and ordinary refractive indices of the liquid crystal material) of the transmissive part is about ½λ and the reflective part is about ¼λ (where λ is the incident wavelength), the transmissive region generates a maximum transmittance and the reflective region generates a maximum reflectance. When a high voltage is applied, the LC molecules are re-orientated to be perpendicular to the substrate, generating negligible phase retardation in both transmissive and reflective regions to achieve a common dark state.

### SUMMARY

In one aspect, in general, a transflective liquid crystal display includes a first transparent glass substrate and a second transparent glass substrate, the first glass substrate being positioned closer to a backlight module than the second glass substrate; a first linear polarizer and a second linear polarizer, the first linear polarizer being positioned closer to the backlight module than the second linear polarizer; and a retardation film between the first and second linear polarizers. The display includes pixels positioned between the first and second substrates, each pixel including a transmissive region and a reflective region. The transmissive region has a liquid crystal layer having a first thickness, the retardation film having a phase retardation that compensates the phase retardation of the liquid crystal layer in the transmissive region for normal incident light to achieve a dark state when no data voltage or a data voltage corresponding to a dark state is applied to the pixel. The reflective region has a liquid crystal layer having a second thickness, the second thickness being configured such that a combination of the retardation film and the liquid crystal layer in the reflective region has a phase retardation in a range between 0.22λ and 0.28λ with respect to normal incident light to achieve a dark state when no data voltage or a data voltage corresponding to a dark state is applied to the pixel, λ being the wavelength of the light rays.

Implementations can include one or more of the following features. The liquid crystal layer has liquid crystal molecules that are aligned substantially parallel to the glass substrates when the pixel is operating in a dark state. The first linear polarizer has a transmission axis that is perpendicular to that of the second linear polarizer, and the liquid crystal layer has a rubbing direction that is at an angle in a range from 40 to 50 degrees relative to the transmission axis of the second linear polarizer. The retardation film includes a biaxially stretched film having principle refractive indices nₓ, n_{y}, and n_{z}, in which nₓ>n_{y} and n_{z}>n_{y}. In some examples, the retardation film has refractive indices nₓ=n_{z}. The n_{z} axis of the retardation film is along a direction that is substantially perpendicular to at least one of the first and second linear polarizers, and the n_{y} axis of the retardation film is substantially parallel to the rubbing direction of the liquid crystal layer.

A combination of the second linear polarizer, the retardation film, and the liquid crystal layer in the reflective region forms a circular polarizer. The pixel includes a pixel electrode in the transmissive and reflective regions, a reflective electrode in the reflective region, and a common electrode, in which the pixel electrode, the reflective electrode, and the common electrode are all at a same side relative to the liquid crystal layer. In some examples, the pixel electrode includes strips, and the pixel electrode is positioned between the common electrode and the liquid crystal layer. The strips each has a width in a range from 2 to 8 μm, and gaps between the strips ranges from 2 to 10 μm. In some examples, the common electrode includes strips, and the common electrode is positioned between the pixel electrode and the liquid crystal layer.

A display controller drives the transmissive and reflective regions using a single gray-scale control gamma curve. The first thickness of the liquid crystal layer in the transmissive region is configured to cause the transmissive region to have a maximum brightness when the pixel is operating in a bright state, in which increasing or decreasing the thickness of the liquid crystal layer in the transmissive region tends to cause the brightness of the pixel to decrease when operating in the bright state. In some examples, the liquid crystal layer includes a negative dielectric anisotropic liquid crystal material. The liquid crystal layer has an initial surface rubbing angle aligned at an angle in a range from 55° to 85° with respect to the lengthwise direction of the electrode strips. In some examples, the liquid crystal layer includes a positive dielectric anisotropic liquid crystal material, the pixel electrode includes strips and is positioned between a common electrode and the liquid crystal layer, and the liquid crystal layer has an initial surface rubbing angle aligned at an angle in a range from 5° to 35° with respect to the lengthwise direction of the pixel electrode strips. In some examples, the liquid crystal layer includes a positive dielectric anisotropic liquid crystal material, the common electrode includes strips and is positioned between a pixel electrode and the liquid crystal layer, and the liquid crystal layer has an initial surface rubbing angle aligned at an angle in a range from 5° to 35° with respect to the lengthwise direction of the common electrode strips.

The display includes a first compensation film and a second compensation film, the first compensation film being closer to a backlight unit than the second compensation film, the first and second compensation films being at opposite sides relative to the liquid crystal layer, the first and second compensation films having refractive indices configured to compensate an effective angle deviation of the first and second linear polarizers for off-axis incident light and reduce off-axis light leakage. The first and second compensation films include a positive uniaxial A-plate having refractive indices nₓ>n_{y}=n_{z} and a negative A-plate having refractive indices n_{y}<nₓ=n_{z}. The optic axes of the first and second compensation films are either parallel to or perpendicular to the transmission axes of the first and second linear polarizers. The display includes a second retardation film that includes a uniaxial C-plate positioned between the first and second linear polarizers and having refractive indices nₓ=n_{y}≠n_{z}.

In another aspect, in general, a transflective liquid crystal display includes a first transparent glass substrate and a second transparent glass substrate, the first glass substrate being positioned closer to a backlight module than the second glass substrate; a first linear polarizer and a second linear polarizer, the first linear polarizer being positioned closer to the backlight module than the second linear polarizer; and a first retardation film. The display includes pixels positioned between the first and second substrates, each pixel including a transmissive region and a reflective region. The transmission region has a liquid crystal layer having a first thickness, the first retardation film having a phase retardation that cancels the phase retardation of the liquid crystal layer in the transmissive region for normal incident light when the pixel is operating in a dark state. The reflective region has a liquid crystal layer having a second thickness such that the liquid crystal layer in the reflective region has a phase retardation in a range between 0.22λ and 0.28λ with respect to normal incident light when the pixel is operating in the dark state, λ being the wavelength of the light rays.

Implementations can include one or more of the following features. The first retardation film is between the first linear polarizer and the liquid crystal layer. The first linear polarizer has a transmission axis that is perpendicular to that of the second linear polarizer, and the liquid crystal layer has a rubbing direction that is at an angle in a range between 40 to 50 degrees relative to a transmission axis of the second linear polarizer. The first retardation film includes a biaxially stretched film having principle refractive indices nₓ, n_{y}, and n_{z}, in which nₓ>n_{y} and n_{z}>n_{y}. The n_{z} axis of the first retardation film is along a direction that is substantially perpendicular to one of the first and second linear polarizers, and the n_{y} axis of the first retardation film is substantially parallel to the rubbing direction of the liquid crystal layer.

The pixel includes a pixel electrode in the transmissive and reflective regions, a reflective electrode in the reflective region, and a common electrode, in which the pixel electrode, the reflective electrode, and the common electrode are all at a same side relative to the liquid crystal layer. The pixel electrode includes strips, the common electrode is in a plane shape, and the pixel electrode is positioned between the common electrode and the liquid crystal layer. The common electrode includes strips, the pixel electrode is in a plane shape, and the common electrode is positioned between the pixel electrode and the liquid crystal layer. The display includes a second retardation film that can be, e.g., a uniaxial C-plate positioned between the first and second linear polarizers and having refractive indices nₓ=n_{y}≠n_{z}. The first and second retardation films are both closer to a backlight module than the liquid crystal layer.

In another aspect, in general, a method of operating a transflective liquid crystal display includes using a retardation film to impart a first phase retardation to normal incidence light to compensate a second phase retardation imparted to the light rays by a liquid crystal layer in a transmissive region of a pixel of the display to achieve a dark state when no data voltage or a data voltage corresponding to a dark state is applied to the pixel; and using a combination of the retardation film and a liquid crystal layer in a reflective region of the pixel to impart a phase retardation in a range between 0.22λ and 0.28λ to normal incidence light to achieve a dark state when no data voltage or a data voltage corresponding to a dark state is applied to the pixel, λ being the wavelength of the light rays.

Implementations can include one or more of the following features. The method includes providing a first linear polarizer and a second linear polarizer, the first linear polarizer being closer to a backlight module than the second linear polarizer, the first and second linear polarizers being at opposite sides of the liquid crystal layer, the liquid crystal layer having a rubbing direction that is at an angle in a range from 40 to 50 degrees relative to a transmission axis of the second linear polarizer. Using the retardation film includes using a biaxially stretched film having principle refractive indices nₓ, n_{y}, and n_{z}, in which nₓ>n_{y} and n_{z}>n_{y}. The n_{z} axis of the retardation film is along a direction that is substantially perpendicular to one of the first and second linear polarizers, and the n_{y} axis of the retardation film is substantially parallel to the rubbing direction of the liquid crystal layer. The method includes using a combination of a linear polarizer, the retardation film, and the liquid crystal layer in the reflective region to form a circular polarizer.

The method includes generating fringe electric fields in the liquid crystal layer, the fringe electric fields having components parallel to the liquid crystal layer surface, by applying a data voltage between a pixel electrode and a common electrode in the transmissive region, and applying the data voltage between a reflective electrode and the pixel electrode in the reflective region, in which the pixel electrode, the reflective electrode, and the common electrode are all at a same side relative to the liquid crystal layer. In some examples, generating the fringe electric fields includes applying a data signal to a pixel electrode having strips and a common electrode having a plane shape, the pixel electrode being positioned between the common electrode and the liquid crystal layer. In some examples, generating the fringe electric fields includes applying a reference voltage to a common electrode having strips and a pixel electrode having a plane shape, the common electrode being positioned between the pixel electrode and the liquid crystal layer. The method includes driving the transmissive and reflective regions using a single gray-scale control gamma curve.

The method includes compensating phase retardation imparted by the liquid crystal layer in the transmissive region to oblique incidence light using a first compensation film and a second compensation film to compensate an effective angle deviation between the first and second linear polarizers at off-axis and reduce off-axis light leakage, the first compensation film being closer to a backlight unit than the second compensation film, the first and second compensation films being at opposite sides relative to the liquid crystal layer. Using the first and second compensation films includes using a positive uniaxial A-plate having refractive indices nₓ>n_{y}=n_{z} and a negative A-plate having refractive indices n_{y}<nₓ=n_{z}. Using the first and second compensation films includes using compensation films having optic axes that are either parallel to or perpendicular to transmission axes of linear polarizers of the display. The method includes a second retardation film which can be, e.g., a uniaxial C-plate having nₓ=n_{y}≠n_{z}.

In another aspect, in general, a method of operating a transflective liquid crystal display includes using a first retardation film to impart a first phase retardation to normal incident light to compensation a second phase retardation imparted to the light by a liquid crystal layer in a transmissive region of a pixel of the display when the pixel is operating in a dark state; and using a liquid crystal layer in a reflective region of the pixel to impart a phase retardation in a range between 0.22λ and 0.28λ to normal incidence light when the pixel is operating in the dark state, λ being the wavelength of the light rays.

Implementations can include one or more of the following features. Using the first retardation film includes using a first retardation film positioned between a linear polarizer and the liquid crystal layer, the first retardation film being closer to a backlight unit than the liquid crystal layer. The method includes using a second retardation film, which can be, e.g., a uniaxial C-plate with nₓ=n_{y}≠n_{z} to reduce off-axis light leakage. Using the first and second retardation films including using first and second retardation films that are both closer to a backlight module than the liquid crystal layer.

In another aspect, in general, an apparatus includes a retardation film; and pixels each including means for canceling a phase retardation imparted to normal incident light by a liquid crystal layer in a transmissive region of a pixel of the display when the pixel is operating in a dark state, and for, in combination with a liquid crystal layer in a reflective region of the pixel, imparting a phase retardation in a range between 0.22λ and 0.28λ to normal incidence light when the pixel is operating in the dark state, λ being the wavelength of the light rays.

Other aspects can include other combinations of the features recited above and other features, expressed as methods, apparatus, systems, program products, and in other ways.

Advantages may include one or more of the following. The transflective display can be used indoors and outdoors with a good viewing angle. In some examples, only one retardation film is used to achieve a wide viewing angle, so the material cost and manufacturing complexity of the display is reduced compared to other designs that use multiple retardation films. The retardation film does not necessarily have to behave like a half-wave plate, so there is more flexibility in choosing the parameters of the retardation film.

### DESCRIPTION OF DRAWINGS

FIG. 1 is a cross-section view of an example pixel of a transflective display.

FIG. 2A is a top view diagram of the pixel.

FIG. 2B is a diagram showing the rubbing direction of the liquid crystal layer.

FIG. 2C illustrates the definition of the principle refractive indices.

FIGS. 3A and 3B show diagrams illustrating the operation mechanisms associated with the dark and bright states of the display.

FIGS. 4A and 4B are graphs showing V-R and V-T curves.

FIGS. 5A to 7B show iso-contrast plots.

FIGS. 8 to 10 are graphs showing V-R and V-T curves.

FIG. 11 is a top view of a pixel.

FIG. 12 is a cross-sectional view of an example pixel of a transflective display.

FIGS. 13A and 13B are graphs showing V-R and V-T curves.

FIGS. 14A to 16B are iso-contrast plots.

FIGS. 17 to 19 are graphs showing V-R and V-T curves.

FIG. 20 is a cross-sectional view of an example pixel of a transflective display.

FIG. 21A is a graph showing the liquid crystal molecule distribution in the bright state.

FIG. 21B is a diagram showing a cross sectional view of a portion of the pixel.

FIG. 22A is a graph showing V-R and V-T curves.

FIGS. 22B to 22E are iso-contrast plots.

FIGS. 23 to 25A are graphs showing V-R and V-T curves.

FIGS. 25B to 25E are iso-contrast plots.

FIGS. 26 and 27 are graphs showing V-R and V-T curves.

FIG. 28 is a cross-sectional view of an example pixel of a transflective display.

FIG. 29 is a Poincaré sphere diagram.

FIGS. 30A to 33B are iso-contrast plots.

FIG. 34 is a cross-sectional view of an example pixel of a transflective display.

FIG. 35 is a graph showing V-T and V-R curves.

FIGS. 36A and 36B are iso-contrast plots.

FIG. 37 is a graph showing V-T and V-R curves.

FIGS. 38A and 38B are iso-contrast plots.

FIG. 39 is a cross-sectional view of an example pixel of a transflective display.

FIG. 40 is a graph showing V-T and V-R curves.

FIGS. 41A to 42 are iso-contrast plots.

### DETAILED DESCRIPTION

The following describes examples of transflective liquid crystal displays that uses a small number (e.g., one) of compensation films while still achieving a high contrast ratio.

### Example 1

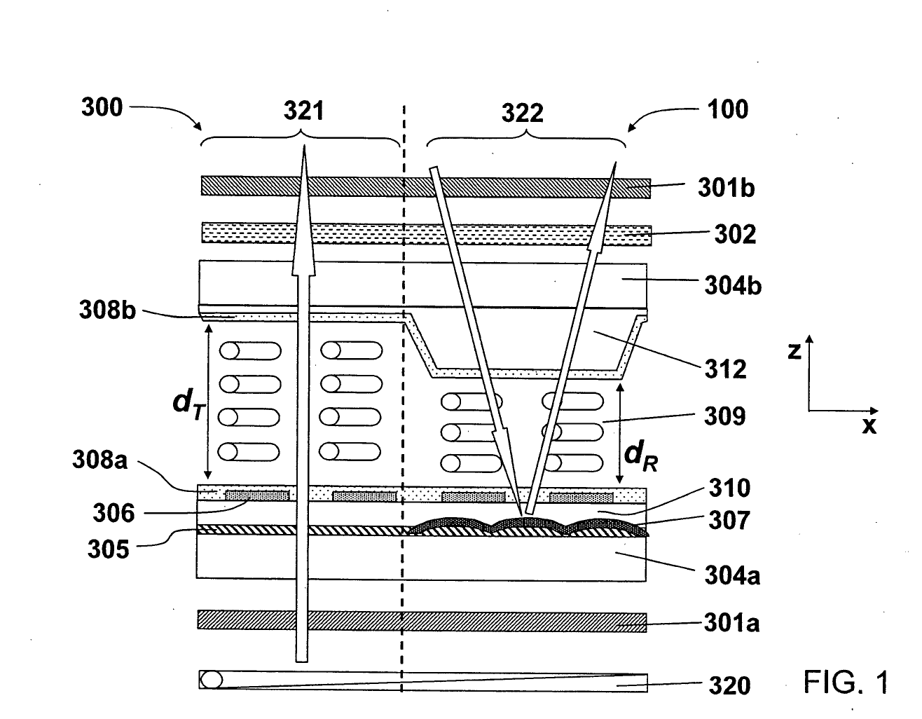

Referring to FIG. 1, in some implementations, a wide-view and high brightness transflective liquid crystal display 300 includes a plurality of pixels 100 (only one of which is shown in the figure) each including a transmissive region 321 and a reflective region 322. The pixel includes a liquid crystal layer 309 positioned between a bottom glass substrate 304a and a top glass substrate 304b. When operating in the transmissive mode, a backlight unit 320 provides backlight to illuminate the transmissive regions 321. When operating in the reflective mode, ambient light or light from a light source external to the display is reflected by reflectors in the reflective regions 322 of pixels. A feature of the display 300 is that the display 300 uses a single negative retardation film 302 to increase viewing angle. The parameters of the retardation film 302 and the liquid crystal layer 309 in the transmissive and reflective regions 321 and 322 are selected such that when no pixel voltage (or a pixel voltage that corresponds to a dark state) is applied to the pixel 100, there is little or no light leakage from the transmissive and reflective regions 321 and 322 for various light incident angles, enabling the display 300 to have a high contrast ratio over a wide range of viewing angles.

The liquid crystal layer 309 has an initial rubbing direction that is about 45° relative to the transmission axis of a top polarizer 301b. The thickness of the liquid crystal layer 309 in the transmissive region 321 is selected to achieve a maximum brightness during the bright state. In some examples, the phase retardation dΔn imparted to light by the liquid crystal layer 309 in the transmissive region 321 is between 0.5λ and 0.7λ, where λ is the wavelength of the incident light. The retardation film 302 has a phase retardation that is designed to fully cancel the phase retardation from the liquid crystal layer 309 in the transmissive region 321 with regard to normal incidence light when no pixel voltage (or a pixel voltage that corresponds to a dark state) is applied, resulting in a dark state in the transmissive region 321.

In this description, when we say a first direction is “about” n degrees relative to a second direction, we mean that the display is designed and configured such that the first direction is at n degrees relative to the second direction, but due to manufacturing tolerances, it is possible that the angle between the first and second directions is slightly different from n degrees. The term “normal incidence light” refers to light propagating in a direction that is perpendicular to the plane of the substrates. The term “oblique incidence light” refers to light propagating in a direction that is at an angle different from 90° relative to the plane of the substrates.

An overcoating layer 312 made of dielectric material, such as SiOₓ, SiNₓ, or some organic materials, is formed in the reflective region to cause the cell gap d_{R} in the reflective region 322 to be different from the cell gap d_{T} in the transmissive region 321. The thickness of the liquid crystal layer 309 in the reflective region 322 is selected such that the overall phase retardation from the retardation film 302 and the liquid crystal layer 309 in the reflective region 322 with respect to normal incidence light is about λ/4, where λ is the wavelength of the incident light. In some examples, the display is designed with respect to light having wavelength λ=550 nm. For examples, the phase retardation imparted to light by the liquid crystal layer 309 in the reflective region 322 can be between 0.25λ and 0.45λ. The retardation film 302, the liquid crystal layer 309 in the reflective region 322, and an upper polarizer 301b form a circular polarizer such that ambient light after being reflected by a reflective electrode does not pass the linear polarizer 301b, resulting in a dark state in the reflective region 322 when no pixel voltage (or a pixel voltage that corresponds to a dark state) is applied.

By using a single retardation film 302, the cost of the display 300 can be reduced (as compared to a display that uses multiple retardation films or uses a patterned in-cell-retarder) while still maintaining a high picture quality.

The display 300 includes two alignment layers 308a and 308b, which can be made of polyimide materials that are formed on the inner surfaces of the substrates 304a and 304b, respectively. The alignment layers 308a and 308b are configured such that liquid crystal molecules in the liquid crystal layer 309 are initially homogeneously aligned with their optic axes substantially parallel to the bottom glass substrate 304a.

A first plane-shaped electrode 305, made of transparent conductive materials such as indium-tin-oxide (ITO) or indium-zinc-oxide (IZO), is formed on the bottom glass substrate 304a. In this example, the electrode 305 functions as a common electrode. In the reflective region 322, a metal reflector layer 307 made of conductive materials such as aluminum or silver is formed above the electrode 305 and electrically connected to the electrode 305. A passivation layer 310, made of dielectric materials such as SiOₓ or SiNₓ, is coated on the electrode 305 and the metal reflector 307. Elongated strips of electrodes 306 that are electrically connected to each other and made of transparent conductive materials, such as ITO or IZO, are formed on the passivation layer 310 and function as the pixel electrode 306.

In this example, the retardation film 302 is a biaxially stretched polymer film having principle refractive indices nₓ, n_{y}, and n_{z}, in which nₓ>n_{y} and n_{z}>n_{y} (the definition of nₓ, n_{y}, and n_{z} is provided below). The retardation film 302 extends over both the transmissive region 321 and the reflective region 322. The retardation film 302 has its n_{z} axis along a direction that is substantially perpendicular to the two linear polarizers 301a and 301b, and its n_{y} axis substantially parallel to the rubbing direction of the liquid crystal layer 309.

Compared to displays that use three retardation films (e.g., see J. Matsushima, et al., “Novel transflective IPS-LCDs with three retardation plates,” Technical Digest of IDW' 07, pp. 1511-1514), the display 300 of FIG. 1 has a number of features or advantages:
The display 300 uses one negative retardation film (instead of three). This reduced the material cost and manufacturing complexity of the display 300.
The liquid crystal layer 309 has its initial rubbing direction substantially parallel to the negative retardation film 302, and the initial rubbing direction of the liquid crystal layer 309 is about 45° relative to the top polarizer transmission axis.
The overall retardation from the negative retardation film 302 and the reflective liquid crystal layer is about π/2, similar to that of a quarter-wave plate. In the reflective region 322, the phase retardation of the liquid crystal layer 309 itself does not necessarily have to be π/2. For example, the liquid crystal layer 309 in the reflective region 322 can have a retardation (e.g., 195 nm) that is larger than that of a quarter-wave plate (e.g., 135 nm), which allows the display 300 to have a better reflectance and fabrication tolerance.
The retardation film 302 does not necessarily behave like a half-wave plate (e.g., having a retardation value of π).

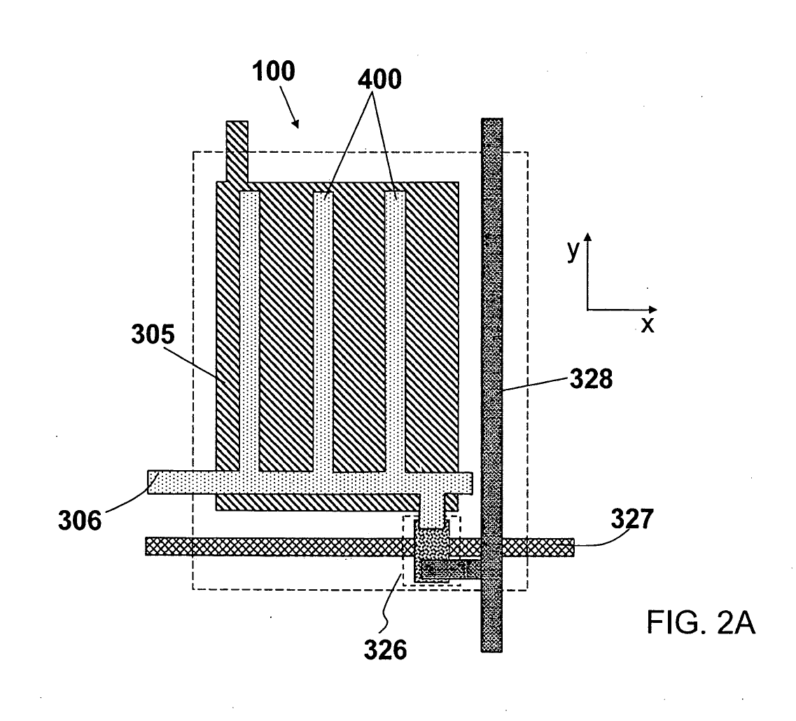

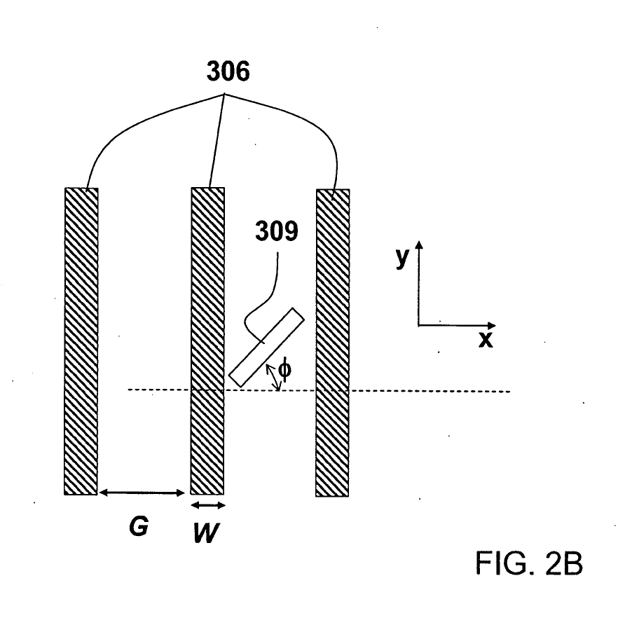

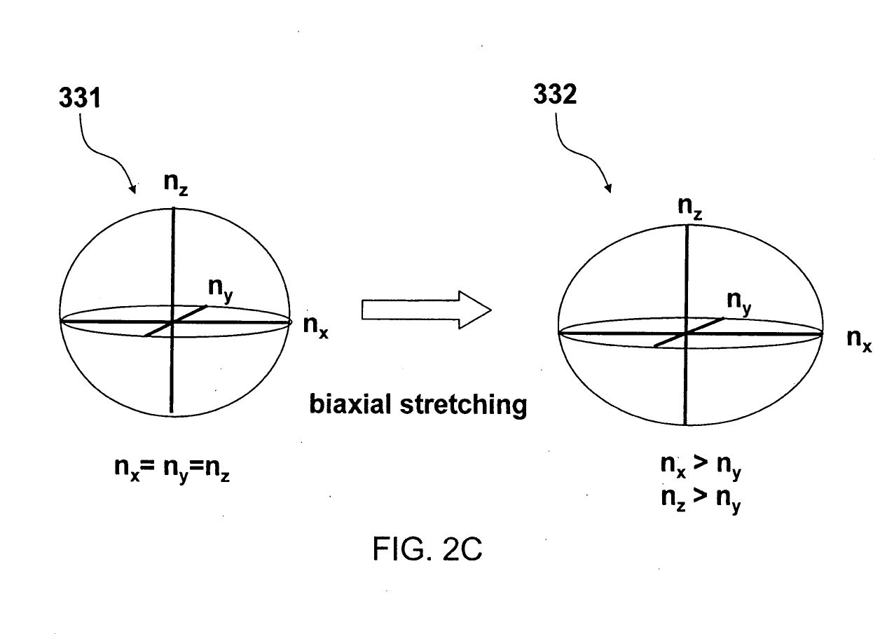

FIG. 2A is a top view diagram of the pixel 100 of FIG. 1. A thin-film-transistor (TFT) 326 switches the pixel 100 on or off. A gate line 327 is formed below the TFT 326. When the gate line 327 turns on the TFT 326, the driving voltage for each pixel is applied from a data line 328 to the pixel electrode 306 through a source node of the TFT 326. The driving pixel electrode 306 includes several elongated strips that are connected to each other. The common electrode 305 is formed below the pixel electrode 306. The common electrode 305 has a planer shape and is connected to a common voltage level. In some implementations, the common electrode 305 for all pixels in the display 300 are electrically connected together.

FIG. 2B is a diagram showing the rubbing direction of the liquid crystal layer 309 on the lower substrate 304a. The surface rubbing direction of the liquid crystal layer 309 is aligned at an angle of φ with respect to the direction that is perpendicular to the electrode strips 306. Here, the electrode strips have an electrode width of W and a gap G between neighboring strips.

FIG. 2C illustrates the definition of the 3-dimensional principle refractive indices nₓ, n_{y}, and n_{z} of an example retardation film 302 used in the display 300 of FIG. 1. See Y. Fujimura et al, “Improvement of optical films for high performance LCDs,” SPIE proceedings, vol. 5003, pages 96-105, 2003. A refractive index ellipsoid 331 of an isotropic polymer film indicates that the refractive indices nₓ, n_{y}, and n_{z} of the isotropic polymer film are equal in all directions (i.e., nₓ=n_{y}=n_{z}). After a biaxial stretching in the nₓ-n_{z} plane, the refractive index ellipsoid 331 changes to the refractive index ellipsoid 332, where its principle refractive indices nₓ, n_{y}, and % have values such that nₓ>n_{y} and n_{z}>n_{y}.

For the retardation film 302 used in the display 300 of FIG. 1, the n_{z} axis is placed substantially parallel to the z-axis of the display 300 (the z-axis is perpendicular to the plane polarizers 301a and 301b), and the refractive indices are selected such that nₓ>n_{y} and n_{z}>n_{y}. In one example, n_{y}<nₓ=n_{z}, in which the biaxial retardation film becomes a uniaxial negative A-plate.

In order to uniquely define an optical arrangement of the retarder 302, we can set the refractive indices of the retarder 302 such that n_{y}<nₓ and assign n_{y} along a particular direction. For example, a first retarder in which n_{y}>nₓ, and n_{y} is at a direction with an angle α in the x-y plane is optically equivalent to a second retarder in which n_{y}<nₓ, and n_{y} is at a direction with an angle α+90° in the x-y plane. Therefore, for the discussion of the retardation film 302 with nₓ>n_{y}, and n_{z}>n_{y} and its n_{z} axis perpendicular to the polarizer surface, we can set n_{y}<nₓ and only assign the direction of n_{y}.

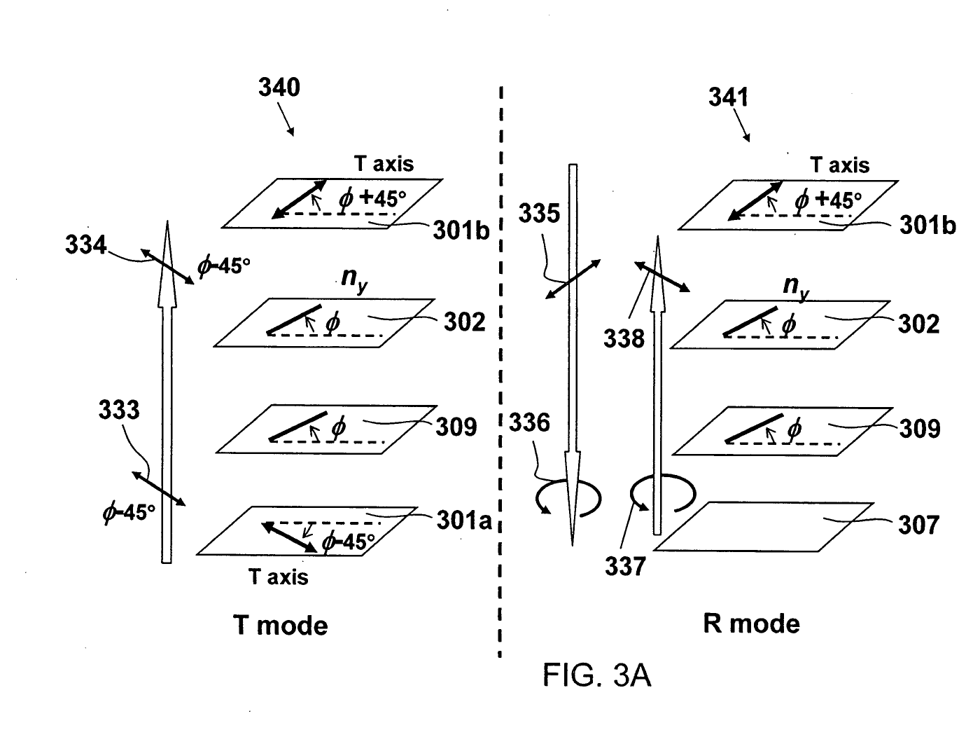

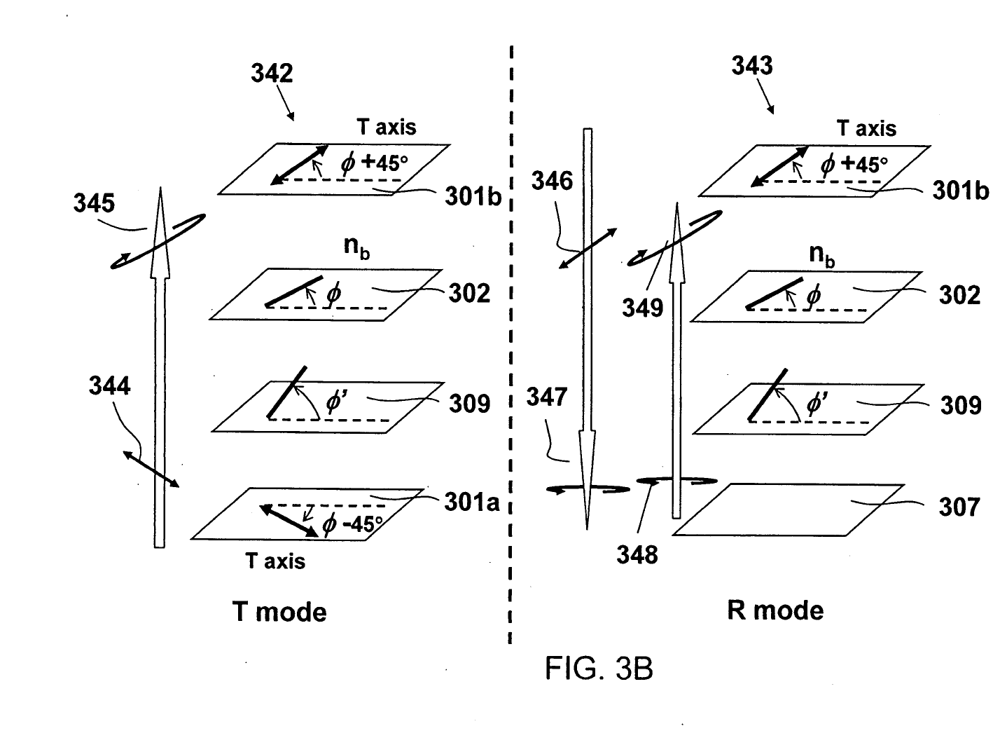

FIG. 3A show diagrams illustrating the operation mechanisms associated with the dark state of the display 300. In FIG. 3A, the liquid crystal layer 309 is initially aligned at an angle of φ with respect to the x-axis (defined as the axis that is perpendicular to the electrode stripes shown in FIG. 2B), and the top retardation film 302 (with its refractive indices nₓ>n_{y}, and n_{z}>n_{y}) has its n_{z} axis along the z-axis, and its n_{y} axis aligned substantially parallel to the liquid crystal rubbing direction. The bottom polarizer 301a has its transmission axis aligned at 45° from the liquid crystal rubbing direction φ. The top linear polarizer 301b has its transmission axis aligned perpendicular to that of the bottom linear polarizer 301a.

The initially homogeneously aligned liquid crystal layer 309 is similar to a uniaxial positive A-plate, which has its optic axis as nₓ aligned at φ and nₓ>n_{y}=n_{z}. In FIG. 3A, a diagram 340 shows how a dark state is achieved in the transmissive region 321. The light from the backlight unit 320 becomes a linearly polarized light 333 at φ-45° after passing the bottom linear polarizer 301a. Because the liquid crystal layer 309 has its optical axis nₓ (where nₓ>n_{y}=n_{z}) aligned parallel to the n_{y} axis of the retardation film 302 (where nₓ>n_{y} and n_{z}>n_{y}), their in-plane phase retardation d(nₓ−n_{y}) cancel each other. The output light 334 from the top retardation film 302 has a same polarization direction as the light 333, and is blocked by the top linear polarizer 301b.

A diagram 341 shows how a dark state is achieved in the reflective region 322. The incident light from the top linear polarizer 301b initially has a linear polarization 335 that is parallel to the transmission axis of the top linear polarizer 301b, which is 45° away from the n_{y} axis of the retardation film 302 and the optical axis of the liquid crystal layer 309.

The overall phase retardation from the top retardation film 302 and the liquid crystal layer 309 in the reflective region is designed to be about λ/4, the light 335 is converted to a circularly polarized light 336 after passing the liquid crystal layer 309 in the reflective region 322, and is reflected back to the top side by the reflector electrode 307. The reflected light 337 has a handiness opposite to that of the incident light 336, as their propagation direction is inverted. The light 337 passing the effective quarter-wave plate formed by both the liquid crystal layer 309 and the retardation film 302 becomes a linearly polarized light 338 that is perpendicular to the transmission axis of the top linear polarizer 301b. The light 338 is blocked by the top linear polarizer 301b, resulting in a dark state. Therefore, the transmissive region 321 and the reflective region 322 can have a common dark state when no pixel voltage (or a pixel voltage corresponding to a dark state) is applied to the pixels 100 of the display 300.

FIG. 3B shows diagrams illustrating the operation mechanisms associated with the bright state of the display 300. When a high pixel voltage (or a pixel voltage that corresponds to a bright state) is applied between the electrodes 305 and 306, fringe fields with strong horizontal components rotate the liquid crystal molecules substantially to change the effective optical axis from the rubbing direction at φ to a different direction at φ′.

A diagram 342 shows how a bright state is achieved in the transmissive region 321. The light 344 from the bottom linear polarizer becomes an elliptically polarized light 345 before impinging onto the top linear polarizer 301b, and part of the light 345 passes the top linear polarizer, resulting in a bright state.

A diagram 343 shows how a bright state is achieved in the reflective region 322. The incident linearly polarized light 346 from the top linear polarizer 301b becomes an elliptically polarized light 347 before reaching the reflective electrode 307, and the reflected elliptically polarized light 348 after passing the liquid crystal layer 309 becomes another elliptically polarized light 349 just before reaching the top linear polarizer 301b, and part of the light 349 passes the top linear polarizer 301b, resulting in a bright state.

By varying the pixel voltage level applied between the electrodes 305 and 306, the phase retardation imparted to the light passing the liquid crystal layer varies, allowing the pixel 100 to show varying gray scale levels.

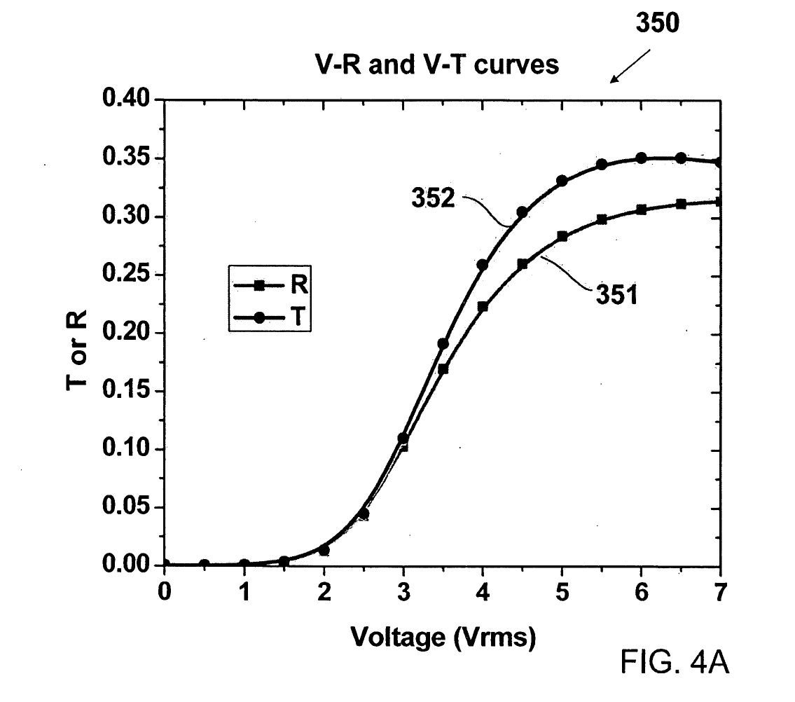

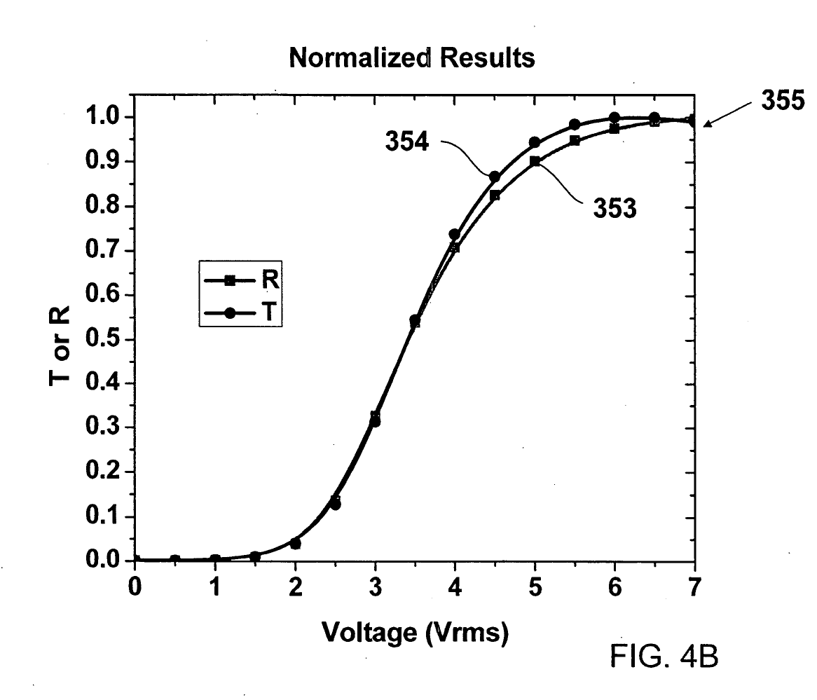

In the description below, FIGS. 4A to 11 show voltage-dependent reflectance curves, voltage-dependent transmittance curves, and iso-contrast plots for the transmissive and reflective regions of examples of the display 300 in FIG. 1, in which the values for various parameters are varied for different graphs.

FIG. 4A is a graph 350 showing a voltage-dependent reflectance (V-R) curve 351 and a voltage-dependent transmittance (V-T) curve 352 for the display 300 in FIG. 1. In this example, the electrode width W and gap G (as shown in FIG. 2B) are 3 μm and 4 μm, respectively. The liquid crystal material used is MLC-6608, a negative dielectric anisotropic liquid crystal material from Merck having parameters as follows: elastic constants K₁₁=16.7 pN, K₃₃=18.1 pN, dielectric anisotropy Δ∈=∈_{//}−∈_{⊥}=−4.2, and optical birefringence Δn=0.083 at λ=550 nm. The liquid crystal cell gap d_{T} for the transmissive region 321 is set at 4 μm and the cell gap d_{R} for the reflective region 322 is set at 2.34 μm.

The rubbing angle of the liquid crystal material is set at φ=10°, and the liquid crystals are initially homogeneously aligned with a pretilt angle of about 2°. The retardation film 302 is made of a negative A-plate with its n_{z} axis along the z-axis, and its nₓ and n_{y} axes are set in the x-y plane, where n_{y}<nₓ=n_{z}. In this example, nₓ=n_{z}=1.65, and n_{y}=1.55, and its n_{y} axis is aligned parallel to the liquid crystal rubbing direction. The thickness of the retardation film 302 is set at 3.32 μm.

The bottom polarizer 301a has a transmission axis set at −35° (relative to the x-axis in FIG. 2B) and the top linear polarizer 301b has a transmission axis set at 55°. The overall phase retardation from the liquid crystal layer in the reflective region 322 and the retardation film 302 is about 2.34 μm×0.083−3.32 μm×0.1=−0.1378 μm ˜−λ/4, where the incident light is assumed to be a green light with λ=550 nm. In this example, the maximum possible transmittance from the two parallel linear polarizers is about 37%.

FIG. 4A shows that both the reflective curve 351 and the transmittance curve 352 can reach a high light efficiency. At about 6 Vrms (root-mean-square voltage), the transmittance is about 35% and the reflectance is about 31%, meaning that the efficiencies reach about 94% for the transmissive region 321 and 84% for the reflective region 322.

FIG. 4B is a graph 355 showing a normalized V-R curve 353 and a normalized V-T curve 354 that substantially match each other. This indicates the display 300 can be driven by a single gray-scale gamma curve using a single set of drivers.

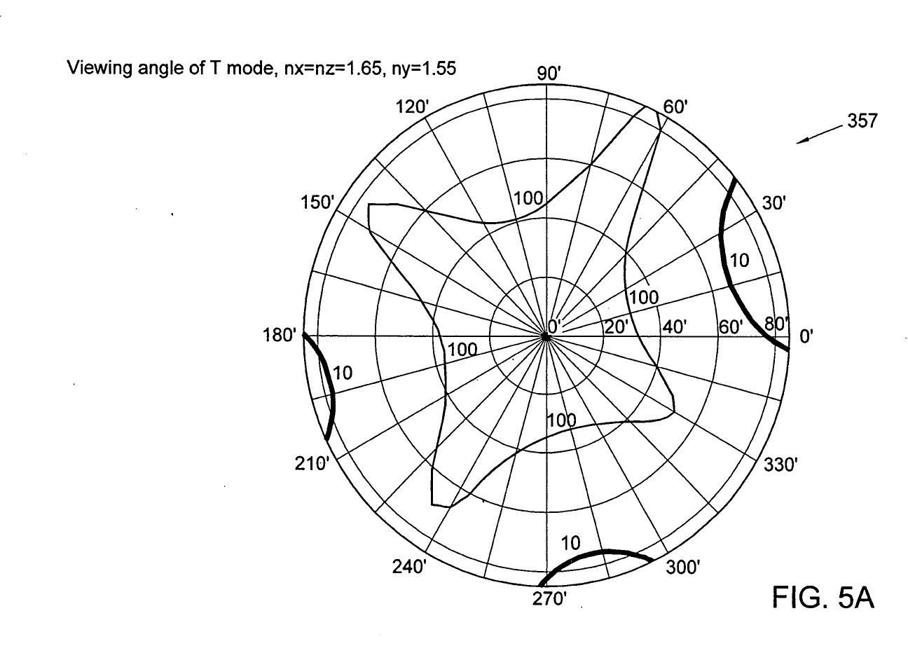

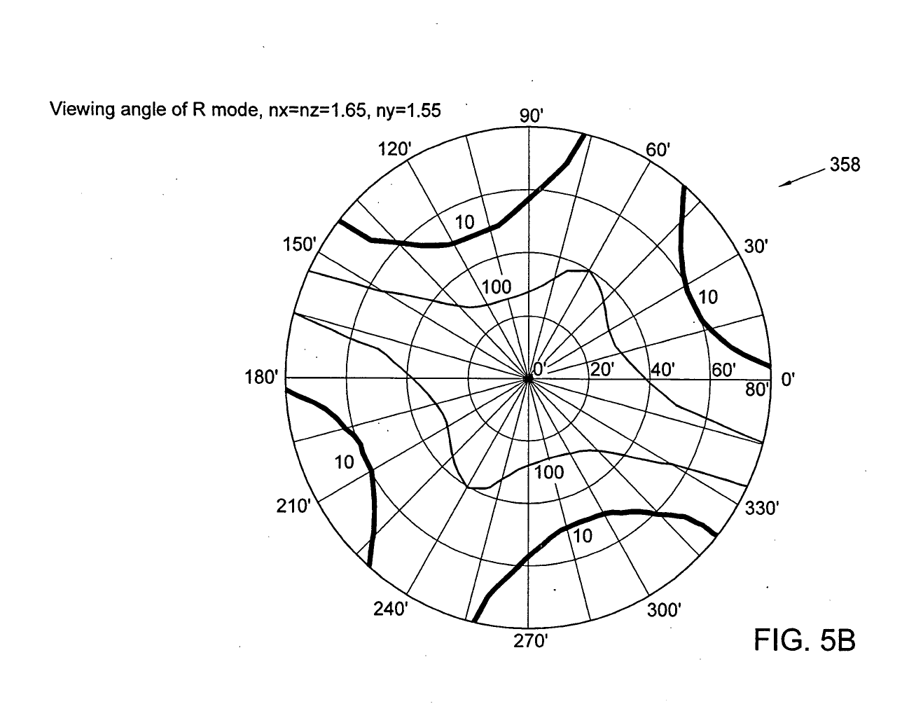

The data points in the graphs or plots shown in FIGS. 4A and 4B were obtained by simulation. The data points in the graphs or plots shown in FIGS. 5A-10, 13A, 13B, were also obtained by simulation.

FIGS. 5A and 5B show iso-contrast plots 357 and 358 of the transmissive region 321 and the reflective region 322, respectively, when the display 300 of FIG. 1 uses a negative Δ∈ liquid crystal material. The iso-contrast plot 357 (FIG. 5A) indicates that, for the transmissive region 321, the viewing cone with a contrast greater than 10:1 extends over about 70° in most directions. The iso-contrast plot 358 (FIG. 5B) indicates that, for the reflective region 322, the viewing cone with a contrast greater than 10:1 extends over about 50° in most directions. The viewing angle of the display is quite wide. The display is suitable for many applications, such as for use in mobile devices. In the simulations for generating the data shown in FIGS. 5A and 5B, the parameters for the display 300 are similar to those for FIGS. 4A and 4B. In this example, the retardation film 302 has refractive indices nₓ=n_{z}=1.65 and n_{y}=1.55.

In some examples, the retardation film 302 does not necessarily have to be a uniaxial negative A-plate. As long as its refractive indices meet the criteria nₓ>n_{y} and n_{z}>n_{y}, its in-plane phase retardation can compensate the phase retardation from the liquid crystal layer to achieve a good dark state and a wide viewing angle. In some examples, nₓ=1.65 and n_{y}=1.55, and the n_{z} value can be set in a range from 1.60 to 1.70.

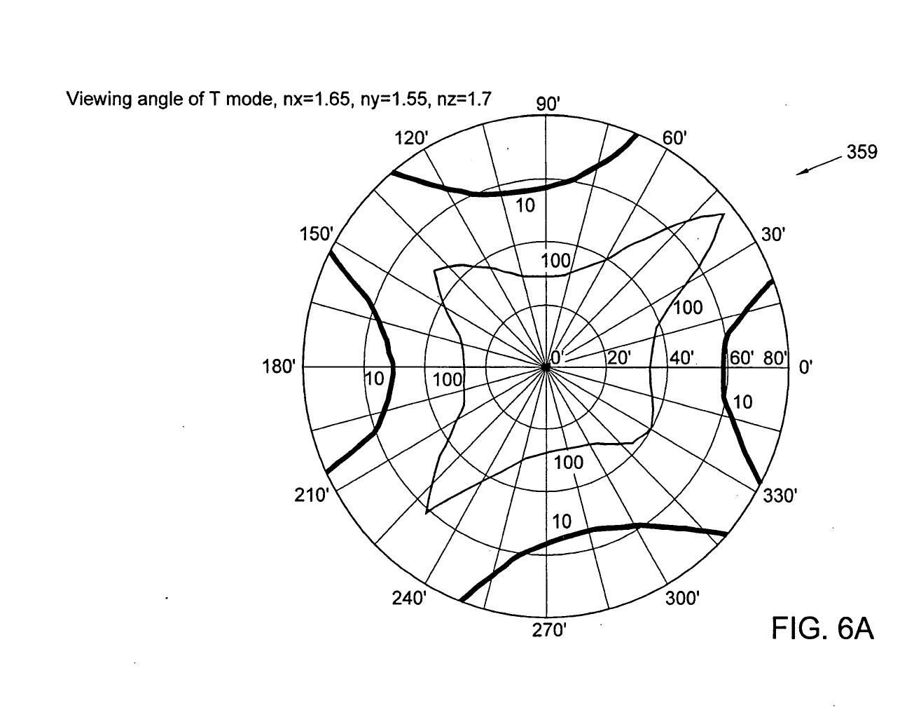

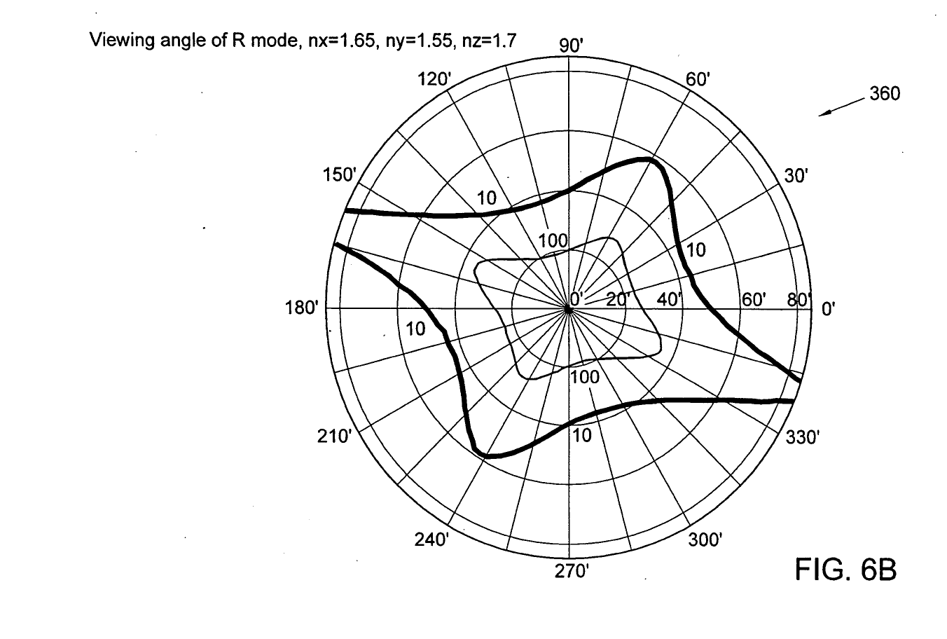

FIGS. 6A and 6B show a viewing angle plot 359 of the transmissive region 321 and a viewing angle plot 360 of the reflective region 322, respectively, where n_{z} of the retarder 302 is at 1.70. The other parameters are the same as those used for FIGS. 5A and 5B. As shown in FIG. 6A, a viewing cone with contrast ratio greater than 10:1 for the transmissive region 321 extends over 50°. As shown in FIG. 6B, a viewing cone with contrast ratio greater than 10:1 for the reflective region 322 extends over 40°.

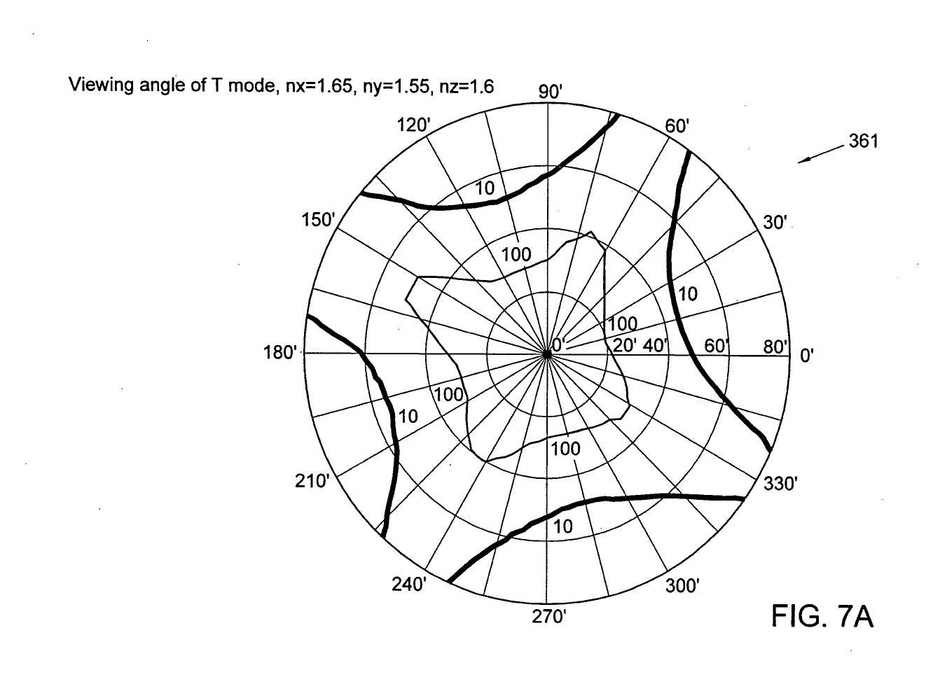

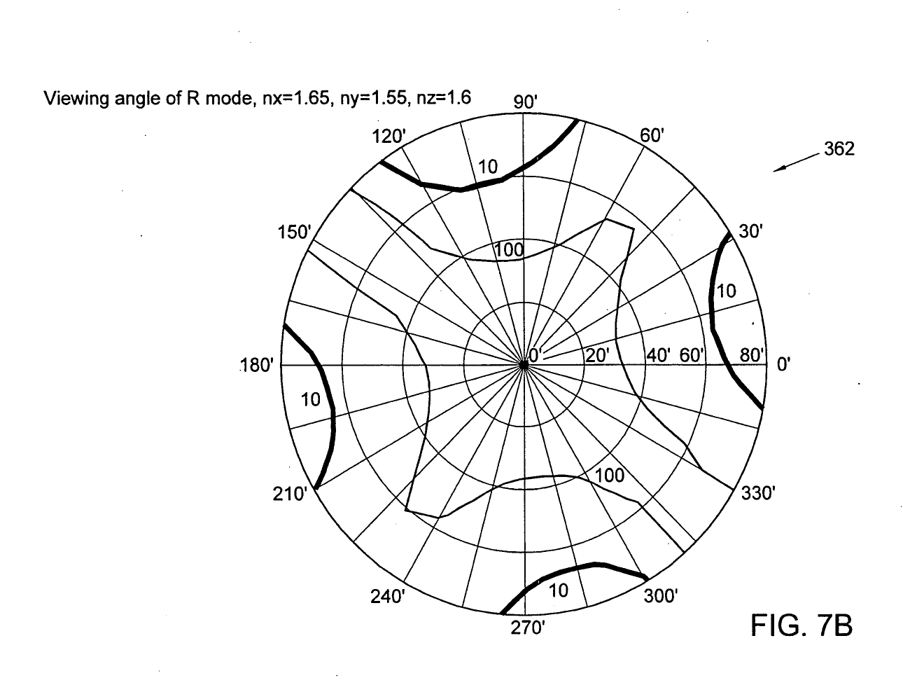

FIGS. 7A and 7B show a viewing angle plot 361 of the transmissive region 321 and a viewing angle plot 362 of the reflective region 322, respectively, where n_{z} of the retarder 302 is at 1.60 (n_{z}>n_{y}). The other parameters are the same as those used for FIGS. 5A and 5B. As shown in FIG. 7A, a viewing cone with contrast ratio greater than 10:1 for the transmissive region 321 extends over 50°. As shown in FIG. 7B, a viewing cone with contrast ratio greater than 10:1 for the reflective region 322 extends over 60°.

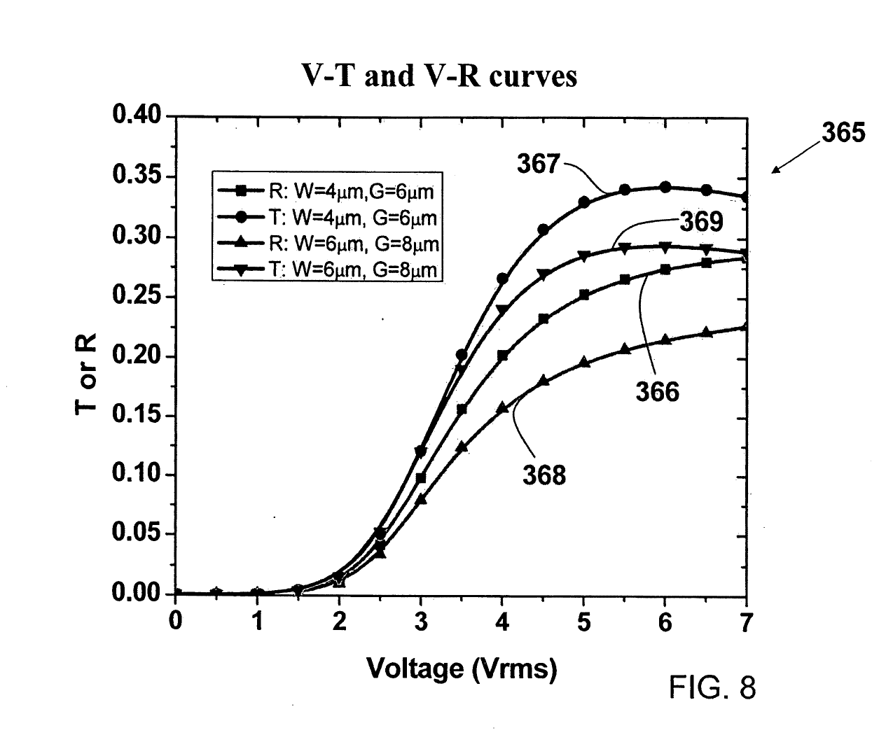

The electrode width and gap can be set at various values. FIG. 8 is a graph 365 showing voltage-dependent reflectance (V-R) and voltage-dependent transmittance (V-T) curves with various electrode width W and gap G values using a negative Δ∈ liquid crystal material. Curves 366 and 367 represent the V-R and V-T curves, respectively, for the case in which W=4 μm and G=6 μm. At V=6 Vrms, the reflectance is about 28%, and the transmittance is about 34%. Curves 368 and 369 represent the V-R and V-T curves, respectively, with W=6 μm and G=8 μm. At V=6 Vrms, the reflectance reaches about 23%, and the transmittance reaches about 28%. Here, the maximum possible light efficiency is about 37%, as evaluated from two parallel linear polarizers.

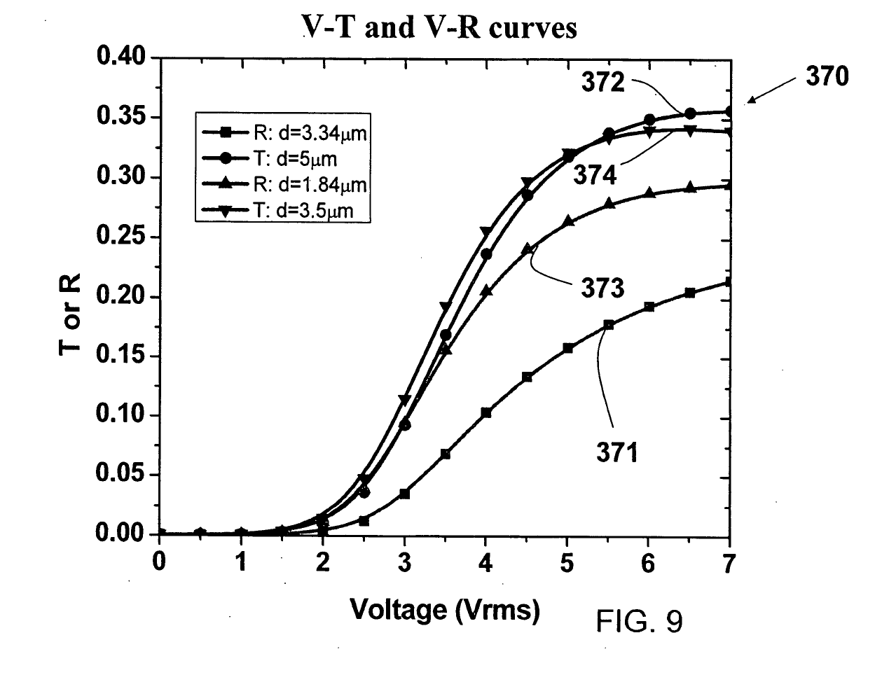

FIG. 9 is a graph 370 showing the V-T and V-R curves for different cell gap values of the liquid crystal layer 309, in which W=3 μm, G=4 μm, and a negative Δ∈ liquid crystal material is used. A V-R curve 371 represents voltage-dependent reflectance (V-R) characteristics when the cell gap d_{R} in the reflective region 322 is about 3.34 μm. A V-T curve 372 represents the voltage-dependent transmittance characteristics when the cell gap d_{T} for the transmittance region 321 is about 5 μm. When V=6 Vrms, the transmittance is about 35%, and the reflectance is about 20%.

A V-R curve 373 represents the voltage-dependent reflectance characteristics when the cell gap d_{R} in the reflective region 322 becomes 1.84 μm. A V-T curve 374 represents the voltage-dependent transmittance characteristics when the cell gap d_{T} for the transmittance region 321 is about 3.5 μm. Under such conditions, when V=6 Vrms, the transmittance is about 35% and the reflectance is about 30%, indicating a high light efficiency.

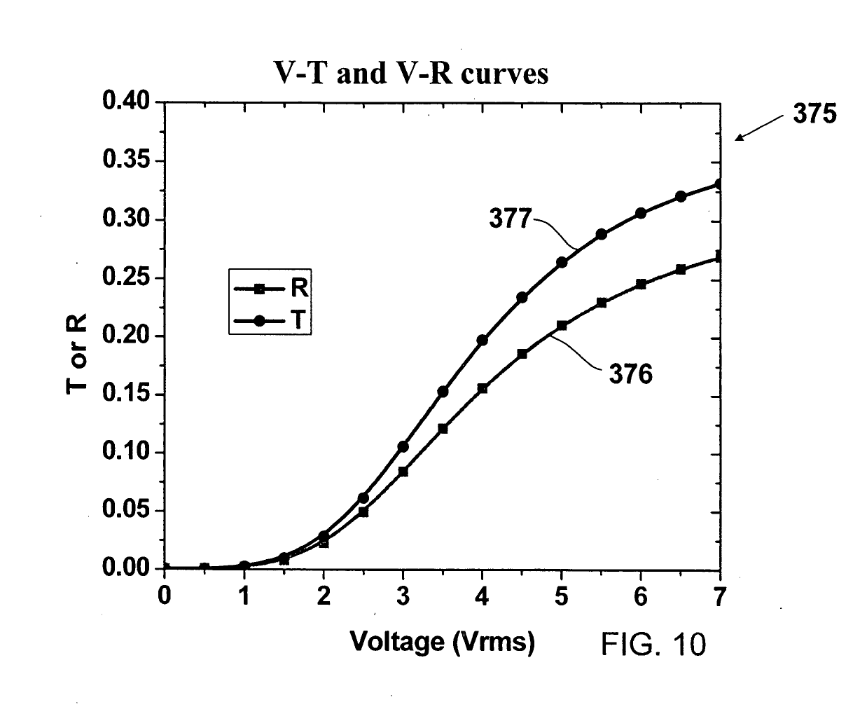

The display configuration is robust in regards to the surface rubbing angle. FIG. 10 is a graph 375 showing a V-R curve 376 and a V-T curve 377 in which the rubbing angle φ=30° and a negative Δ∈ liquid crystal material is used. The parameters used for the simulation of FIG. 10 are the same as those for FIG. 2A except that the rubbing angle φ is different. Both the V-R curve 376 and the V-T curve 377 indicate that this display configuration requires a higher driving voltage. At V=7 Vrms, the reflectance is about 27%, and the transmittance is about 33%.

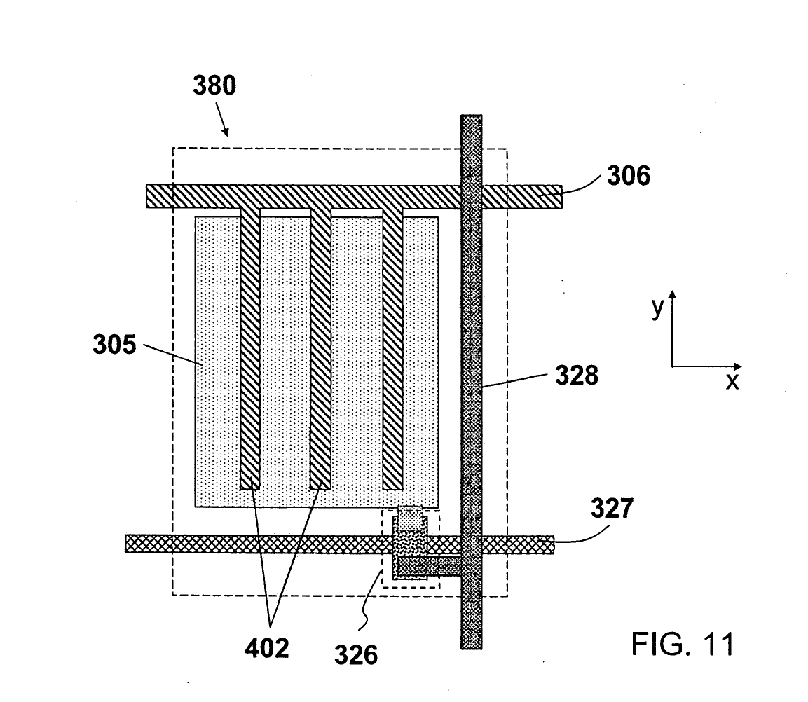

FIG. 2A shows an example pixel configuration in which the common electrode 305 is a plane electrode, and the pixel electrode 306 has multiple strips 400 that are electrically connected to the TFT 326. Referring to FIG. 11, in some examples, the locations and configurations of the pixel electrode and the common electrode can be interchanged. Here, a pixel 380 includes a pixel electrode 305 having the shape of a plane electrode that is connected to the TFT 326, and a common electrode 306 having multiple strips 402 that are electrically connected to a reference voltage. When the gate line 327 turns on the TFT 326, the driving voltage is transmitted from the data line 328 to the pixel 380. The voltage difference between the common electrode 306 and the pixel electrode 305 generates fringe electric fields having strong horizontal components in the liquid crystal cell region that cause the liquid crystal molecules to rotate, thereby affecting the gray scale level shown by the pixel 380.

### Example 2

The display 300 of FIG. 1 uses a negative dielectric anisotropic liquid crystal material. In some implementations, a positive dielectric anisotropic liquid crystal material can be used.

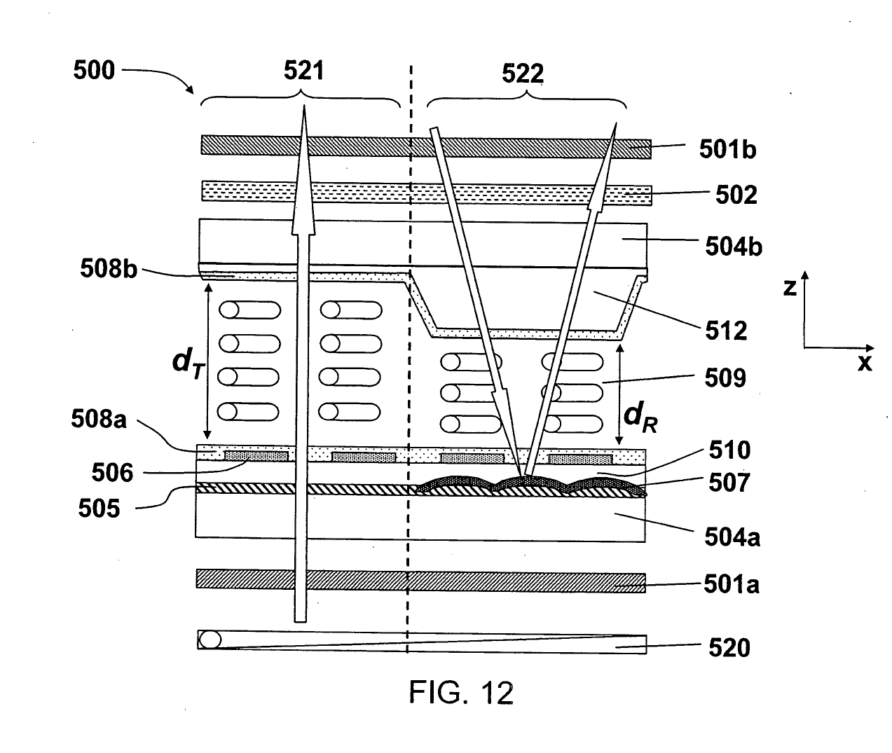

FIG. 12 is a cross-sectional view of an example wide-view and high brightness transflective liquid crystal display 500 that uses a positive dielectric anisotropic liquid crystal material. The display 500 has a structure similar to the display 300 of FIG. 1 and includes a plurality of pixels each divided into a transmissive region 521 and a reflective region 522. A liquid crystal layer 509 is positioned between two alignment layers 508a and 508b that are between a bottom glass substrate 504a and a top glass substrate 504b, which in turn are between a first linear polarizer 501a and a second linear polarizer 501b.

An overcoating layer 512 is formed in the reflective region 522 to reduce the cell gap d_{R} in the reflective region 522. A first driving electrode 505 having a plane shape is formed on the bottom substrate 504a, and a metal reflector electrode 507 is connected to the first driving electrode 505. A passivation layer 510 is coated over the electrode 505 and the reflector electrode 507. A second driving electrode 506 having multiple strips is formed on the passivation layer 510.

A retardation film 502 is positioned between the top glass substrate 504b and the top linear polarizer 501b. The retardation film 502 extends over both the transmissive and reflective regions. In the reflective region 522, the overall phase retardation from the retardation film 502 and the liquid crystal layer 509 is designed to be about λ/4, where λ is the wavelength of the desired incident light. The liquid crystal layer 509, the retardation film 502, and the top linear polarizer 501b together forms a circular polarizer to enable a dark state in the reflective region 522 when no voltage is applied.

In this example, the liquid crystal molecules are initially homogeneously aligned to the glass substrates. At its initial state, the liquid crystal layer 509 behaves like a positive uniaxial A-plate that has its n_{z} axis along the z-axis, and its optical axis nₓ along its rubbing direction in the x-y plane, while the refractive indices meet the following conditions: nₓ>n_{y}=n_{z}. The retardation film 502 can be a negative A-film or a biaxial film, such as a biaxially stretched polymer film with its principle refractive indices nₓ>n_{y}, and n_{z}>n_{y}. When n_{z}=nₓ, this is a uniaxial negative A-plate.

Here the retardation film 502 has its n_{y} axis aligned parallel to the liquid crystal rubbing direction. The retardation film 502 cancels the phase retardation from the liquid crystal layer 509 in the transmissive region to obtain a dark state when no pixel voltage or a pixel voltage corresponding to a dark state is applied to the pixel. When pixel voltages corresponding to gray-scale levels are applied between the electrodes 505 and 506, the liquid crystal molecules are rotated such that the transmissive region 521 and the reflectance region 522 have certain transmittance and reflectance, respectively, according to the pixel voltage levels.

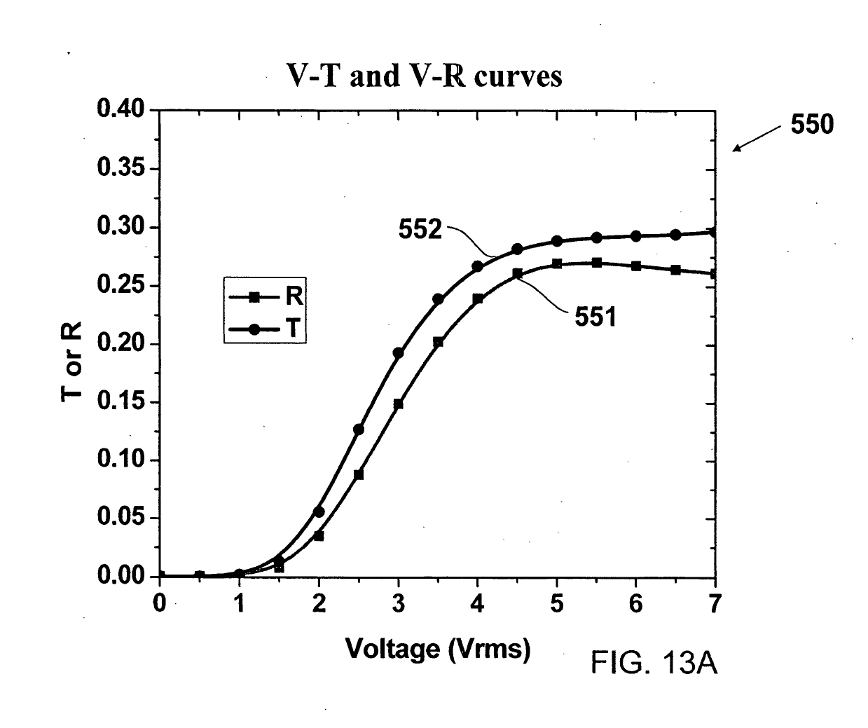

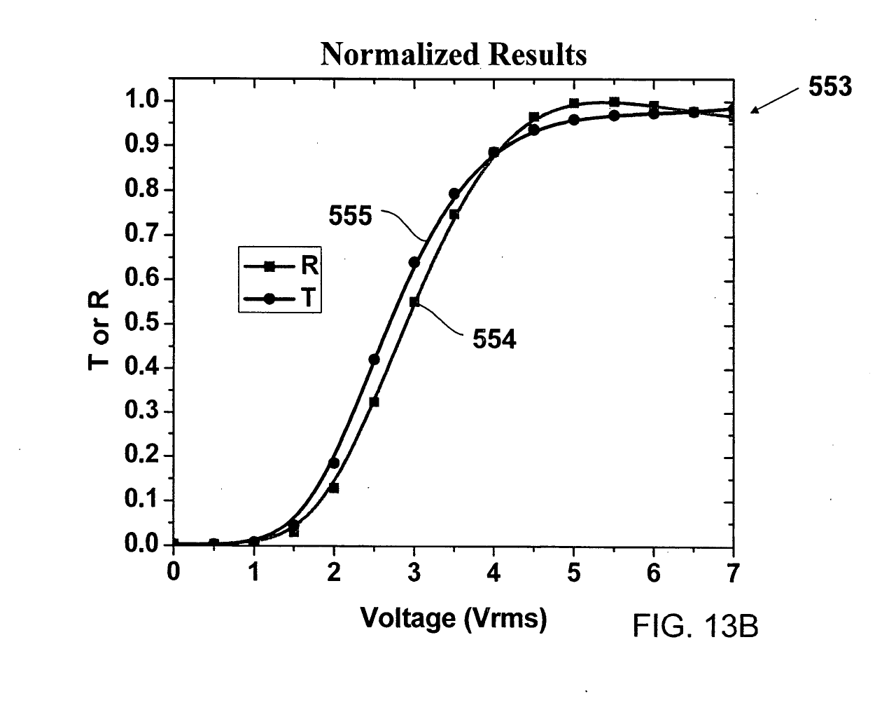

FIG. 13A is a graph 550 showing a V-R curve 551 and a V-T curve 552 for the display 500 of FIG. 12. In this example, the liquid crystal display 500 uses a positive Δ∈ liquid crystal material MLC-6686 having the following parameters: elastic constants K₁₁=8.8 pN, K₃₃=14.6 pN, dielectric anisotropy Δ∈=∈_{//}−∈_{⊥}=+10, and optical birefringence Δn=0.095 at λ=550 nm. The cell gap d_{T} in the transmissive region is 3.5 μm, and the cell gap d_{R} in the reflective region is 2.05 μm. The initial liquid crystal rubbing direction φ is about 80°. The retardation film 502 has its n_{y} axis also at 80°, with its principle refractive indices n_{y}<nₓ and n_{y}<n_{z}, where nₓ=n_{z}=1.65, and n_{y}=1.55. The thickness of the retardation film 502 is 3.33 μm. The phase retardation of the liquid crystal layer in the transmissive region 521 is cancelled by the retardation film 502. The overall phase retardation from the liquid crystal layer in the reflective region 522 and the retardation film 502 is about 3.33×(−0.1)+2.05×0.095=−0.1374 μm, which is close to a quarter-wavelength (137.5 nm) at 550 nm. The top linear polarizer 501b has its transmission axis at 45° away from the rubbing direction, and the bottom linear polarizer 501a has its transmission axis perpendicular to the top linear polarizer 501b. The electrode width W and gap G are 3 μm and 4 μm, respectively.

Comparing FIGS. 13A and 4A, it can be seen that the light efficiencies for both T and R regions 521 and 522 of the display 500 are reduced as compared to those of the display 300 in which a negative liquid crystal material is used. This is because the fringe electric fields between electrodes have some vertical electric field components, which make the liquid crystal molecules in part of the cell regions tilt up for a phase loss. However, the on-state voltage is reduced to about 5 Vrms because the positive liquid crystal material has a larger dielectric anisotropy Δ∈. At V=5 Vrms, the transmittance is about 30%, and the reflectance is about 26%, where the maximum possible value (the value from two parallel linear polarizers) is about 37%.

Referring to FIG. 13B, a graph 553 shows a normalized V-R curve 554 and a normalized V-T curve 555. The curves 554 and 555 have a good overlap with each other, indicating the display transmissive and reflective modes can be driven by a single gray-scale control gamma curve.

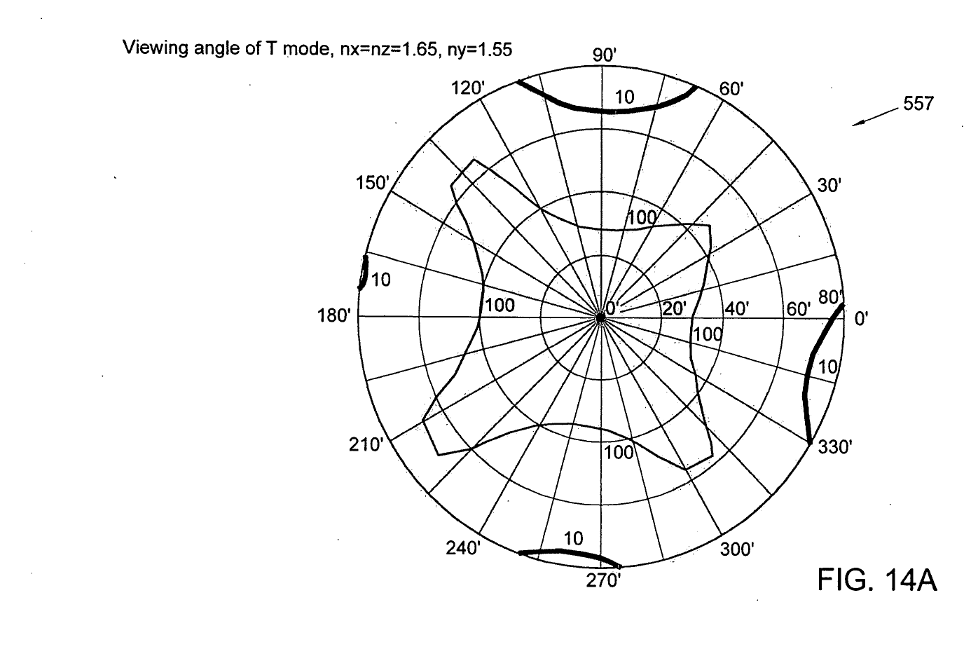

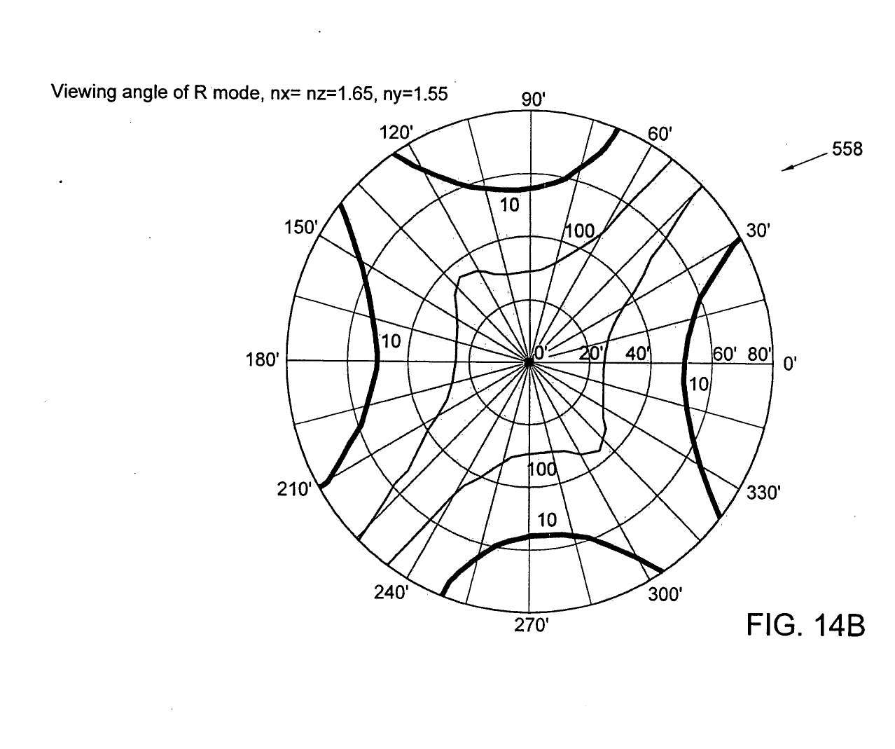

FIG. 14A shows an iso-contrast plot 557 for the display 500 when operating in the transmissive mode. The display 500 has a viewing cone with a contrast ratio over 10:1 that extends over 70° in most directions for the transmissive mode. In this example, the retardation film 502 is a negative A-plate that has a thickness of 3.33 μm and refractive indices nₓ=1.65, n_{y}=1.55, n_{z}=1.65. The n_{y} axis of the film is placed along the liquid crystal surface rubbing direction, which is at 80°.

FIG. 14B shows an iso-contrast plot 558 for the display 500 when operating in the reflective mode. The display 500 has a viewing cone with a contrast ratio over 10:1 that extends over 50° in most directions for the reflective mode.

As long as the n_{z} value is larger than the n_{y} value, and the n_{y} axis is placed along the liquid crystal rubbing direction, the retardation film 502 does not necessarily have to be a uniaxial A-plate.

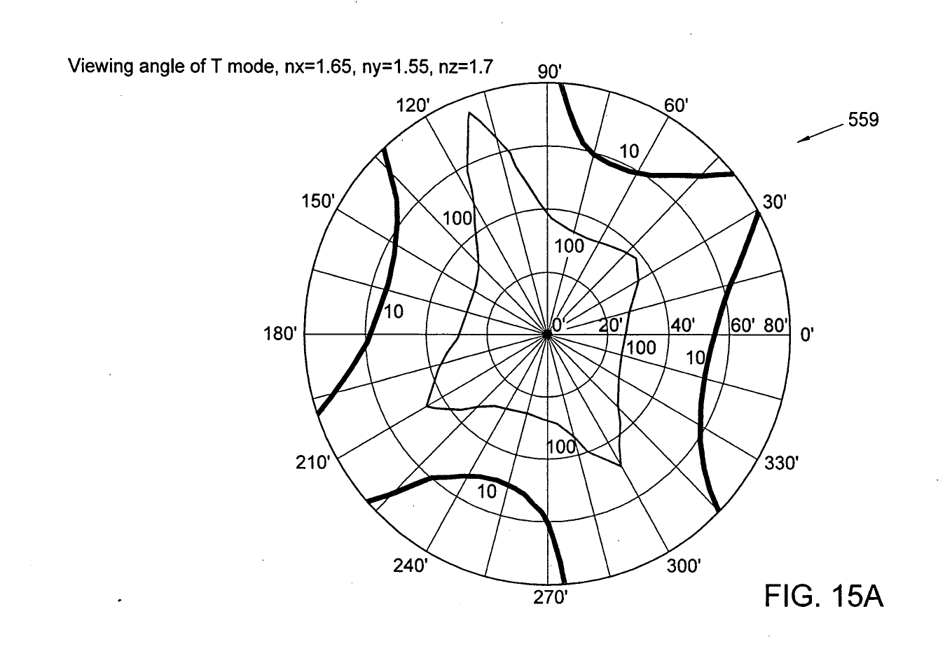

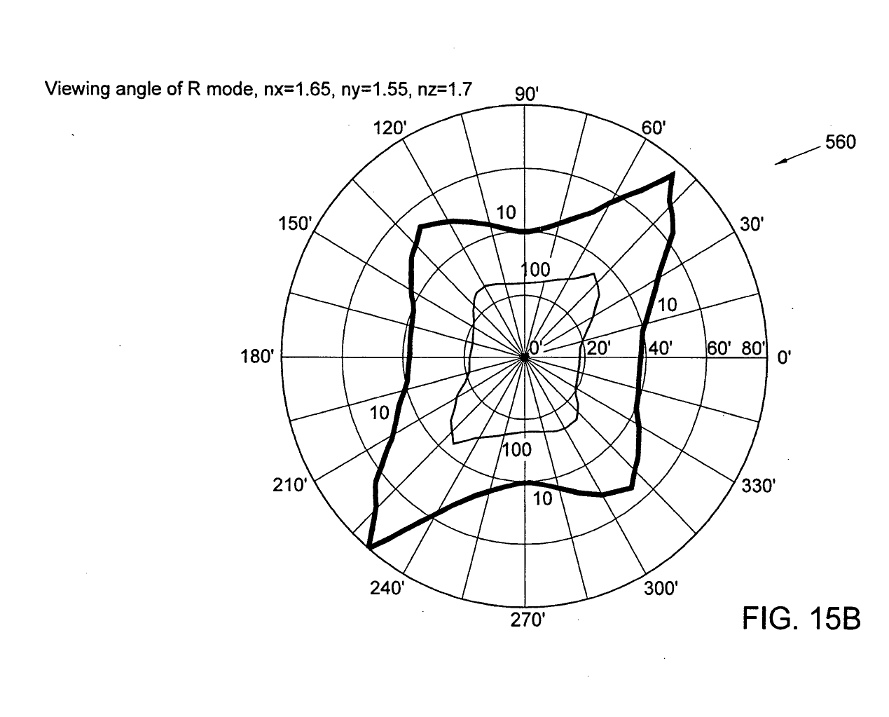

FIG. 15A shows an iso-contrast plot 559 for the display 500 operating in the transmissive mode when the retardation film 502 has refractive indices nₓ=1.65, n_{y}=1.55, and n_{z}=1.70. The parameters for the simulation of FIG. 15A are the same as those for FIG. 14A except that the values for n_{z} are different. The display 500 has a viewing cone having a contrast ratio over 10:1 that extends over 55° in most directions for the transmissive mode.

FIG. 15B shows a corresponding iso-contrast plot 560 when the display 500 is operating in the reflective mode. The display 500 has a contrast ratio over 10:1 that extends over 40° for the reflective mode. The parameters for the simulations of FIGS. 15A and 15B are the same as those for FIGS. 14A and 14B except that the values for n_{z} are different.

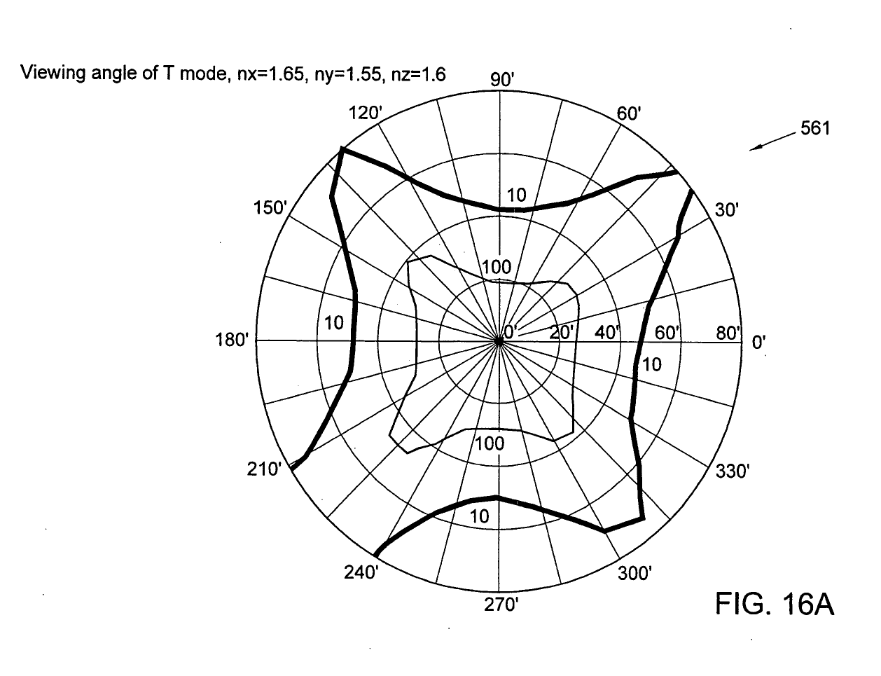

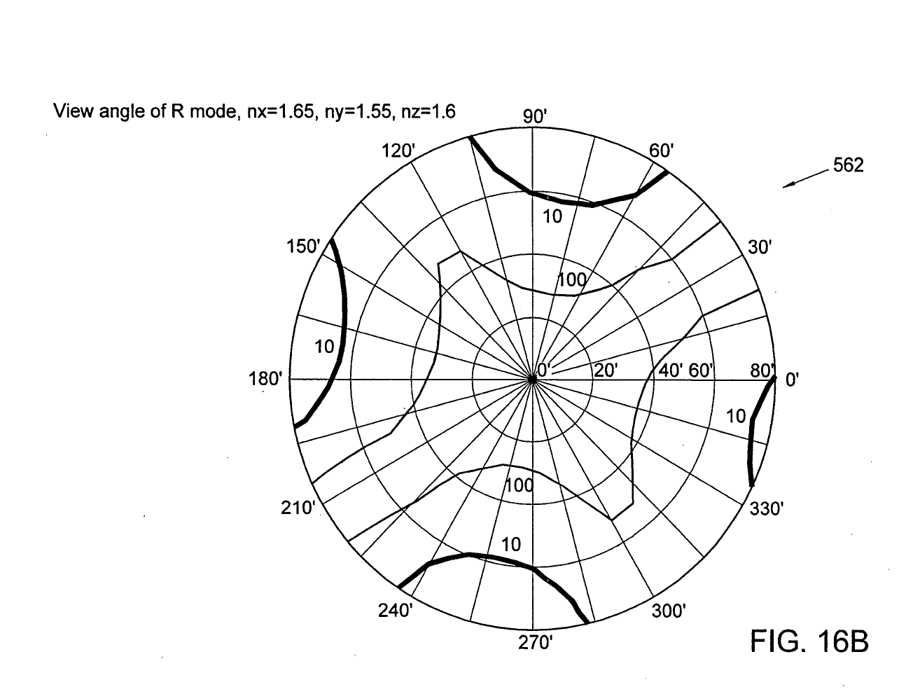

FIG. 16A shows an iso-contrast plot 561 for the display 500 operating in the transmissive mode when the retardation film 502 has refractive indices nₓ=1.65, n_{y}=1.55, and n_{z}=1.60. The display 500 has a viewing cone with contrast ratio over 10:1 that extends over 45° in most directions for the transmissive mode.

FIG. 16B shows a corresponding iso-contrast plot 562 for the display 500 operating in the reflective mode. The display 500 has a viewing cone with contrast ratio over 10:1 that extends over 60° in most directions for the reflective mode. The parameters for the simulations of FIGS. 16A and 16B are the same as those for FIGS. 14A and 14B except that the values for n_{z} are different.

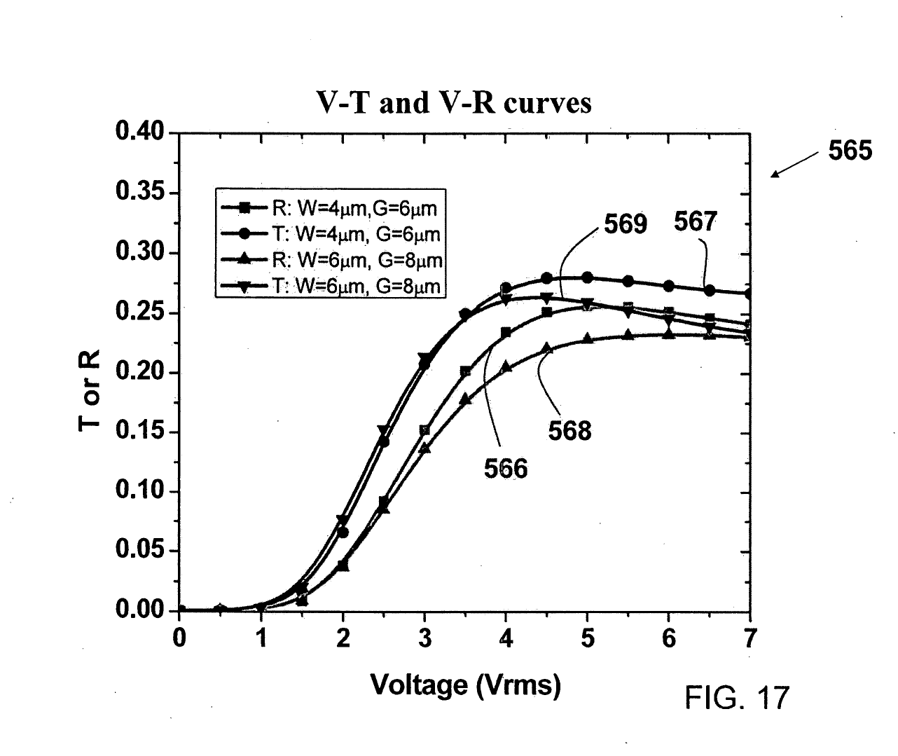

The electrode width (W) and gap (G) of the display 500 can have various values. FIG. 17 is a graph 565 showing V-R and V-T curves for the display with various electrode width W and gap G values using a positive Δ∈ liquid crystal material. A V-R curve 566 and a V-T curve 567 represent the voltage-dependent reflectance and voltage-dependent transmittance characteristics, respectively, of the display 500 when W=4 μm and G=6 um. At V=5 Vrms, the reflectance is about 25%, and the transmittance is about 28%.

A V-R curve 568 and a V-T curve 569 represent the voltage-dependent reflectance and voltage-dependent transmittance characteristics, respectively, of the display 500 when W=6 μm and G=8 μm. At V=5 Vrms, the reflectance is about 23% and the transmittance is about 26%. The maximum possible light efficiency here is about 37%, as evaluated from two parallel linear polarizers.

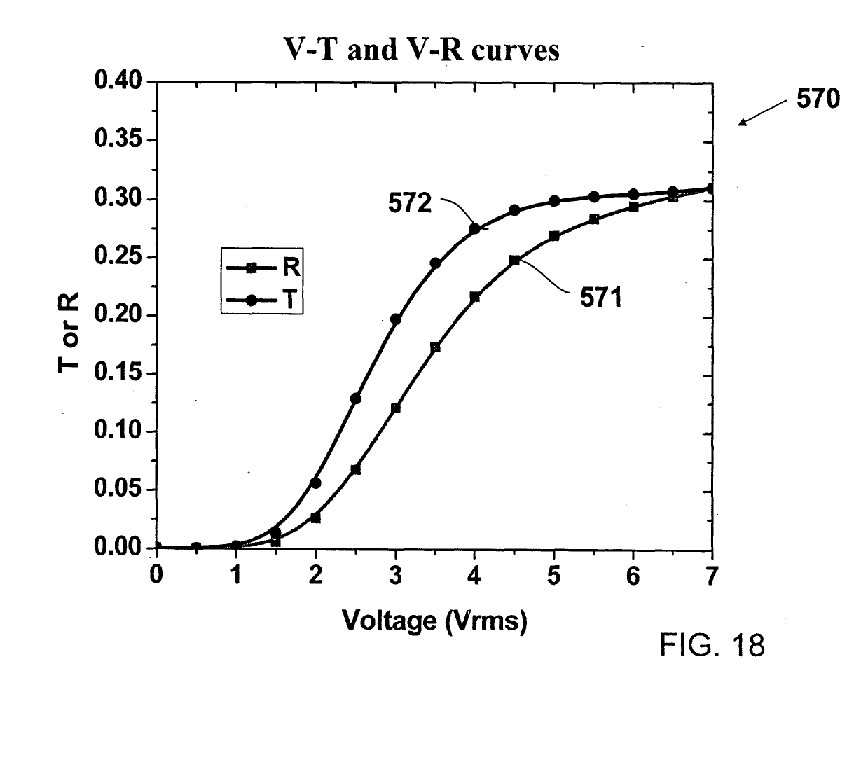

FIG. 18 is a graph 570 that shows a V-R curve 571 and a V-T curve 572 for the display 500 when the cell gap d_{T} in the transmissive region 521 is about 4.0 μm, and the cell gap d_{R} in the reflective region 522 is about 2.55 μm. A positive Δ∈ liquid crystal material is used. The electrode 506 has an electrode width W=3 μm and an electrode gap G=4 μm. In this example, at V=5.5 Vrms, the transmittance is about 28% and the reflectance is about 30%. The parameters for the simulation of FIG. 18 are the same as those for FIG. 13A except that the values for the cell gaps are different.

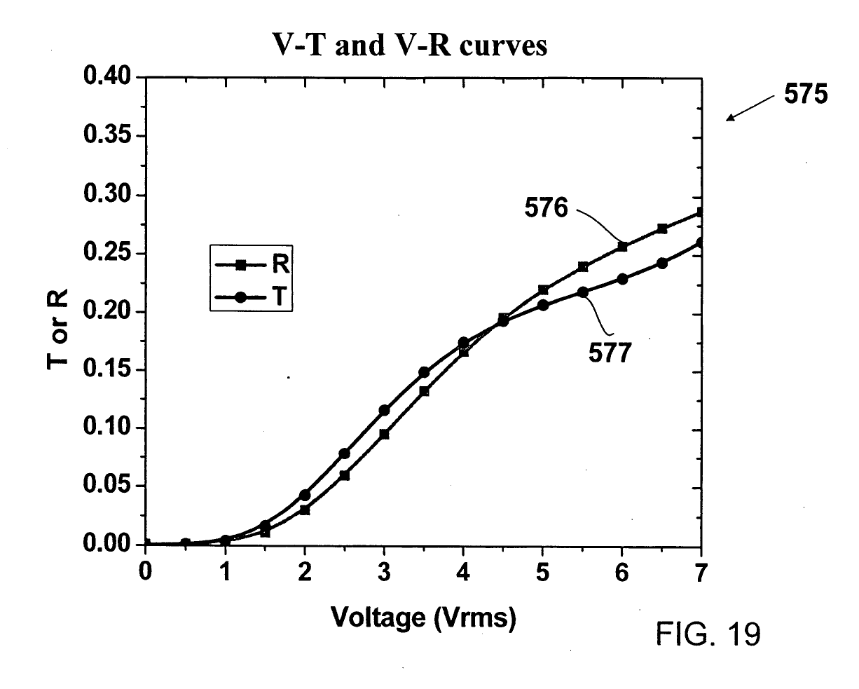

FIG. 19 is a graph 575 that shows a V-R curve 576 and a V-T curve 577 for the display 500 in which a rubbing angle φ=60° and a positive Δ∈ liquid crystal material are used. The curves 576 and 577 show that a higher driving voltage is required for the display 500 under this configuration (compared to the configuration in FIG. 13A). At V=7 Vrms, the reflectance is about 27% and the transmittance is about 24.5%. The parameters for the simulation of FIG. 19 are the same as those for FIG. 13A except that the values for the rubbing angles are different.

### Example 3

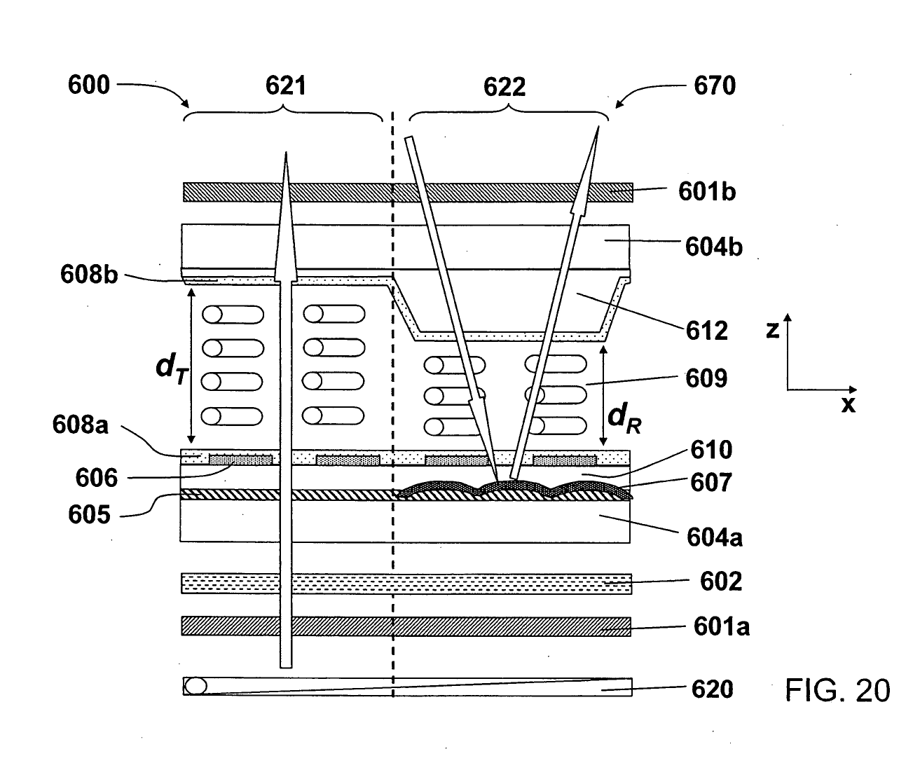

FIG. 20 is a cross-sectional diagram of a pixel 670 of an example wide-view and high brightness transflective liquid crystal display 600 that has a retardation film 602 positioned between a bottom glass substrate 604a and a lower linear polarizer 601a.

The pixel 670 is divided into a transmissive region 621 and a reflective region 622. A homogeneous alignment liquid crystal layer 609 is positioned between two glass substrates 604a and 604b. Two alignment layers 608a and 608b are formed in the inner surfaces of the two glass substrates 604a and 604b for aligning the liquid crystal molecules. On the bottom glass substrate 604a, a first electrode 605 having a plane shape and made of transparent conductive materials is formed in the transmissive region 621, and a metal reflective layer 607 is formed in the reflective region 622, and the metal reflective layer 607 is electrically connected to the first electrode 605. A passivation layer 610 is coated on the first electrode 605 and the metal reflective layer 607, above which a second electrode 606 having several strips are formed.

In the reflective region 622, an overcoating layer 612 is formed to reduce the cell gap d_{R} as compared to the cell gap d_{T} in the transmissive region 621 to compensate for the optical path difference in the transmissive and reflective regions. The two glass substrates 604a and 604b are between two linear polarizers: a first linear polarizer 601a that is close to a backlight unit 620, and a second linear polarizer 601b that is close to the viewer. The transmissive axis of the bottom polarizer 601a is about 45° relative to the liquid crystal rubbing direction, and the bottom and top polarizers 601a and 601b are crossed to each other.

A feature of the display 600 is that the retardation film 602 is positioned between the liquid crystal layer 609 and the bottom linear polarizer 601a that is close to the backlight unit 620. In the display 300 in FIG. 1, to achieve a good dark state in the reflective mode, the retardation film and the liquid crystal layer in the reflective region together have a total phase retardation similar to that of a quarter-wave plate. By comparison, in the display 600, the retardation film 602 is below the liquid crystal layer 609 and does not contribute to the reflective mode. Thus, in the display 600, the liquid crystal layer 609 in the reflective region 622 needs to have a phase retardation similar to that of a quarter-wave plate in order to obtain a good dark state by itself. The optical axis of the liquid crystal layer 609 is about 45° relative to the transmission axis of the top linear polarizer 601b.

A feature of the display 600 is that it uses only one negative retardation film 602. Another feature of the display 600 is that the liquid crystal layer 609 has its initial rubbing direction substantially parallel to the n_{y} axis (where the refractive index of the negative retardation film 602 is similar to that defined in above examples, and n_{y}<nₓ and n_{y}<n_{z}) of the negative retardation film 602, and the initial rubbing direction of the liquid crystal layer is about 45° relative to the top polarizer transmission axis.

In the transmissive region 621, in order to achieve a dark state, the liquid crystal layer 609 and the retardation film 602 need to compensate each other. Thus, the configuration for achieving the dark state is similar for the displays 600 and 300. However, the optical configurations of the bright state for the displays 600 and 300 are different because the liquid crystal molecule distribution in the bright state is not equivalent to a homogeneous uniaxial plate, but rather is asymmetrical in the vertical direction. A more detailed discussion is provided below.

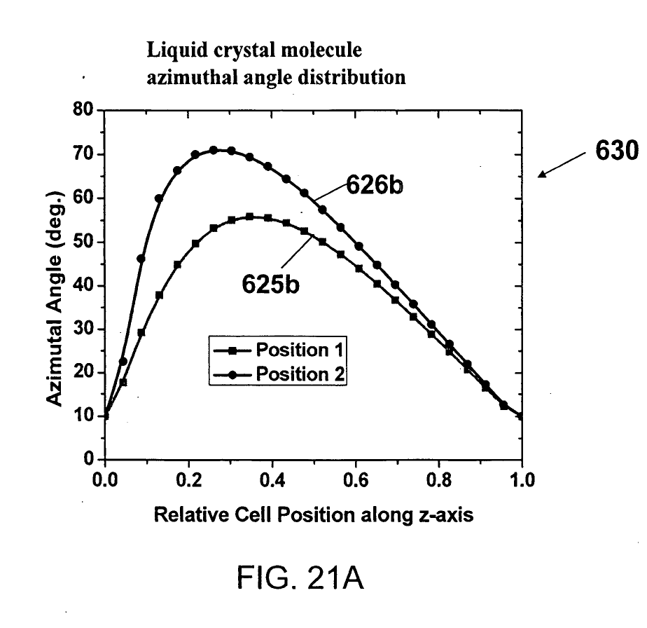

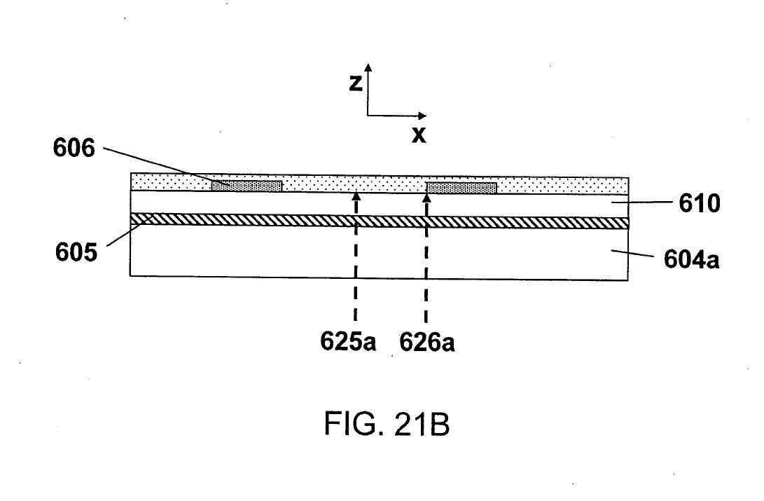

FIG. 21A is a graph 630 showing the liquid crystal molecule distribution (azimuthal angle of the molecule) when the display 600 is operating in a full bright state, in which the voltage applied between the electrodes 605 and 606 is about 6.0 Vrms, and a negative liquid crystal material is used. The graph 630 shows a curve 625b that represents the liquid crystal molecule distribution throughout the liquid crystal cell from the bottom surface to the top surface along the +z axis above a location 625a between two electrode strips 606, as shown in FIG. 21B. The curve 626b represents the liquid crystal molecule distribution throughout the liquid crystal cell from the bottom surface to the top surface along the +z axis above a location 626a at the edge of an electrode strip 606, as shown in FIG. 21B.

The curves 625b and 626b show that, from z=0 to z=1 (in a relative cell gap position, where z=0 at the bottom surface of the liquid crystal layer 609 and z=1 at the top surface of the liquid crystal layer), the azimuthal angle distribution is not symmetrical in the vertical +z direction. The liquid crystal molecule rotation for the bottom half of the liquid crystal layer 609 (which is closer to the electrode strips 606) is stronger than that of the top half of the liquid crystal layer. Therefore, when the liquid crystal layer 609 is stacked with the retardation film, the optical characteristics of the display for one configuration in which the retardation film is positioned above the liquid crystal layer 609 (where the retardation film is closer to the liquid crystal end at z=1) is different from another configuration in which the retardation film is positioned below the liquid crystal layer 609 (where the retardation film is closer to the liquid crystal end at z=0). This can be verified by their electro-optical performances.

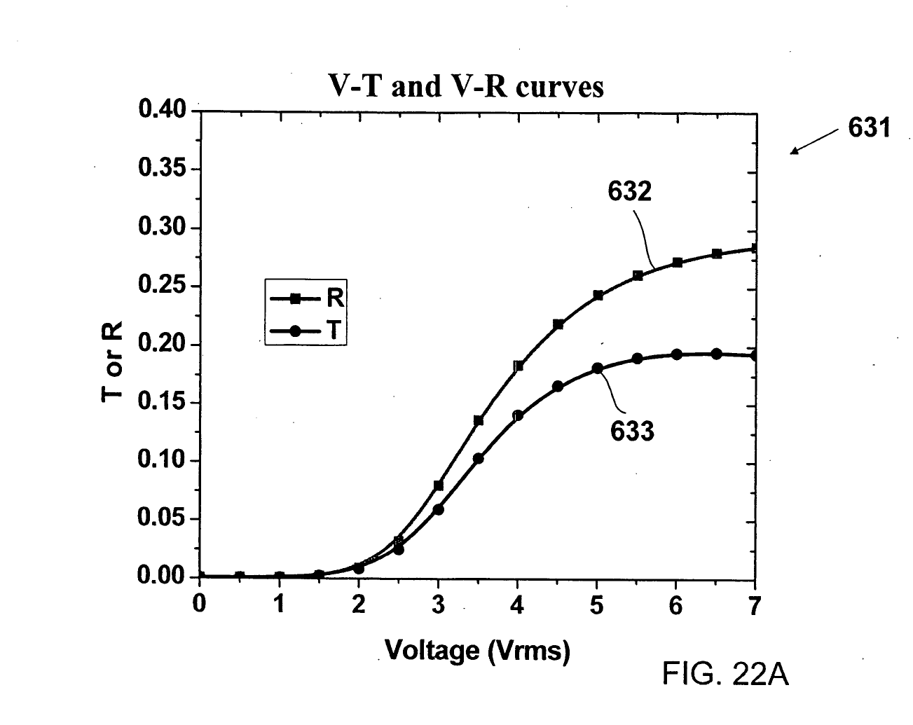

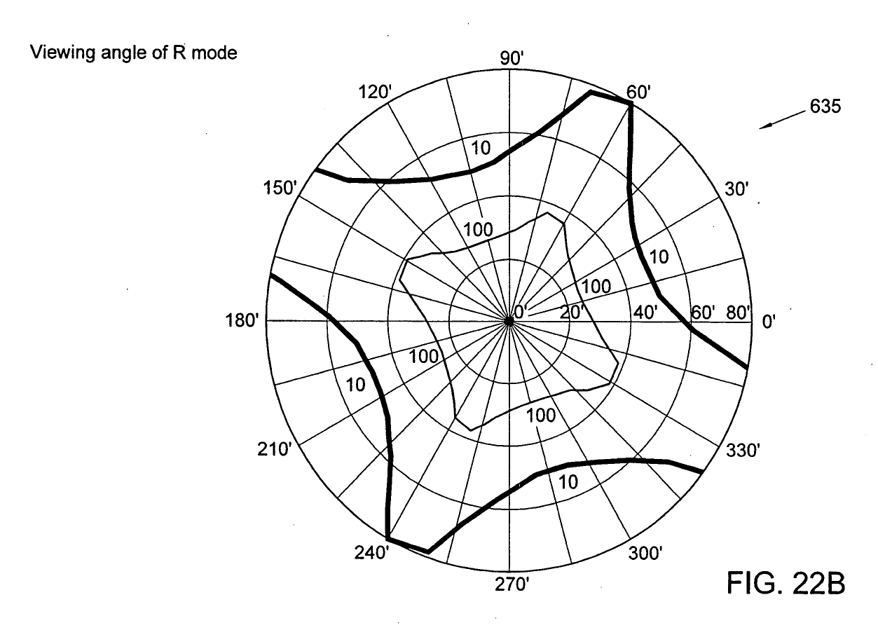

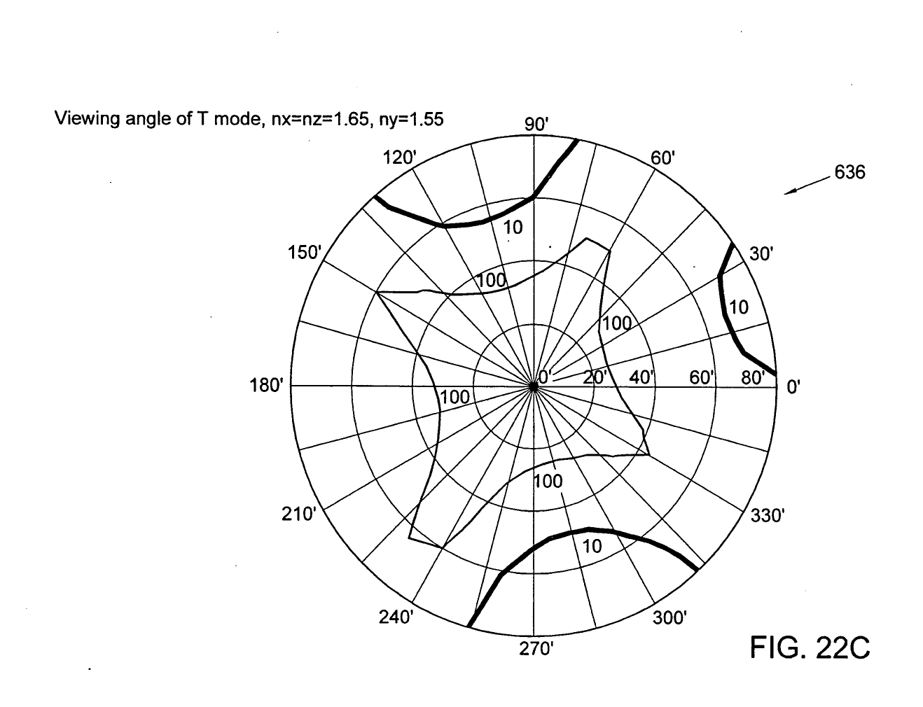

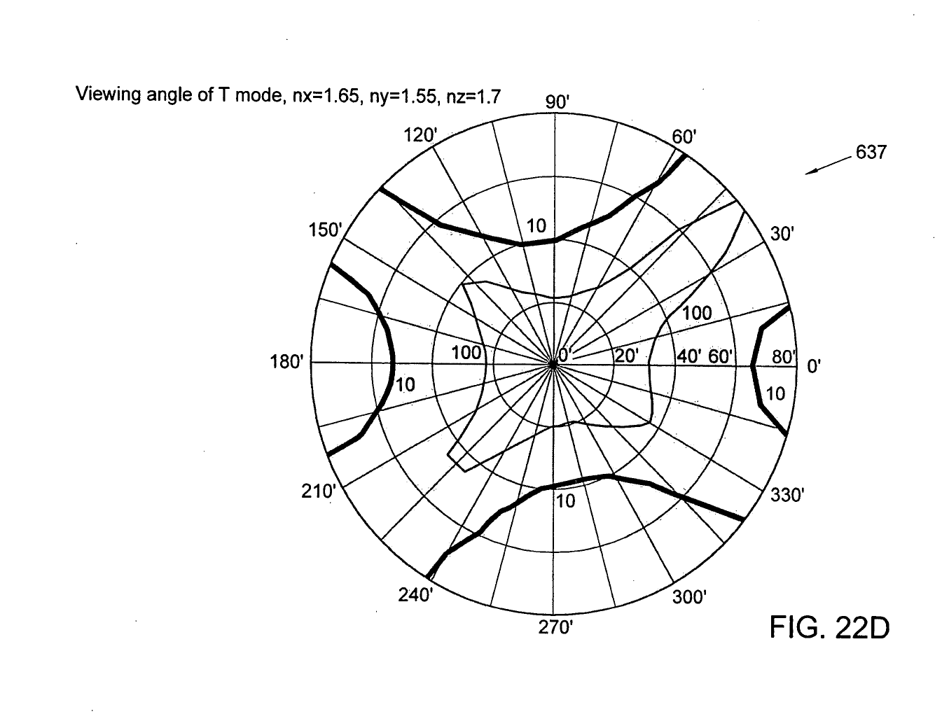

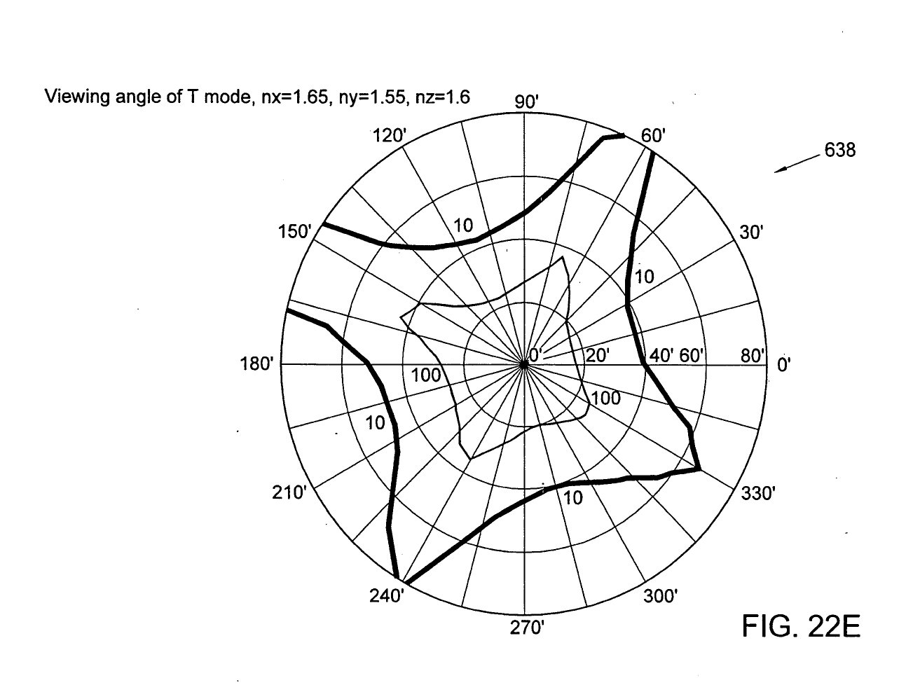

FIG. 22A is a graph 631 showing a V-R curve 632 and a V-T curve 633 for the liquid crystal cell using a negative liquid crystal material MLC-6608, where the cell gap for the transmissive part is 4.0 μm and the cell gap for the reflective part is 1.66 μm. Here the retardation film 602 is a negative A-plate with its principle refractive indices nₓ=1.65, n_{y}=1.55, n_{z}=1.65 and its n_{y} axis along the liquid crystal rubbing direction at φ=10°. The thickness of the retardation film 602 is 3.32 μm so that its phase retardation is similar to that of the liquid crystal layer 609. The V-R curve 632 shows that at V=6 Vrms, the reflectance is about 25%. The V-T curve 633 shows that at V=6 Vrms, the transmittance is only about 20%. In this example, the electrode width W and gap G (as shown in FIG. 2B) are 3 μm and 4 μm, respectively.

FIG. 22B shows an iso-contrast plot 635 for the display 600 operating in the reflective mode, indicating that the display 600 has a viewing cone with contrast ratio over 10:1 that extends over 50° in most directions. The parameters of the retardation film 602 do not affect the reflective mode since the ambient light does not pass the retardation film 602. The parameters for the simulation of FIG. 22B are the same as those for FIG. 22A.

FIG. 22C shows an iso-contrast plot 636 for the display 600 operating in the transmissive mode, where the retardation film 602 has refractive indices nₓ=1.65, n_{y}=1.55, and n_{z}=1.65. The transmittance of the bright state is reduced, and the viewing cone with a contrast ratio over 10:1 is narrowed a bit to over 50° in most directions (as compared to the display 300, in which the viewing cone with a contrast greater than 10:1 extends over about 70° in most directions, as shown in FIG. 5A). The parameters for the simulation of FIG. 22C are the same as those for FIG. 22B.

To compensate the phase retardation of the liquid crystal layer 609 in the transmissive region 621, the n_{z} value of the retardation film 602 does not necessarily have to be equal to nₓ. FIG. 22D shows an iso-contrast plot 637 of the display 600 operating in the transmissive mode with n_{z} equal to 1.70. The viewing cone with a contrast ratio over 10:1 extends over 40° in most directions. The parameters for the simulation of FIG. 22D are the same as those for FIG. 22C, except that the value for n_{z} is different.

FIG. 22E shows an iso-contrast plot 638 of the display 600 operating in the transmissive mode with n_{z} equal to 1.60. The viewing cone with a contrast ratio over 10:1 extends to about 40°. Note that the n_{z} value of the retardation film 602 only affects the off-axis performance of the display 600 and not the performance for normal incidence. The parameters for the simulation of FIG. 22E are the same as those for FIG. 22C, except that the value for n_{z} is different.

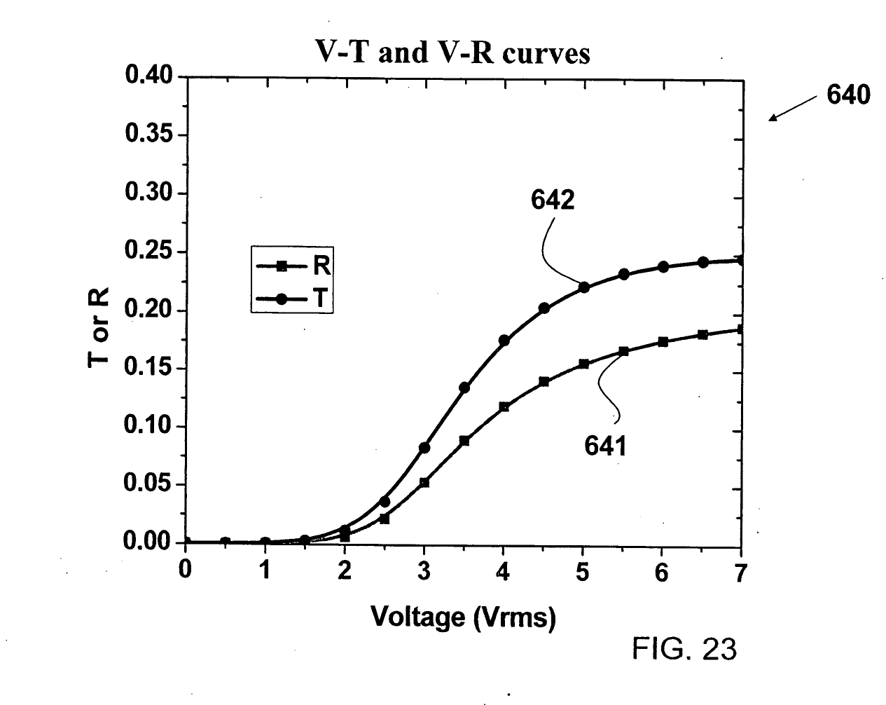

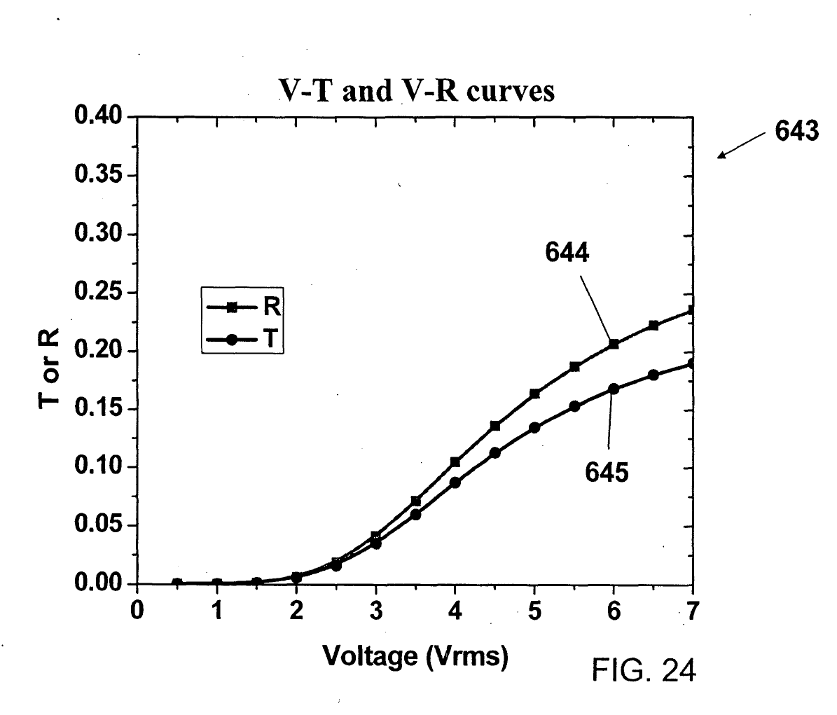

FIG. 23 is a graph 640 showing a V-R curve 641 and a V-T curve 642 of the display 600 having an electrode width W=6 μm and an electrode gap G=8 μm, where the transmission region cell gap d_{T}=4.0 μm, the reflective region cell gap d_{R}=1.66 μm, and the rubbing angle φ=10°. Except the difference in electrode width W and gap G, the other parameters for the simulation of FIG. 23 are the same as those for FIG. 22A. The V-R curve 641 and V-T curve 642 show that, at V=6 Vrms, the reflectivity is about 18% and the transmittance is about 24%.

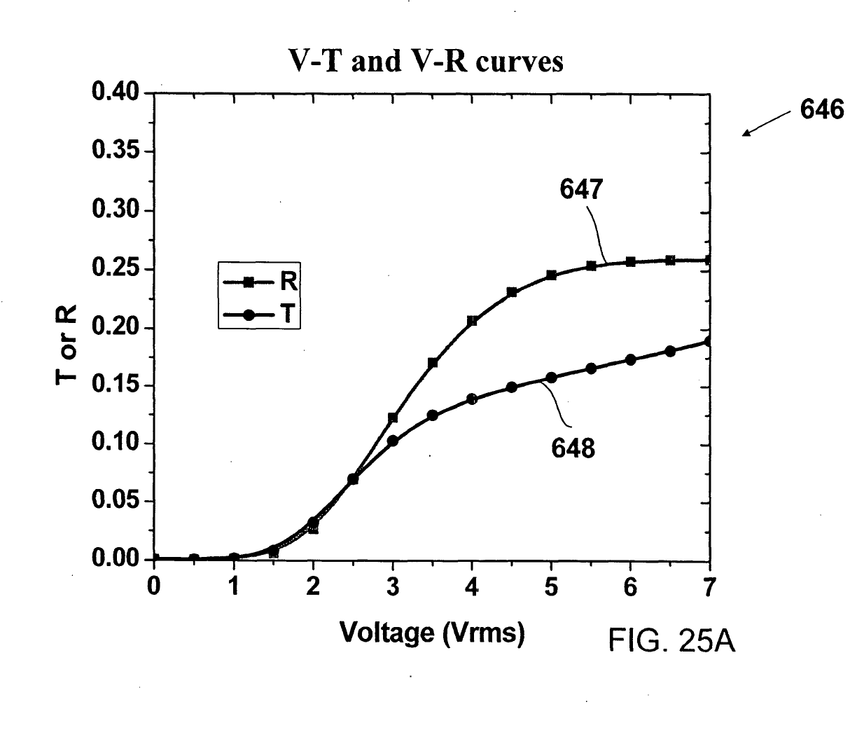

FIG. 24 is a graph 643 showing a V-R curve 644 and a V-T curve 645 for the display 600 having a rubbing angle φ=30°, and in which a negative Δ∈ liquid crystal material is used. The V-R curve 644 and the V-T curve 645 show that, at V=6 Vrms, the reflectivity is about 22% and the transmittance is about 18%. The parameters used for the simulation of FIG. 24 are the same as those for FIG. 22A, except that the rubbing angle is different.

The display 600 of FIG. 20 can use a positive Δ∈ liquid crystal material. In some implementations, the rubbing direction of the liquid crystal layer 609 is about 80°, and the positive Δ∈ liquid crystal material is, e.g., MLC-6686 having an optical birefringence Δn˜0.095. The cell gap d_{T} of the transmissive region 621 is about 3.5 μm. The retardation film 602 has a thickness of about 3.33 μm, principle refractive indices nₓ=1.65, n_{y}=1.55, n_{z}=1.65, and n_{y} axis at 80°, which is parallel with the liquid crystal rubbing direction. The cell gap d_{R} in the reflective region is reduced to about 1.45 μm so that the liquid crystal layer 609 in the reflective region 622 has a phase retardation similar to that of a quarter-wave plate. In the reflective region 622, the liquid crystal layer 609 and the top linear polarizer 601b together have a phase retardation similar to that of a circular polarizer to achieve a dark state when no pixel voltage or a pixel voltage corresponding to a dark state is applied. This way, when no pixel voltage or a pixel voltage corresponding to a dark state is applied, the display 600 has a common dark state between the transmissive and reflective modes.

When a high voltage is applied between the electrodes 605 and 606, fringe electric fields with strong horizontal field components rotate the liquid crystal molecules, causing the light passing to the top linear polarizer 601a to have an elliptical polarization so that at least a portion of the light passes the top linear polarizer 601a in both the transmittance and reflectance regions.

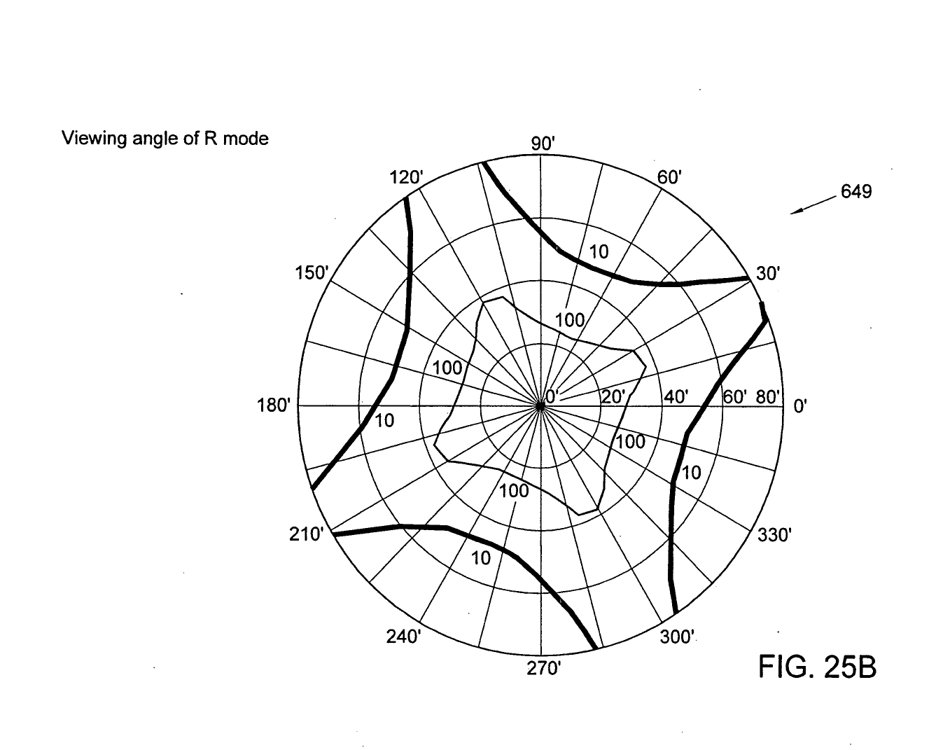

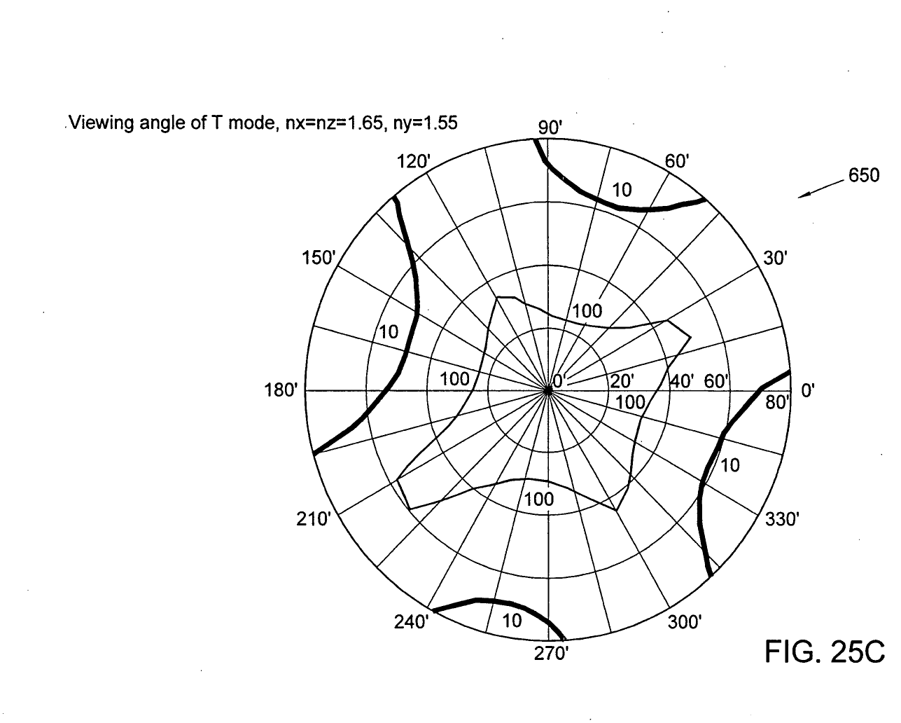

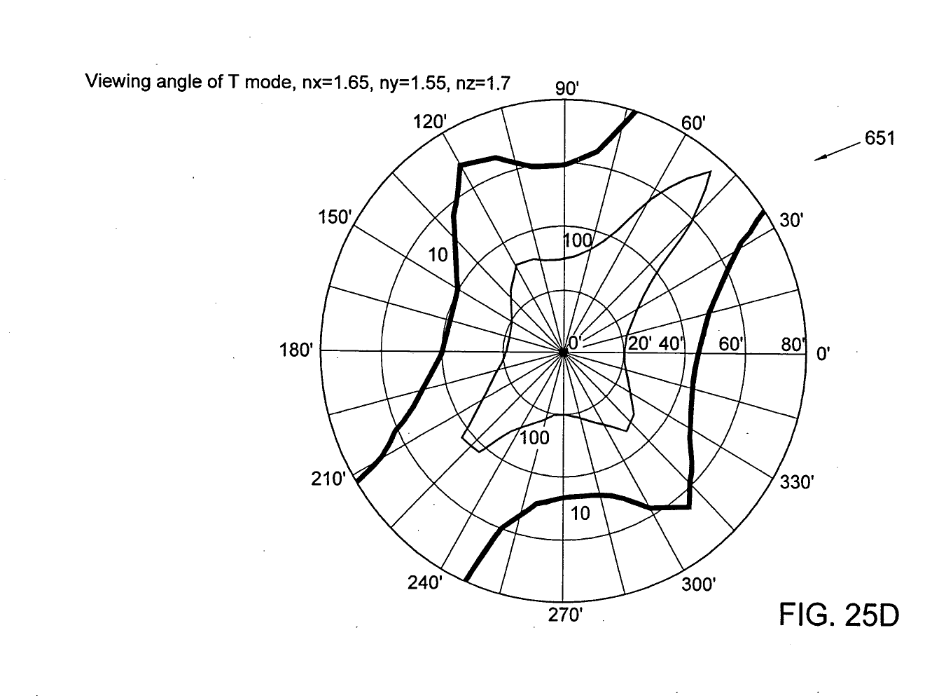

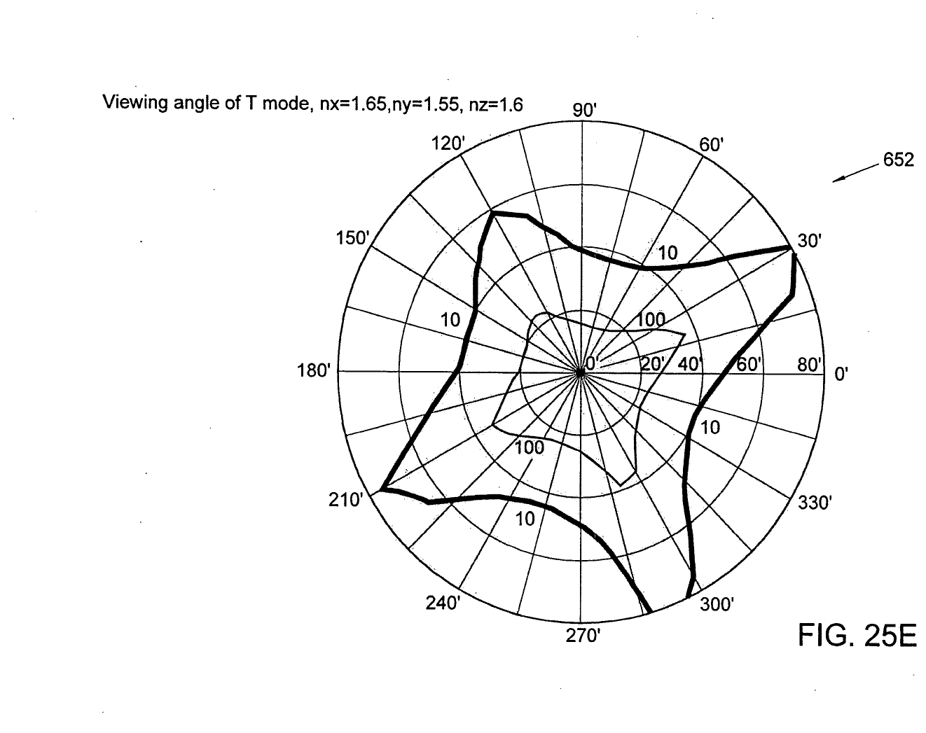

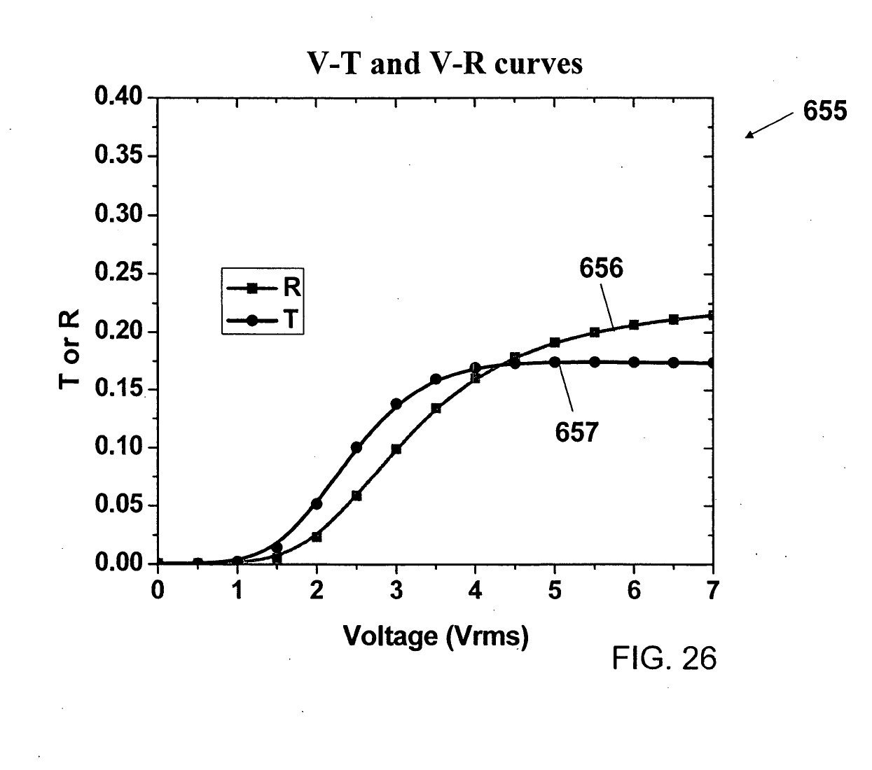

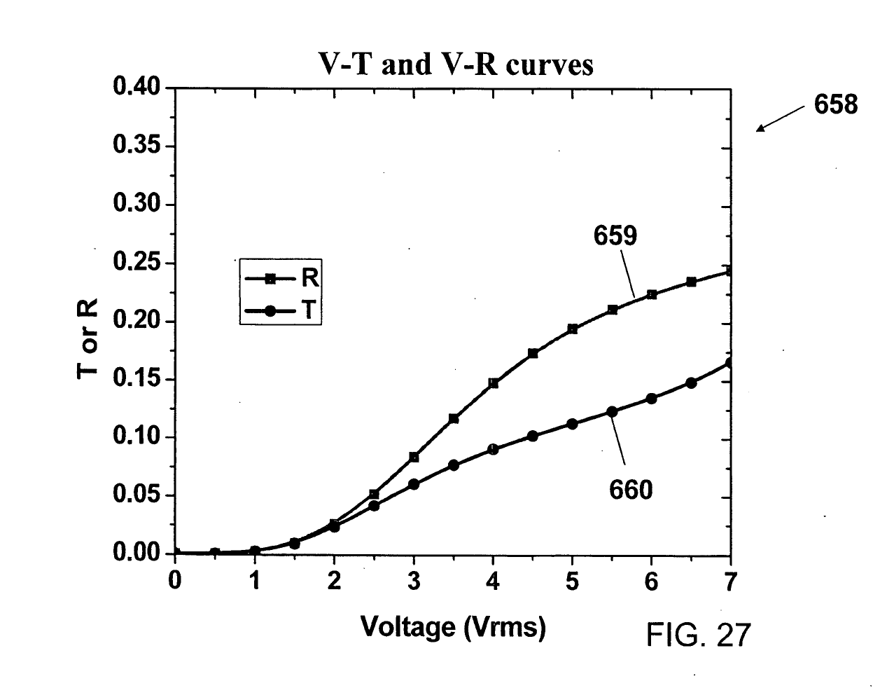

In the following, FIGS. 25A to 27 show simulations of the display 600 in which a positive Δ∈ liquid crystal material is used.

FIG. 25A is a graph 646 showing a V-R curve 647 and a V-T curve 648 for the display 600 in which a positive Δ∈ liquid crystal material is used. The other parameters for the simulation of FIG. 25A are the same as those for FIG. 22A. The V-R curve 647 shows that at V=6 Vrms the reflectance is about 26%, and the transmittance is reduced to about 17.5%. The reduction in transmittance may be due to two factors: 1) due to its positive dielectric anisotropy Δ∈, the liquid crystal molecules are tilted by the vertical field components of the fringe fields generated by the electrodes, so phase retardation is also reduced; and 2) the retardation film 602 is placed close to the liquid crystal surface with electrodes, where the liquid crystal molecules experience a strong twist near that surface. In this example, the electrode width W and gap G (as shown in FIG. 2B) are 3 μm and 4 μm, respectively.

A comparison of the curves 647 and 648 with curves 632 and 633 (of FIG. 22A) shows that the reflective mode is not as sensitive to the change of liquid crystal materials as for the transmissive mode. This may be because for the reflective mode to obtain a good bright state, either the liquid crystal molecules in the reflective region 622 mostly rotates about 45° (similar to the configuration in which a negative Δ∈ liquid crystal material is used), or the liquid crystal molecules tilt up to have a negligible phase retardation. Therefore, when a positive Δ∈ liquid crystal material is used, both the tilt and rotation of liquid crystal molecules contribute to the reflectance in the reflectance region 622. But this mechanism does not hold for the transmissive mode, whose maximum transmittance occurs when the liquid crystal molecules are rotated uniformly by 45°.

FIG. 25B is an iso-contrast plot 649 for the display 600 operating in the reflective mode, indicating that the viewing cone with a contrast ratio over 10:1 is extended over 50° in most directions. Since no retardation film is placed above the reflective liquid crystal cell region, the reflective viewing angle performance is not related to the parameters of the retardation film. The parameters for the simulation of FIG. 25B are the same as those for FIG. 25A.

FIG. 25C is an iso-contrast plot 650 for the display 600 operating in the transmissive mode, where the retardation film 602 has refractive indices n_{y}=1.65, n_{y}=1.55, and n_{z}=1.65. As the transmittance of the bright state is reduced, the viewing cone with a contrast ratio over 10:1 is also narrowed a bit to over 50° in most directions as compared to those in FIG. 22C. The parameters for the simulation of FIG. 25C are the same as those for FIG. 25A.

FIG. 25D is an iso-contrast plot 651 for the display 600 operating in the transmissive mode in which the retardation film 602 has a refractive index n_{z}=1.70. The other parameters for the simulation of FIG. 25D are the same as those for FIG. 25C. The viewing cone with contrast ratio over 10:1 is extended over 40° in most directions.

FIG. 25E is an iso-contrast plot 652 for the display 600 operating in the transmissive mode in which the retardation film 602 has a refractive index n_{z}=1.60. The other parameters for the simulation of FIG. 25E are the same as those for FIG. 25C. The contrast ratio over 10:1 is also extended to about 40°. Note that the n_{z} value affects the off-axis performance of the display and does not affect the performance of the display for normal incident light.

FIG. 26 is a graph 655 showing a V-R curve 656 and a V-T curve 657 for the display 600 in which the electrode width and gap are set to be W=6 μm and G=8 μm. Except the difference in electrode width W and gap G, the other parameters, such as the liquid crystal layer thickness and the rubbing angle are the same as those for FIG. 25A. A larger W and G combination results in a smaller (as compared to that in FIG. 25A with W=3 μm and G=4 μm) on-state voltage at about 4 Vrms for the transmissive mode using the positive liquid crystal material, but the transmittance is reduced to about 17%. For the reflective mode, the reflectance saturates at about 7 Vrms with a reflectance value of about 23%.

FIG. 27 is a graph 658 showing a V-R curve 659 and a V-T curve 660 for the display 600 when the rubbing angle is set to be 60° instead of 80°, the electrode width W is equal to 3 μm and the electrode gap G is equal to 4 μm. This rubbing angle gives rise to a larger on-state voltage and a reduced transmittance (as compared to that in FIG. 25A with rubbing angle at 80°). At V=7 Vrms, the reflectance is about 25% and the transmittance is about 17%.

### Example 4

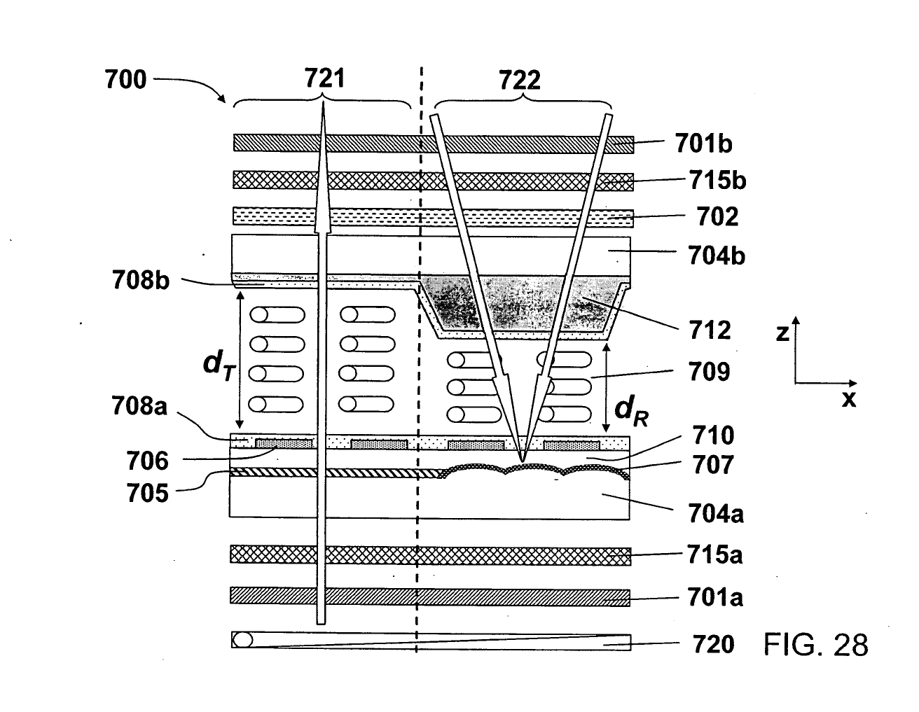

In some implementations, the viewing angle of the display can be improved by adding two compensation films. FIG. 28 is a cross-sectional diagram of a display 700 that has a retardation film 702 and two compensation films 715a and 715b. The term “retardation film” and “compensation film” are used interchangeably in this document, as a retardation film compensates for the phase retardation caused by the liquid crystal layer. Each pixel of the display 700 is divided into a transmissive region 721 and a reflective region 722. An initially homogeneously aligned liquid crystal layer 709 is positioned between two alignment layers 708a and 708b, which is positioned between a bottom glass substrate 704a and a top glass substrate 704b.

To compensate the optical path difference in the transmissive and reflective regions, an overcoating layer 712 is formed in the reflective region 722. A first driving electrode 705 having a plane shape is formed on the bottom substrate 704a and a metal reflector 707 (similar to the reflector 307 of FIG. 1) is electrically connected to the electrode 705. A passivation layer 710 is coated over the electrode 705 and the reflector 707. An electrode 706 having several strips is formed on the passivation layer 710. The two glass substrates 704a and 704b are positioned between a bottom linear polarizer 701a that is close to a backlight unit 720 and a top linear polarizer 701b that is close to the viewer. The first and second linear polarizers are crossed to each other.

A retardation film 702 is positioned between the top glass substrate 704b and the top linear polarizer 701b, and extends over both the transmissive and reflective regions. The overall phase retardation from the retardation film 702 and the liquid crystal layer 709 in the reflective region 722 is designed to be about λ/4, where λ is the wavelength of the desired incident light. The retardation film 702, the liquid crystal layer 709 in the reflective region 722, and the top linear polarizer 701b together form a circular polarizer to achieve a dark state in the reflective mode when no voltage or a voltage corresponding to a dark state is applied.

A first compensation film 715a made of a uniaxial positive A-plate is placed between the bottom linear polarizer 701a and the bottom substrate 704a. A second compensation film 715b made of a uniaxial negative A-plate is placed between the first linear polarizer 701a and the second linear polarizer 701b. The optical axis of the uniaxial compensation film 715a is aligned parallel to the transmission axis of the bottom linear polarizer 701a, and the optical axis of the top compensation film 715b is aligned parallel to the transmission axis of the top linear polarizer 701a. Because the optical axes of the compensation films 715a and 715b are parallel to the transmission axes of the nearby linear polarizers, the two compensation films do not affect the display electro-optical performance at normal incidence. The compensation films 715a and 715b compensate angle deviation from the bottom and top polarizers (i.e., two polarizers are crossed to each other for normal incidence light, but no longer perpendicular to each other for some off-axis incidence light) and the phase retardation imparted to oblique incidence light by the liquid crystal layer and help improve the viewing angle of the display 700.

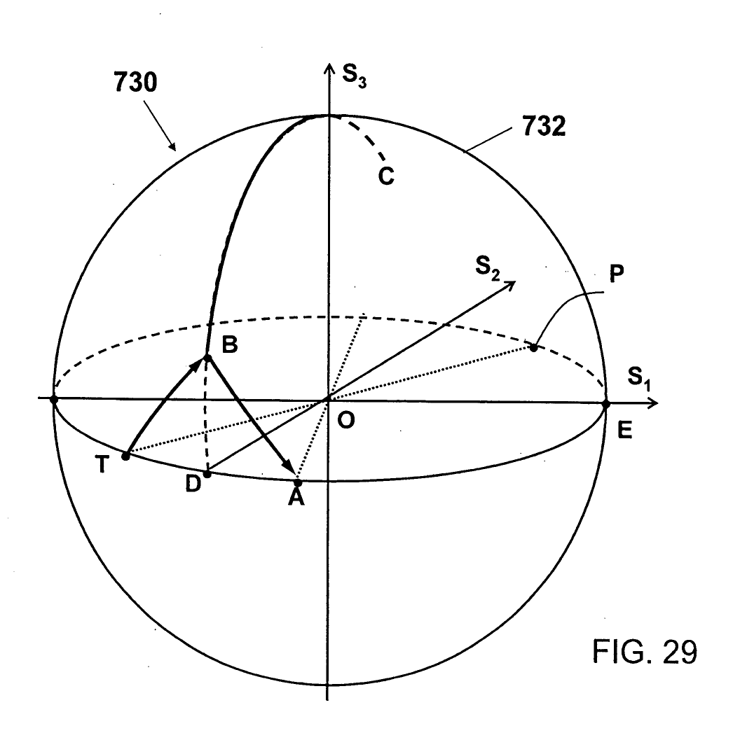

FIG. 29 is a Poincaré sphere diagram 730 showing a polarization trace of the incident light from the bottom linear polarizer to the top linear polarizer drawn on a Poincaré sphere 732, showing the compensation mechanism of the compensation films 715a and 715b. An explanation on designing compensation films using uniaxial films can be found in the article titled “Analytical solutions for uniaxial-film-compensated wide-view liquid crystal displays,” Journal of Display Technology, vol. 2, pages 2-20, 2006, by X. Zhu et al.

When the display 700 is viewed at a direction at an angle from the normal direction (or z-axis), e.g., with a polar angle 70° and an azimuthal angle −45° with respect to the transmission axis of the bottom linear polarizer 701a, the absorption axes of the bottom linear polarizer 701a and the top linear polarizer 701b are no longer perpendicular to each other (i.e., angle deviation from the bottom and top linear polarizers). On the Poincaré sphere diagram 730, point P represents the absorption axis of the bottom linear polarizer 701a, and point A represents the absorption axis of the top linear polarizer 701b. A point T (which is opposite to the point P relative to the origin O) on the Poincaré sphere 732 represents the polarization of the light that just passes the bottom linear polarizer 701a from the backlight unit 720. Point T does not overlap point A, meaning that for a display having only two linear polarizers, at this off-axis direction, light passing the bottom linear polarizer 701a will not be fully absorbed by the top linear polarizer 701b, resulting in off-axis light leakage.

By using the additional two compensation films 715a and 715b in the display 700, the off-axis light leakage can be substantially suppressed. In the Poincaré sphere diagram 730, the light passing the bottom linear polarizer 701a will first have a polarization represented by point T. Because the bottom uniaxial A-plate 715a has an optical axis set along the absorption axis of the top linear polarizer 701b, the light with a polarization represented by point T will be rotated to point B along an axis AO (which passes points A and O) after passing the compensation film 715a.

The light then passes the liquid crystal layer 709 and the retardation film 702. The liquid crystal layer 709 has its optical axis along line OE, so when the light passes the liquid crystal layer 709, the polarization of light on the Poincaré sphere 732 moves from point B to point C. Because the retardation film 702 has its n_{y} axis along the rubbing direction of the liquid crystal layer 709, the phase retardation of the retardation film 702 cancels that of the liquid crystal layer 709. When the light passes the retardation film 702, the polarization of light on the Poincaré sphere 732 moves from point C back to point B. The top uniaxial A-plate 715b is a negative uniaxial film whose optical axis is parallel to the absorption axis of the bottom linear polarizer 701a, and converts the light with a polarization at point B to point A along the axis OP. As a result, the off-axis light can be fully absorbed by the top linear polarizer 701b.

There are distinct differences between the display 700 shown in FIG. 28 and displays that use three retardation films (e.g., see J. Matsushima, et al., “Novel transflective IPS-LCDs with three retardation plates,” Technical Digest of IDW'07, pp. 1511-1514). First, the additional two compensation films 715a and 715b are used to compensate the effective angle deviation of the two linear polarizers at an off-axis incidence. Here, the optic axes of the compensation films 715a and 715b are set either parallel to or perpendicular to the transmission axis of the linear polarizers 701a and 701b. The compensation films 715a and 715b do not affect normal incident light, i.e., does not change the polarization of the light parallel to the z-axis. More importantly, in this design, only one negative retardation film 702 is used to compensate the liquid crystal layer 709 for light parallel to the z-axis.

Second, the liquid crystal layer 709 has its initial rubbing direction substantially parallel to the n_{y} axis of the negative retardation film 702, and the initial rubbing direction of the liquid crystal layer 709 is set about 45° relative to the top polarizer transmission axis.

Third, there is flexibility in choosing the parameters for the retardation film 702 and the liquid crystal layer 709. For example, the retardation film 702 above the liquid crystal layer 709 does not necessarily have to behave like a half-wave plate. The retardation film 702 can have a retardation of, e.g., 330 nm, which is different from the half wavelength of 275 nm for λ=550 nm. For example, the liquid crystal layer 709 in the reflective region 722 does not necessarily have to behave like a quarter-wave plate, as long as the overall retardation from the negative retardation film 702 and the reflective liquid crystal layer 709 is similar to that of a quarter-wave plate. The liquid crystal layer in the reflective region can have a retardation (e.g., 195 nm) that is larger than that of a quarter-wave plate (135 nm), thus allowing the display 700 to have a better reflectance and fabrication tolerance. Other differences in configuration and electro-optic performance will be described below.

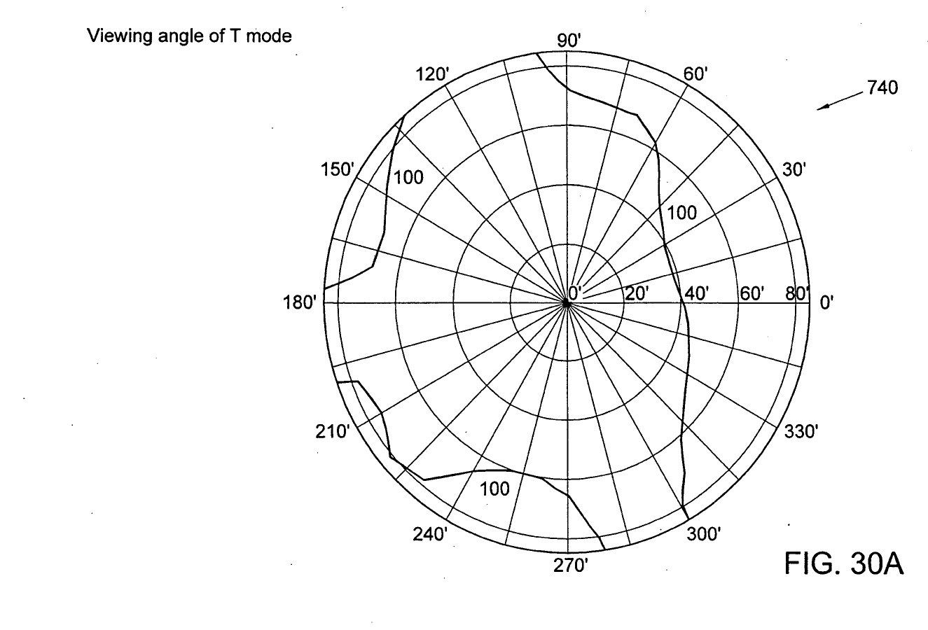

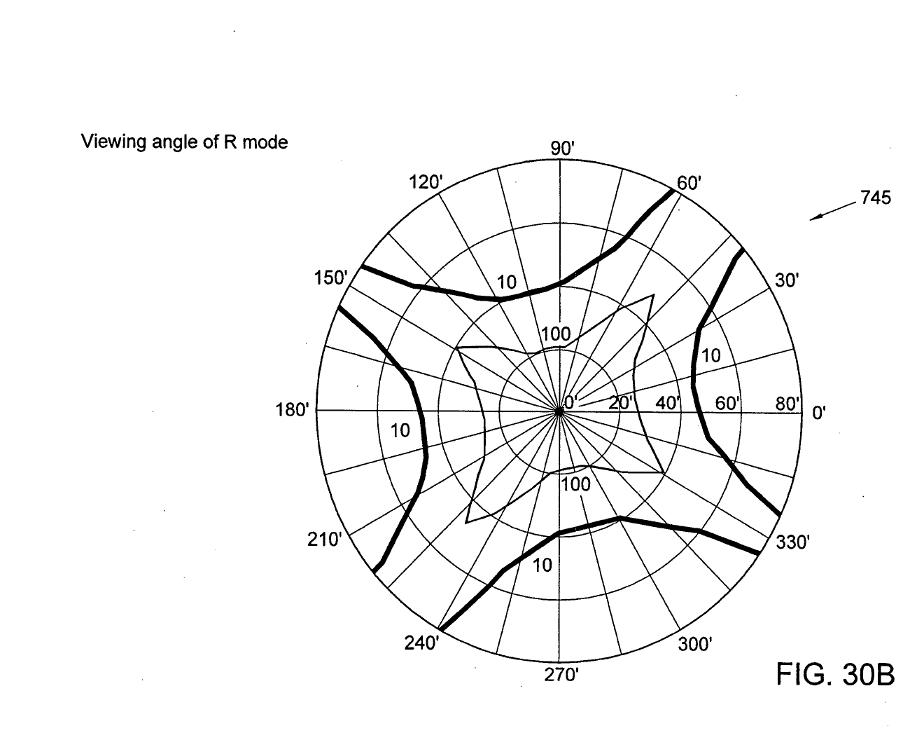

FIGS. 30A and 30B show iso-contrast plots 740 and 745 of the viewing angle of the transmissive region 721 and the reflective region 722, respectively, of the display 700. In this simulation, a negative dielectric anisotropy (−Δ∈) liquid crystal material was used, the liquid crystal layer 709 has a cell gap of 4 μm in the transmissive region 721 and a cell gap of 2.34 μm in the reflective region 722. The retardation film 702 has a phase retardation that is designed to fully cancel the phase retardation from the liquid crystal layer 709 in the transmissive region 721 when no pixel voltage (or a pixel voltage that corresponds to a dark state) is applied, resulting in a dark state in the transmissive region 721. The retardation film 702 has its n_{y} axis along the liquid crystal rubbing direction.

The first compensation film 715a is a positive uniaxial A-plate with its retardation dΔn about equal to 92.1 nm and its optic axis along the absorption axis of the top linear polarizer 701b. The second compensation film 715b is a negative uniaxial A-plate with its retardation dΔn about equal to −92.1 nm and its optic axis along the absorption axis of the bottom linear polarizer 701a.

As shown in the plot 740 (FIG. 30A), for the transmissive mode, the viewing cone with a contrast ratio over 10:1 is expanded to over 85° in all directions. For the reflective mode, as shown in the plot 745 (FIG. 30B), the compensation effect is not that obvious. This may result from the fact that both the film 715b and film 702 function on the light in the reflective mode. Nonetheless, the viewing cone with a contrast ratio over 10:1 is still over 40° in most directions.

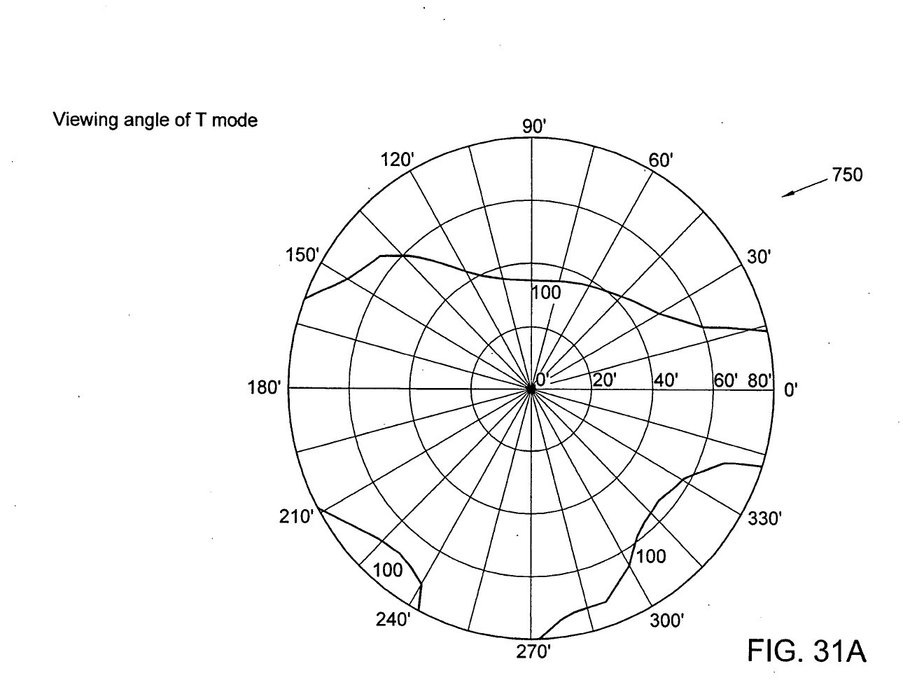

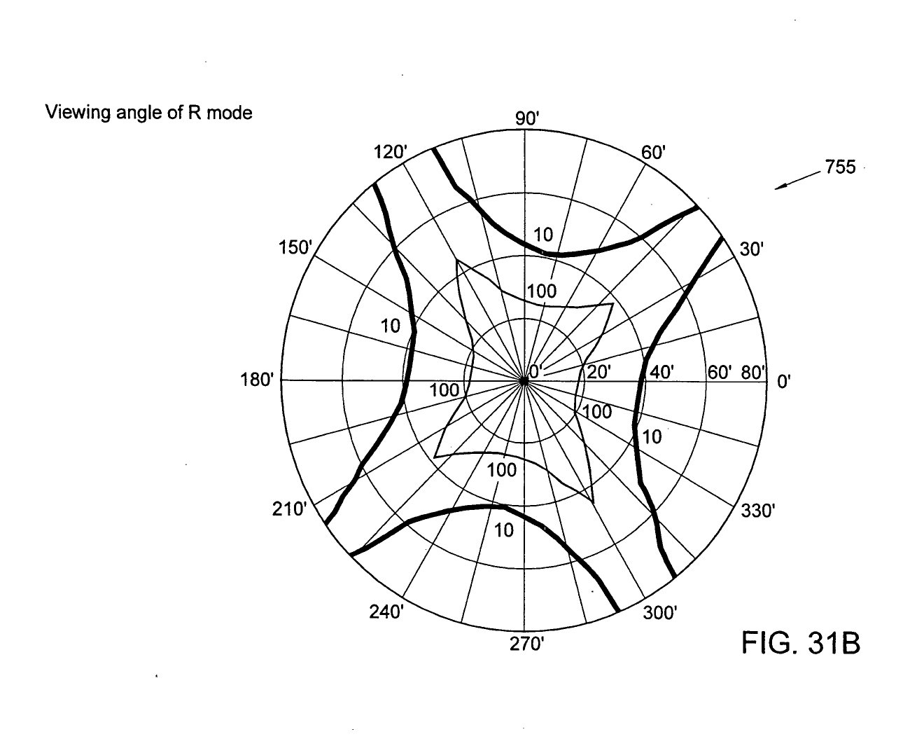

In some implementations, a positive Δ∈ liquid crystal material can also be used for the display 700. FIGS. 31A and 31B show the viewing angles of the transmissive mode and reflective mode, respectively, of the display 700 when a positive liquid crystal material is used for the liquid crystal layer 709. The liquid crystal cell gap for the transmissive region 721 is set at 3.5 μm and the cell gap for the reflective region 722 is set at 2.05 μm. The retardation film 702 has a phase retardation that is designed to fully cancel the phase retardation from the liquid crystal layer 709 in the transmissive region 721 when no pixel voltage (or a pixel voltage that corresponds to a dark state) is applied, resulting in a dark state in the transmissive region 721.

In this example, the first compensation film 715a is a positive uniaxial A-plate having a retardation dΔn equal to about 92.1 nm, and its optic axis is along the absorption axis of the top linear polarizer 701b. The second compensation film 715b is a negative uniaxial A-plate having a retardation dΔn equal to about −92.1 nm and its optic axis is along the absorption axis of the bottom linear polarizer 701a. As shown in the viewing angle plot 750, for the transmissive mode, a viewing cone with contrast ratio greater than 10:1 extends to over 89° in all directions. As shown in the plot 755 (FIG. 31B), for the reflective mode, the viewing cone with a contrast ratio over 10:1 is over 40° in most directions.

The compensation films 715a and 715b have their optic axes set along the transmission axes of the linear polarizers 701a and 701b, respectively, and do not affect the performance of the display 700 at normal incidence. To obtain a wide-viewing angle, the phase retardation imparted by the retardation film 702 needs to fully cancel the phase retardation imparted by the liquid crystal layer 709 in the transmissive region in the dark state. The position of the retardation film 702 affects the transmittance at the bright state (as illustrated in Example 3 above), but not on the dark state. The two compensation films 715a and 715b can be used in a display in which the retardation film 702 is placed between the liquid crystal layer 709 and the bottom linear polarizer 701a (specifically, placed near the liquid crystal surface with electrodes). In this example, the liquid crystal layer 709 in the reflective part 722 is set to behave like a quarter-wave plate when no voltage is applied.

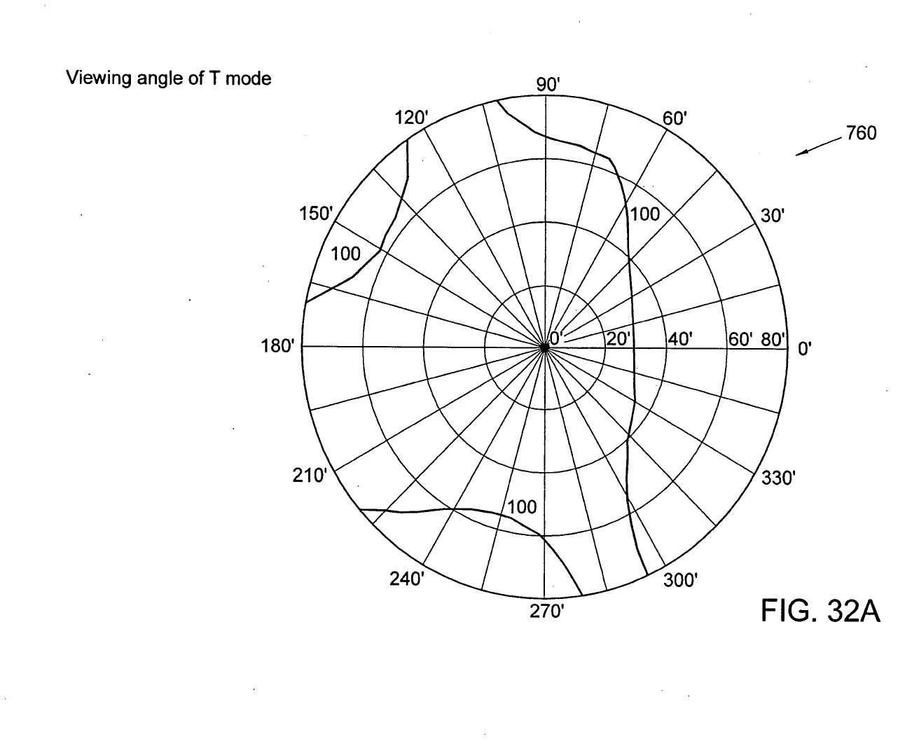

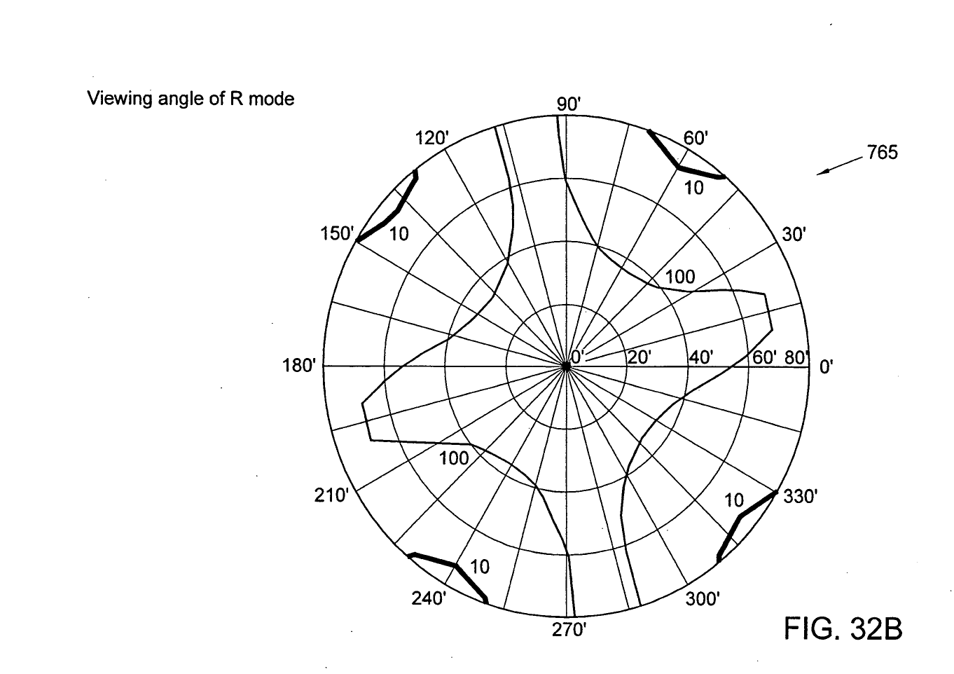

FIGS. 32A and 32B show the iso-contrast plots 760 and 765 for a transmissive region and a reflective region, respectively, of a display using a negative liquid crystal material using a configuration similar to the display 700 shown in FIG. 28, except that the retardation film 702 is placed near the liquid crystal surface with driving electrodes (e.g., between the liquid crystal layer 709 and the bottom linear polarizer 701a).

As shown in FIG. 32A, although the brightness is reduced (compared to FIG. 30A), the viewing cone with a contrast ratio over 10:1 still extends to over 89° in all directions. As shown in FIG. 32B, the viewing angle of the reflective mode is expanded (as compared to FIG. 31B) and the viewing cone with a contrast ratio greater than 10:1 is over 70° in most directions.

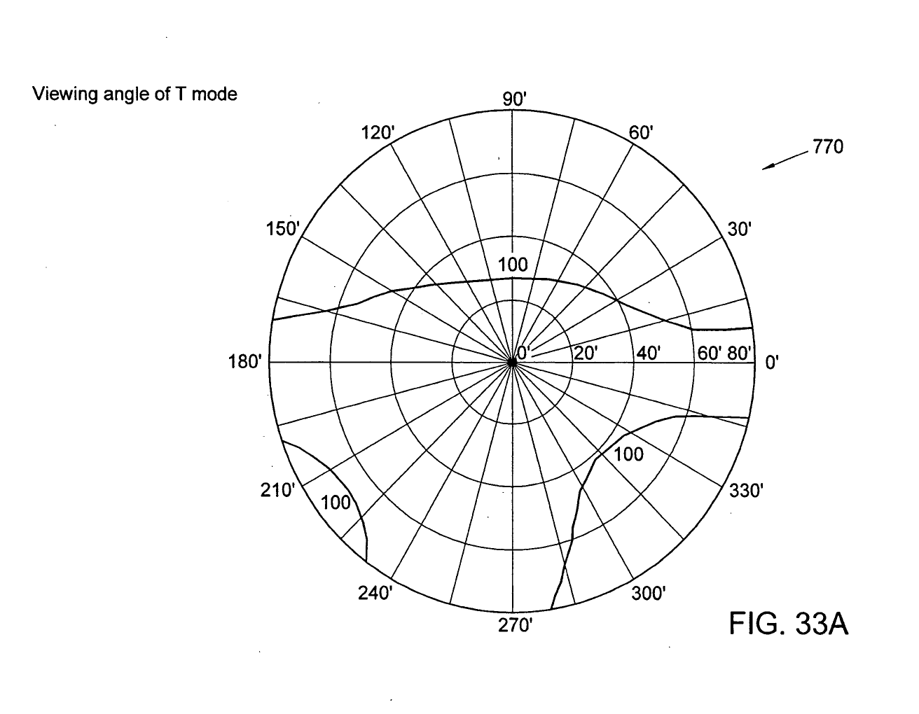

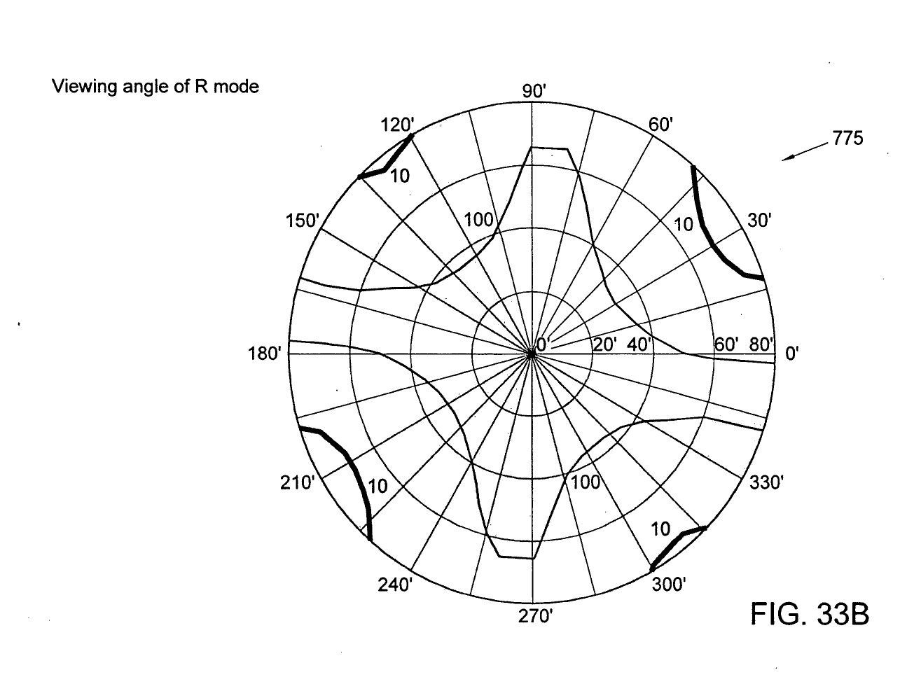

FIGS. 33A and 33B show the iso-contrast plots 770 and 775 for the transmissive region and reflective region, respectively, of a display having a configuration similar to that used for the simulations of FIGS. 32A and 32B, except that uses a positive Δ∈ liquid crystal material is used. The retardation film 702 is placed close to the liquid crystal surface with driving electrodes. As shown in the plot 770, for the transmissive mode, a viewing cone with a contrast ratio greater than 10:1 extends to over 89° in all directions. As shown in the plot 775, for the reflective mode, a viewing cone with a contrast ratio greater than 10:1 extends to over 70° in most directions. The trade-off of this configuration is that the transmissive mode has a lower brightness, as compared to the same configuration but with a negative Δ∈ liquid crystal material.

### Example 5

In some implementations, a transflective LCD can use a uniaxial positive A film and a negative C film to replace the negative A film or biaxial film discussed in the examples above.

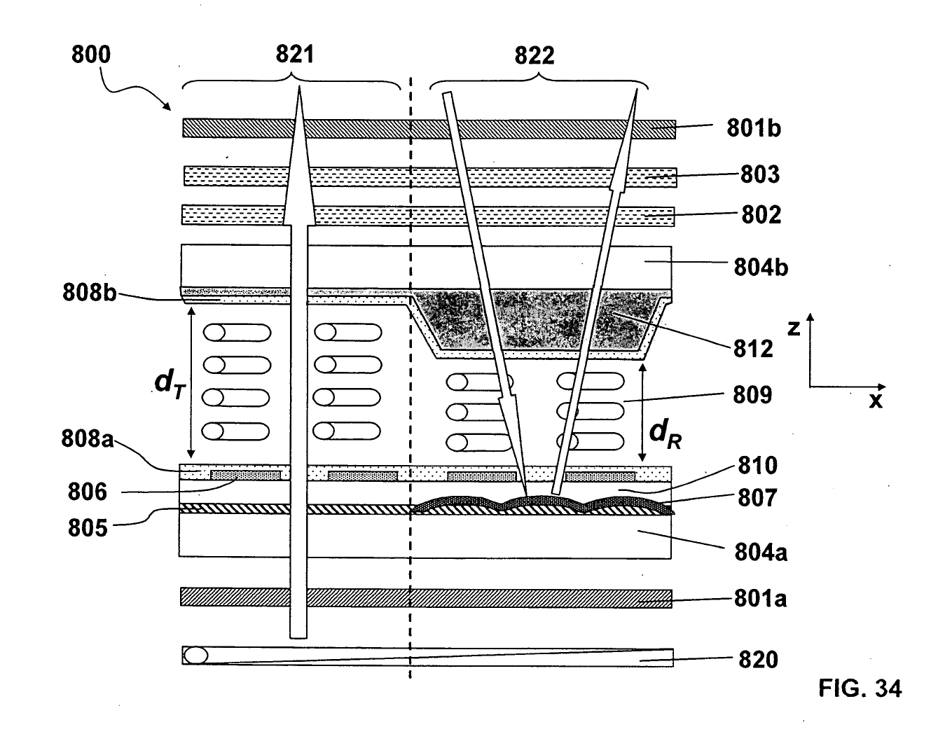

FIG. 34 is a cross-sectional diagram of one pixel of a wide-view and high brightness transflective liquid crystal display 800. The display 800 has a configuration that is similar to that of the display 300 (FIG. 1), except that the display 800 uses two retardation films 802 and 803.

Each pixel of the display 800 has a transmissive region 821 and a reflective region 822, where a backlight unit 820 is placed below a liquid crystal layer 809 as a light source. The liquid crystal layer 809 is sandwiched between a bottom glass substrate 804a and a top glass substrate 804b. Two alignment layers 808a and 808b, made of, e.g., polyimide materials, are formed on the inner surfaces of the substrates 804a and 804b, respectively. The liquid crystal molecules are initially homogeneously aligned with their optic axes substantially parallel to the bottom glass substrate 804a.

A first plane-shaped electrode 805, made of a transparent conductive material such as indium-tin-oxide (ITO) or indium-zinc-oxide (IZO), is formed on the bottom glass substrate 804a. In the reflective region 822, a metal reflector layer 807, made of a conductive material such as aluminum or silver, is electrically connected to the electrode 805. A passivation layer 810, made of a dielectric materials such as SiOₓ or SiNₓ, is further coated on the bottom electrode 805 and metal reflector 807. On the passivation layer 810, a group of stripe-shaped electrodes 806 is formed as the second electrode, which is also made of transparent a conductive material such as ITO or IZO. An overcoating layer 812 made of a dielectric material such as SiOₓ, SiNₓ, or an organic material, is formed in the reflective region 822 to cause the cell gap d_{R} in the reflective region 822 to be different from the cell gap d_{T} in the transmissive region 821.

The retardation film 802 can be a uniaxially or biaxially stretched polymer film with its principle refractive indices n_{y}<nₓ and n_{z}<nₓ, is placed between the first and second linear polarizers 801a and 801b, covering both the transmissive and reflective regions 821 and 822. Here, the retardation film 802 has its n_{z} axis along the direction that is substantially perpendicular to the surface of the two linear polarizers. In this example, both n_{y} and n_{z} are smaller than nₓ and its n_{y} axis is substantially parallel to the rubbing direction of the liquid crystal layer.

The retardation film 802 is designed to fully cancel the phase retardation from the liquid crystal layer 809 in the transmissive region at the normal incidence when no voltage or a voltage corresponding to a dark state is applied, leading to a dark state of the transmissive mode under two crossed linear polarizers. The overall phase retardation from the retardation film 802 and the liquid crystal layer 809 in the reflective region 822 is designed to be about λ/4, where λ is the wavelength of the desired incident light. The retardation film 802 and the liquid crystal layer 809 together with the top linear polarizer 801b forms a circular polarizer that generates a dark state in the reflective mode when no voltage is applied.

In some examples when nₓ>n_{y}=n_{z}, the biaxial retardation film 802 becomes a uniaxial positive A-plate. Note that in order to uniquely define the optical arrangement of the retarder 802 with n_{y}<nₓ and n_{z}<nₓ and its n_{z} perpendicular to the polarizer surface, we can set the refractive indices n_{y}<nₓ and assign the refractive index n_{y} along a certain direction. The retardation film 803 can be a uniaxial C-plate that is placed between the film 802 and the liquid crystal layer 809. Here, for an uniaxial C-plate, its refractive indices satisfy: nₓ=n_{y}≠n_{z}.

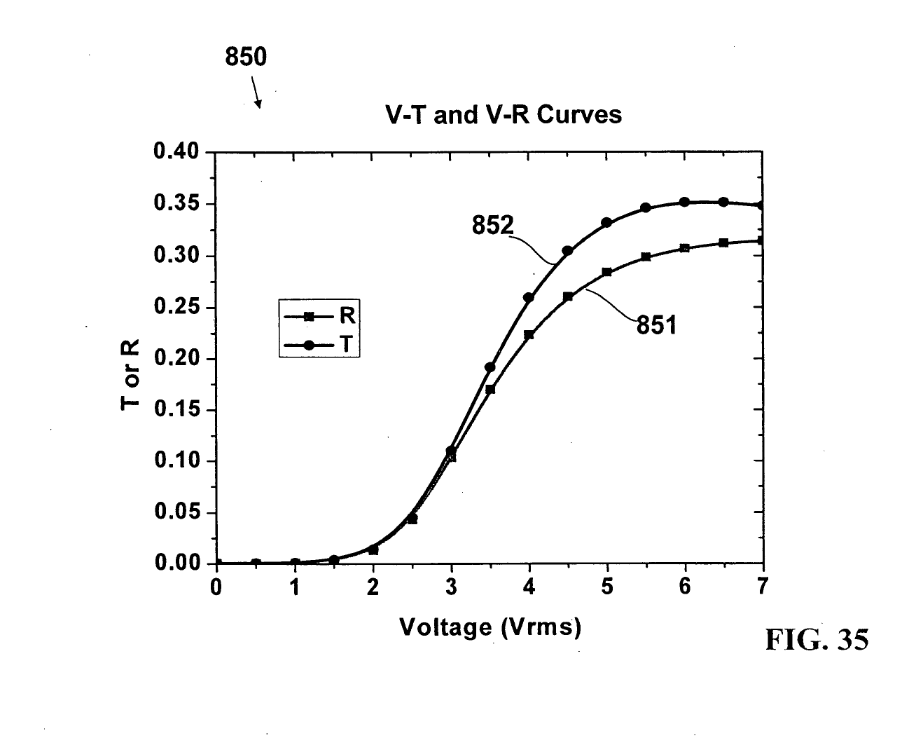

FIG. 35 is a graph 850 showing a V-R curve 851 and a V-T curve 852 of the display 800 (FIG. 34) that uses a negative Δ∈ liquid crystal material. Here, the electrode width W and gap G (as illustrated in FIG. 34) are set as 3 μm and 4 μm, respectively. The liquid crystal material used is MLC-6608. The liquid crystal cell gap d_{T} for the transmissive region 821 is set at 4 μm and the cell gap d_{R} for the reflective region 822 is set at 2.34 μm. The rubbing angle of the liquid crystal material is at φ=10°, and the liquid crystals are initially homogeneously aligned with a pretilt angle about 2°.

In this example, the retardation film 802 is a positive A-plate with its n_{z} axis along the z-axis, and its nₓ and n_{y} axes are set in the x-y plane, where nₓ>n_{y}=n_{z}. Here, n_{y}=n_{z}=1.55, and nₓ=1.65, and its n_{y} axis is aligned parallel to the liquid crystal rubbing directions. The thickness of the retardation film 802 is set at 3.32 μM. The bottom polarizer 801a has its transmission axis set at −35° relative to the x-axis as illustrated in FIG. 2B and the top linear polarizer 801b has its transmission axis at 55° relative to the x-axis. Here, the overall phase retardation from the liquid crystal layer 809 in the reflective region 822 and the top retardation film 802 is about 2.34×0.083−3.32×0.1 μm=−0.1378 μm˜−λ/4, where the incident light is taken as a green light with λ=550 nm.

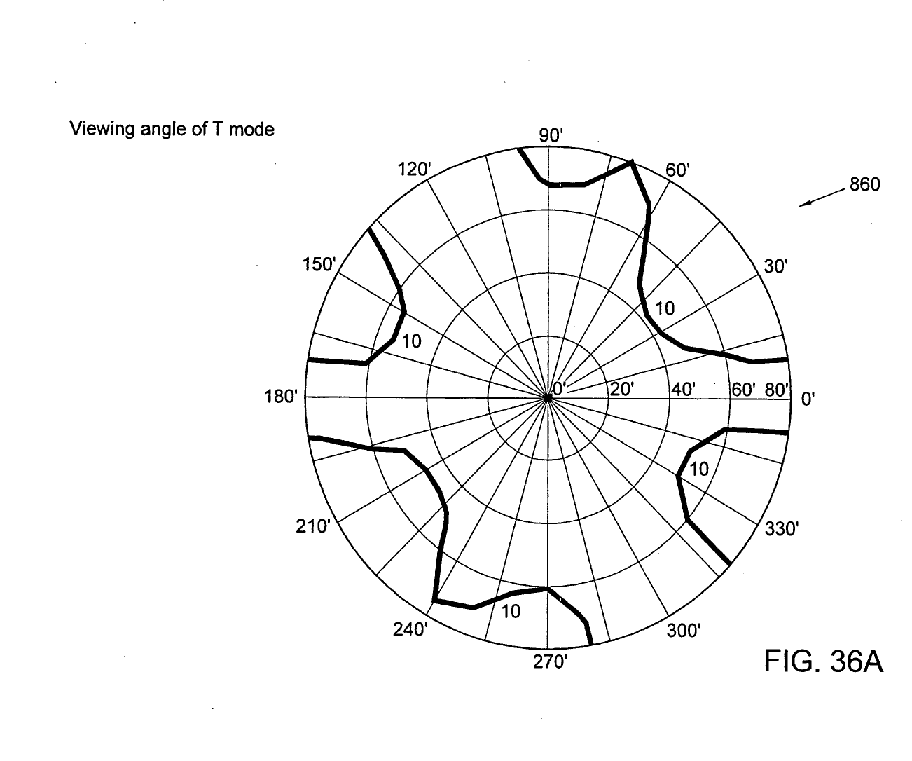

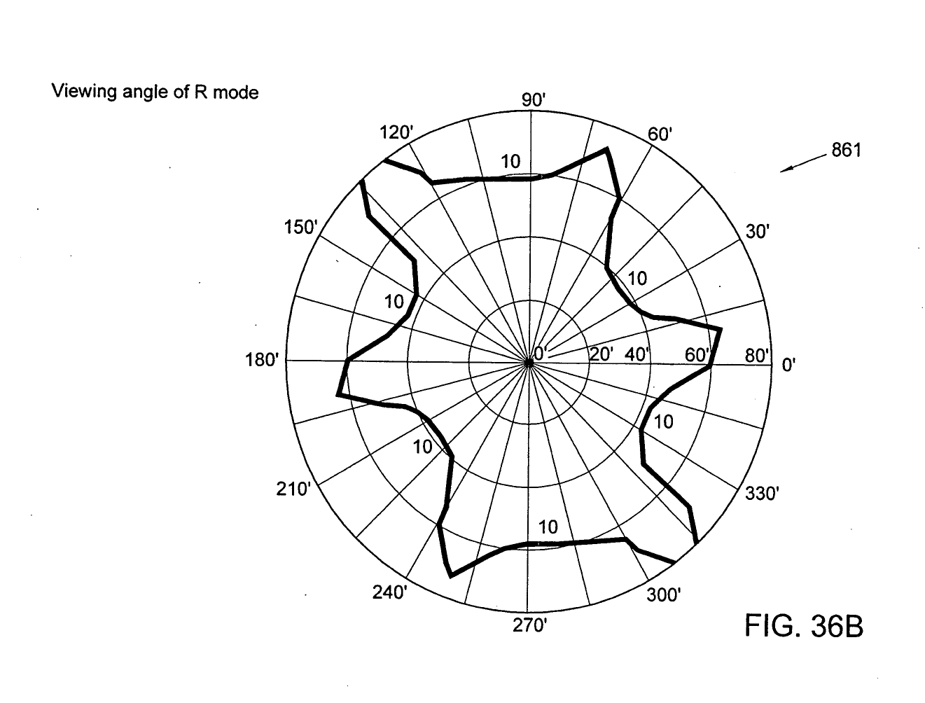

The C-plate 803 does not affect normal incident light because it has nₓ=n_{y} in the x-y plane, but it affects the viewing angle of the display 800. FIGS. 36A and 36B show the iso-contrast plots 860 and 861 for the transmissive mode and reflective mode, respectively, in which the C-plate has refractive indices nₓ=n_{y}=1.50, and n_{z}=1.51, and a thickness of about 28.5 μm. In the transmissive mode, the viewing cone having a contrast ratio greater than 10:1 is over 45° in most directions. In the reflective mode, the viewing cone having a contrast ratio greater than 10:1 over about 40° in most directions. Here the parameters of C-plate 803 can be determined through simulation and configured to provide the optimum viewing angle.

The display 800 of FIG. 34 can also use positive liquid crystal material with the rubbing direction set at about 80° relative to the x-axis. In this example, the positive Δ∈ liquid crystal material is MLC-6686 with an optical birefringence Δn equal to about 0.095. The cell gap d_{T} of the transmissive region 821 is about 3.5 μm. The phase retardation of the retardation film 802 has a thickness about 3.33 μm with its principle refractive indices nₓ=1.65, n_{y}=1.55, n_{z}=1.55, and n_{y} axis at 80° relative to the x-axis. The cell gap d_{R} in the reflective region 822 is reduced to about 2.05 μm. In this configuration, the combination of the liquid crystal layer 809 in the reflective region 822 and the top retardation film 802 function similar to a quarter-wave plate, which further in combination with the top linear polarizer 801b function similar to a circular polarizer. This allows the reflective region 822 to have a dark state. When no voltage or a voltage corresponding to a dark state is applied to the pixel, the pixel has a common dark state across the transmissive and reflective regions.

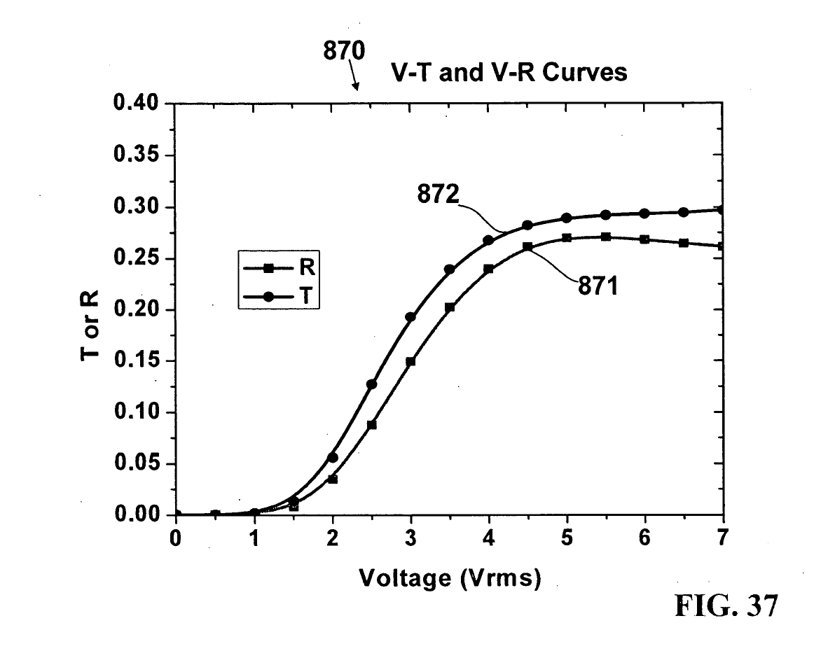

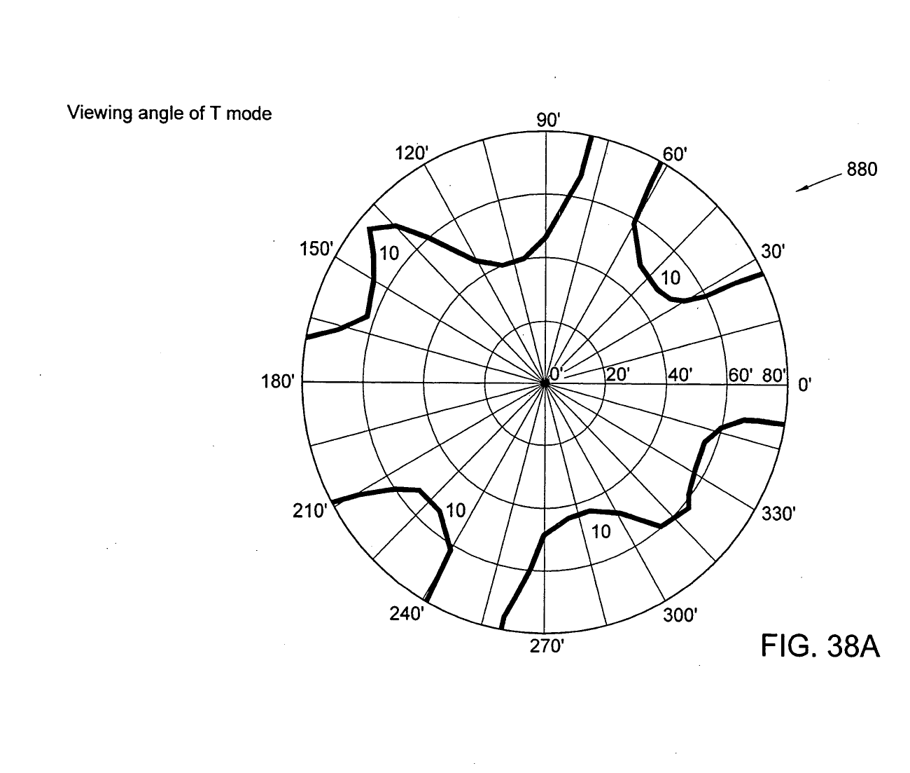

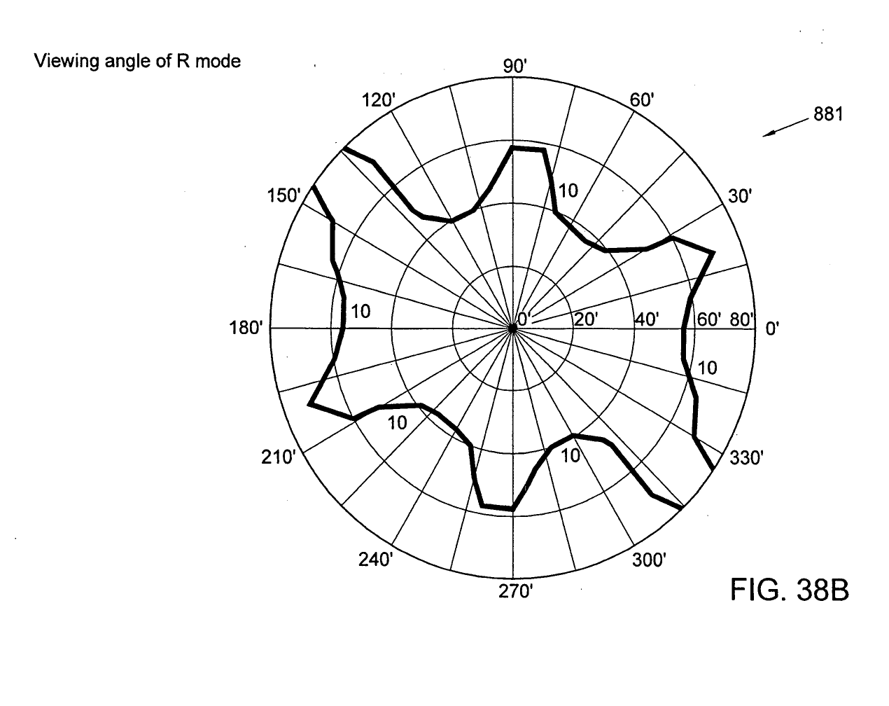

FIG. 37 is a graph 870 showing a V-T curve 872 and a V-R curve 871 for the display 800 using a positive liquid crystal material and having the parameters described above. FIG. 38A shows an iso-contrast plot 880 for the transmissive region 821. FIG. 38B shows an iso-contrast plot 881 for the reflective region 822. In both cases, the C-plate has refractive indices nₓ=n_{y}=1.50, and n_{z}=1.51, and a thickness of about 28.5 μm.

### Example 6

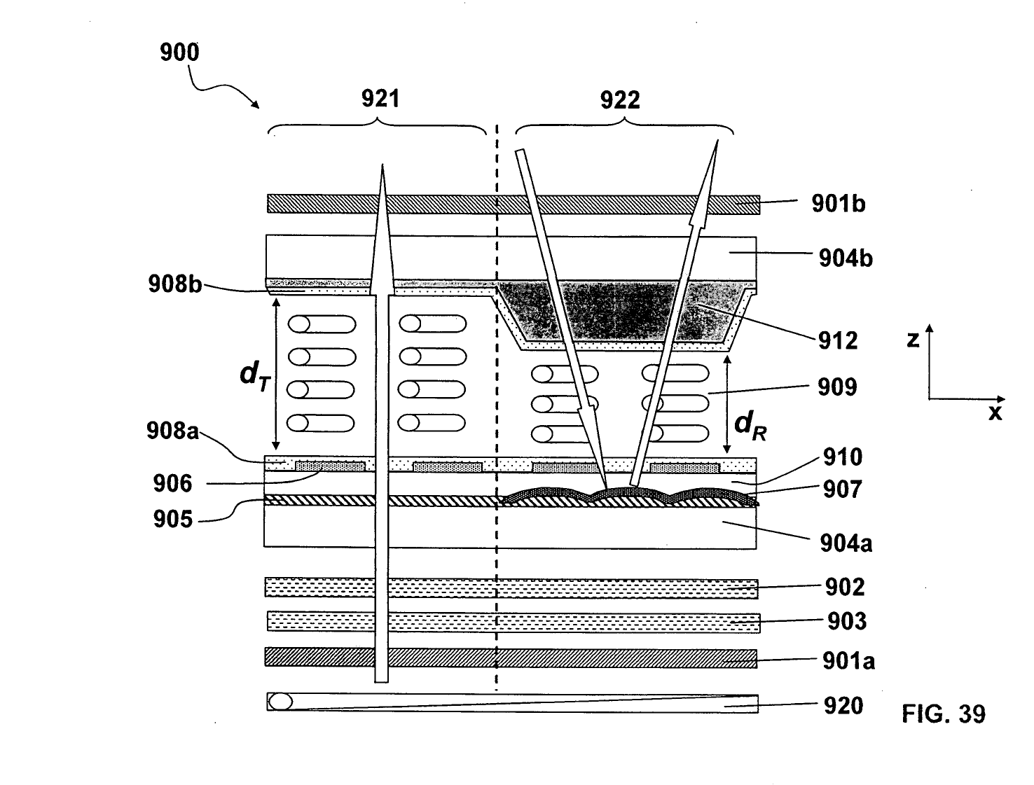

In some implementations, two retardation films can be positioned near the bottom substrate 904a. FIG. 39 is a cross-sectional diagram of one pixel of a wide-view and high brightness transflective liquid crystal display 900. The pixel is divided into a transmissive region 921 and a reflective region 922. A homogeneous alignment liquid crystal layer 909 is positioned between two glass substrates 904a and 904b. Two alignment layers 908a and 908b are formed in the inner surfaces of the two glass substrates and align the liquid crystal molecules.

On the bottom glass substrate 904a, a first electrode 905 made of transparent conductive materials, such as ITO or IZO, is formed in a plane shape in the transmissive region 921, and a reflective metal layer 907 made of aluminum or silver is formed in the reflective region 922 as a reflector. The metal reflector 907 is electrically connected to the electrode 905. A passivation layer 910 made of dielectric materials such as SiOₓ or SiNₓ, is coated on the electrode 905 and 907, above which a group of second electrodes 906 are formed in a striped shape.

In the reflective region 922, an overcoating layer 912 made of a material such as SiOₓ or SiNₓ, or an organic material, is formed to adjust the cell gap d_{R} to be different from that of the transmissive region d_{T}, in order to compensate for the optical path difference in the transmissive and reflective regions. The liquid crystal layer 909 is positioned between two glass substrates, which in turn are placed between two linear polarizers: a first linear polarizer 901a that is close to a backlight unit 920, and a second linear polarizer 901b that is close to a viewer. The transmission axis of the bottom polarizer 901a is set about 45° relative to the liquid crystal rubbing direction, while the bottom and top polarizers 901a and 901b are crossed to each other.

The retardation film 902 has a phase retardation that is designed to fully cancel the phase retardation from the liquid crystal layer 909 in the transmissive region 921 at the normal incidence when no pixel voltage (or a pixel voltage that corresponds to a dark state) is applied, resulting in a dark state in the transmissive region 921. The overall phase retardation from the liquid crystal layer 909 itself in the reflective region 922 is designed to be about λ/4, where λ is the wavelength of the desired incident light. Thus, the combination of the liquid crystal layer 909 and the top linear polarizer 901b forms a circular polarizer that results in a dark state in the reflective region 922 when no voltage (or a pixel voltage that corresponds to a dark state) is applied.

In some examples, when the retardation film 902 has refractive indices nₓ>n_{y}=n_{z}, the biaxial retardation film 902 becomes a uniaxial positive A-plate. To uniquely define the optical arrangement of the retardation film 902 with n_{y}<nₓ and n_{z}<nₓ and its n_{z} perpendicular to the polarizer surface, we can set its refractive indices n_{y}<nₓ and assign its refractive index n_{y} along a certain direction. To increase the viewing angle, another retardation film 903, which can be a uniaxial C-plate, is placed between the film 902 and the bottom linear polarizer 901a. In this example, the uniaxial C-plate has refractive indices nₓ=n_{y}≠n_{z}.

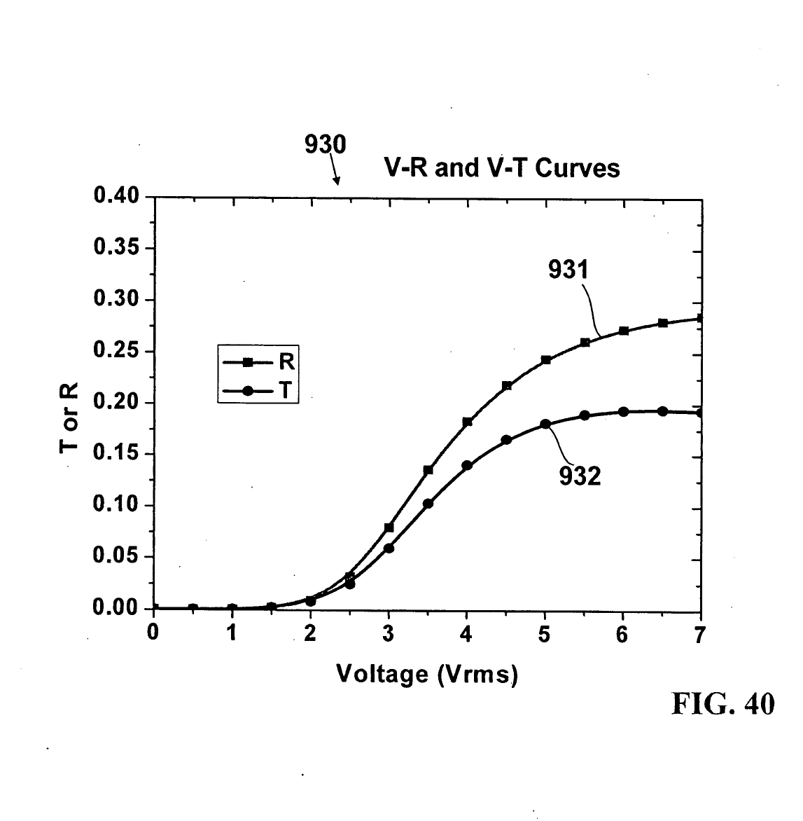

FIG. 40 is a graph 930 showing a V-R curve 931 and a V-T curve 932 for the pixel of the display 900 (FIG. 39), in which a negative liquid crystal material MLC-6608 is used. The cell gap for the transmissive region 921 is 4.0 μm and the cell gap for the reflective region 922 is 1.66 μm. Here, the retardation film 902 is a positive A-plate with its principle refractive indices nₓ=1.65, n_{y}=1.55, n_{z}=1.55 and its n_{y} axis along the liquid crystal rubbing direction at φ=10° relative to the x-axis. The thickness of the retardation film 902 (a positive uniaxial A-plate) is 3.32 μm so that its phase retardation is similar to that of the liquid crystal layer 909.

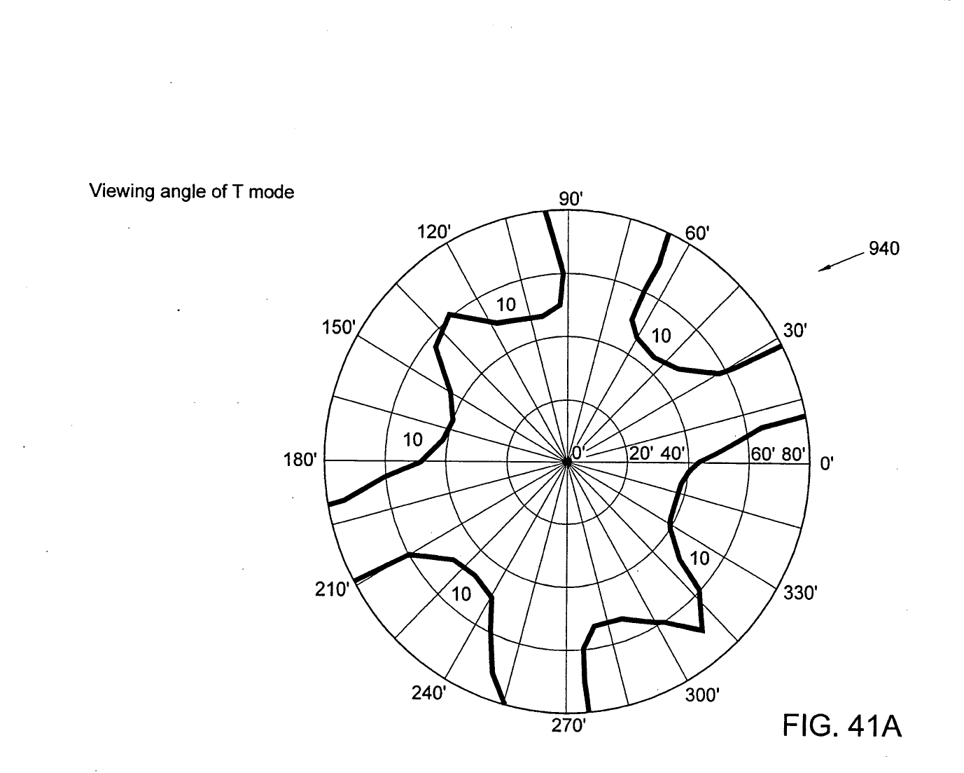

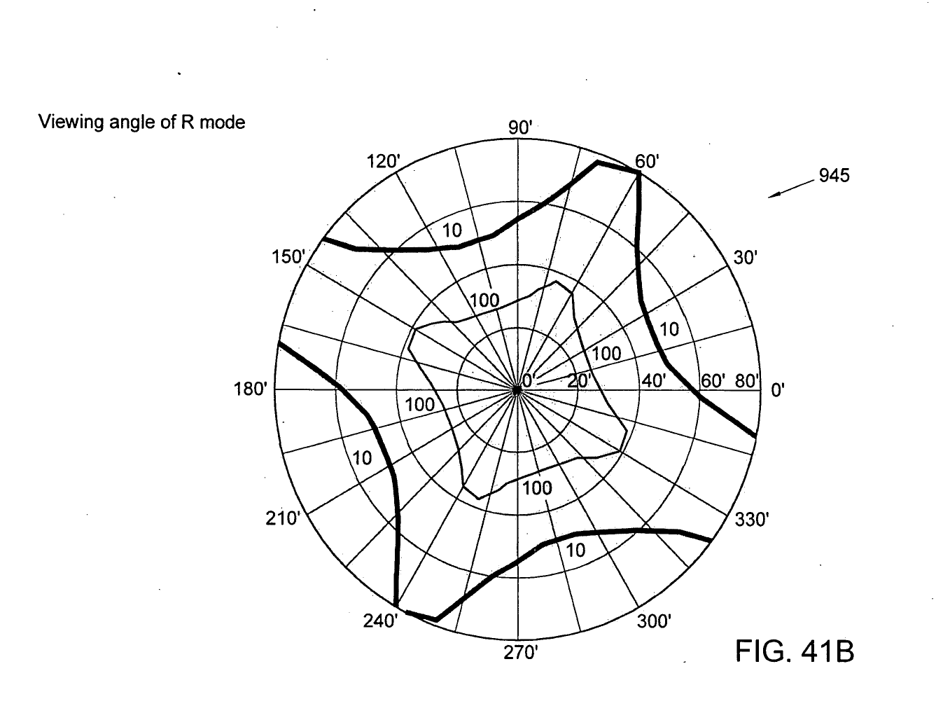

FIG. 41A shows an iso-contrast plot 940 for the transmissive region 921, in which the C-plate 903 has refractive indices nₓ=n_{y}=1.50, and n_{z}=1.51, and a thickness of about 28.5 μm. FIG. 41B shows the iso-contrast plot 945 for the reflective region 922, which is same as the plot 635 for the display 600 shown in FIG. 20. When the retardation film or films are positioned between the lower substrate and the lower linear polarizer, the retardation film or films do not affect the viewing angle of the reflective region.

In some implementations, the display 900 of FIG. 39 can use a positive Δ∈ liquid crystal material, in which the liquid crystal surface rubbing direction is set at about 80°.

FIG. 40 is a graph 930 showing the a V-R curve 931 and a V-T curve 932 for the display 900 in which a negative Δ∈ liquid crystal material is used. In this example, the parameters for the display 900 are the same as those for the display 600 (FIG. 20), except that the display 900 includes a positive uniaxial A-plate 902 and an additional retardation film 903 (a uniaxial C-plate). The V-R curve 931 and V-T curve 932 obtained from the normal incidence are the same as the V-R curve 632 and V-T curve 633 (FIG. 22A), respectively.

FIG. 41A shows an iso-contrast plot 940 for the display 900 operating in the transmissive mode. FIG. 41B shows an iso-contrast plot 945 for the display 900 operating in the reflective mode. Comparing the plots 945 and 635 (FIG. 22B), it can be seen that the viewing angle for the reflective mode of displays 900 and 600 are similar. The viewing angle for the transmissive mode of the displays 900 and 600 are different.

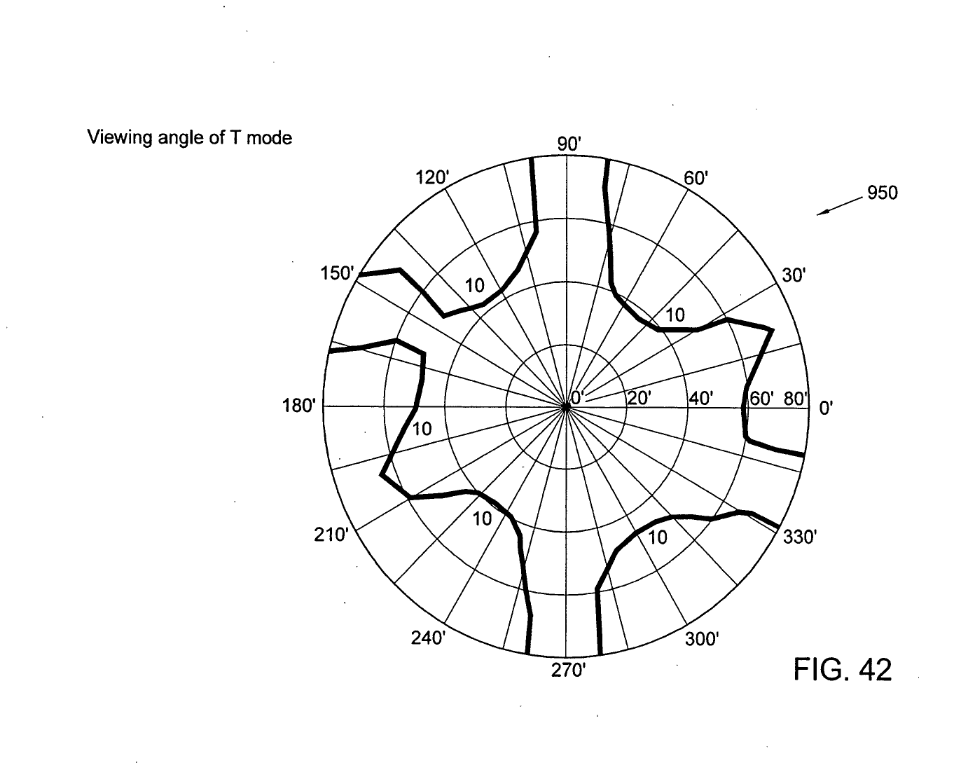

FIG. 42 shows an iso-contrast plot 950 for the transmissive mode of the display 900 in which a positive Δ∈ liquid crystal material is used. In this example, the C-plate has refractive indices nₓ=n_{y}=1.50, and n_{z}=1.51, and a thickness of about 30 μm.

The transflective liquid crystal displays described above each has a wide viewing angle and high transmittance and reflectance. A single gray-scale control gamma curve can be used for both transmissive and reflective modes. The displays can be made using a simple fabrication process that does not involve any in-cell-retarder. The displays can be used in various applications, such as portable displays for mobile electronic devices.

A number of embodiments of the invention have been described. Nevertheless, it will be understood that various modifications may be made without departing from the spirit and scope of the invention. For example, the components of the displays, such as the liquid crystal layer, the polarization films, and the alignment layers, can use materials and have parameters different from those described above. When the display is operating in the transmissive mode in which the backlight unit is turned on, some ambient light may be reflected by the reflective pixel electrode, so the display can operate in both the transmissive and reflective modes at the same time. The electrode widths and electrode spacing can be different from those described above. The geometry of the common electrode and pixel electrode can be different from those described above. For example, the openings and the stripes in the common or pixel electrode can have varying widths, can be curved, and can have various shapes.

The orientations of the liquid crystal molecules described above refer to the directions of directors of the liquid crystal molecules. The molecules do not necessarily all point to the same direction all the time. The molecules may tend to point more in one direction (represented by the director) over time than other directions. For example, when we say the liquid crystal molecules are aligned along a particular direction, we mean that the average direction of the directors of the liquid crystal molecules is generally aligned along the particular direction, but the individual molecules may point to different directions.

Other implementations and applications are also within the scope of the following claims.

What is claimed is:

1. A transflective liquid crystal display comprising:
a first transparent glass substrate;
a second transparent glass substrate, the first glass substrate being positioned closer to a backlight module than the second glass substrate;
a first linear polarizer;
a second linear polarizer, the first linear polarizer being positioned closer to the backlight module than the second linear polarizer;
a retardation film between the first and second linear polarizers;
pixels positioned between the first and second substrates, each pixel comprising
a transmissive region having a liquid crystal layer having a first thickness, the retardation film having a phase retardation that compensates the phase retardation of the liquid crystal layer in the transmissive region for normal incident light to achieve a dark state when no data voltage or a data voltage corresponding to a dark state is applied to the pixel, and
a reflective region having a liquid crystal layer having a second thickness, the second thickness being configured such that a combination of the retardation film and the liquid crystal layer in the reflective region has a phase retardation in a range between 0.22λ and 0.28λ with respect to normal incident light to achieve a dark state when no data voltage or a data voltage corresponding to a dark state is applied to the pixel, λ being the wavelength of the light rays.

2. The display of claim 1 in which the first linear polarizer has a transmission axis that is perpendicular to that of the second linear polarizer, and the liquid crystal layer has a rubbing direction that is at an angle in a range from 40 to 50 degrees relative to the transmission axis of the second linear polarizer.

3. The display of claim 1 in which the retardation film comprises a biaxially stretched film having principle refractive indices nₓ, n_{y}, and n_{z}, in which nₓ>n_{y} and n_{z}>n_{y}.

4. The display of claim 3 in which the n_{z} axis of the retardation film is along a direction that is substantially perpendicular to at least one of the first and second linear polarizers, and the n_{y} axis of the retardation film is substantially parallel to the rubbing direction of the liquid crystal layer.

5. The display of claim 1 in which a combination of the second linear polarizer, the retardation film, and the liquid crystal layer in the reflective region forms a circular polarizer.

6. The display of claim 1 in which the pixel comprises a pixel electrode in both the transmissive and reflective regions, a reflective electrode in the reflective region, and a common electrode,
the pixel electrode, the reflective electrode, and the common electrode all being at a same side relative to the liquid crystal layer.

7. The display of claim 6 in which the pixel electrode comprises strips, the pixel electrode being positioned between the common electrode and the liquid crystal layer.

8. The display of claim 6 in which the common electrode comprises strips, the common electrode being positioned between the pixel electrode and the liquid crystal layer.

9. The display of claim 1 in which the first thickness of the liquid crystal layer in the transmissive region is configured to cause the transmissive region to have a maximum brightness when the pixel is operating in a bright state, in which increasing or decreasing the thickness of the liquid crystal layer in the transmissive region tends to cause the brightness of the pixel to decrease when operating in the bright state.

10. The display of claim 1 in which the liquid crystal layer comprises a negative dielectric anisotropic liquid crystal material.

11. The display of claim 10 in which the liquid crystal layer has an initial surface rubbing angle aligned at an angle in a range from 55° to 85° with respect to the lengthwise direction of the electrode strips.

12. The display of claim 1 in which the liquid crystal layer comprises a positive dielectric anisotropic liquid crystal material, the common electrode comprises strips and is positioned between a pixel electrode and the liquid crystal layer, and the liquid crystal layer has an initial surface rubbing angle aligned at an angle in a range from 5° to 35° with respect to the lengthwise direction of the common electrode strips.

13. The display of claim 1, further comprising a first compensation film and a second compensation film, the first compensation film being closer to a backlight unit than the second compensation film, the first and second compensation films being at opposite sides relative to the liquid crystal layer, the first and second compensation films having refractive indices configured to compensate an effective angle deviation of the first and second linear polarizers for off-axis incident light and reduce off-axis light leakage.

14. The display of claim 13 in which the first and second compensation films comprise a positive uniaxial A-plate having refractive indices nₓ>n_{y}=n_{z} and a negative A-plate having refractive indices n_{y}<nₓ=n_{z}.

15. The display of claim 13 in which the optic axes of the first and second compensation films are either parallel to or perpendicular to the transmission axes of the first and second linear polarizers.

16. The display of claim 1, further comprising a second retardation film that comprises a uniaxial C-plate positioned between the first and second linear polarizers and having refractive indices nₓ=n_{y}≠n_{z}.

17. The display of claim 1 in which the liquid crystal layer has liquid crystal molecules that are aligned substantially parallel to the glass substrates when the pixel is operating in a dark state.

18. A transflective liquid crystal display comprising:
a first transparent glass substrate;
a second transparent glass substrate, the first glass substrate being positioned closer to a backlight module than the second glass substrate;
a first linear polarizer;
a second linear polarizer, the first linear polarizer being positioned closer to the backlight module than the second linear polarizer;
a first retardation film;
pixels positioned between the first and second substrates, each pixel comprising
a transmissive region having a liquid crystal layer having a first thickness, the first retardation film having a phase retardation that cancels the phase retardation of the liquid crystal layer in the transmissive region for normal incident light when the pixel is operating in a dark state, and
a reflective region having a liquid crystal layer having a second thickness such that the liquid crystal layer in the reflective region has a phase retardation in a range between 0.22λ and 0.28λ with respect to normal incident light when the pixel is operating in the dark state, λ being the wavelength of the light rays.

19. A method of operating a transflective liquid crystal display, the method comprising:
using a retardation film to impart a first phase retardation to normal incidence light to compensate a second phase retardation imparted to the light rays by a liquid crystal layer in a transmissive region of a pixel of the display to achieve a dark state when no data voltage or a data voltage corresponding to a dark state is applied to the pixel; and
using a combination of the retardation film and a liquid crystal layer in a reflective region of the pixel to impart a phase retardation in a range between 0.22λ and 0.28λ to normal incidence light to achieve a dark state when no data voltage or a data voltage corresponding to a dark state is applied to the pixel, λ being the wavelength of the light rays.

20. The method of claim 19, further comprising generating fringe electric fields in the liquid crystal layer, the fringe electric fields having components parallel to the liquid crystal layer surface, by applying a data voltage between a pixel electrode and a common electrode in the transmissive region, and applying the data voltage between a reflective electrode and the pixel electrode in the reflective region, in which the pixel electrode, the reflective electrode, and the common electrode are all at a same side relative to the liquid crystal layer.
